(19) United States
(12) Patent Application Publication
(10) Pub. No.: US 2014/0087156 A1
(43) Pub. Date: Mar. 27, 2014

(54) SURFACE COATING SYSTEM AND METHOD OF MAKING AND USING SAME

(71) Applicant: Michael T. Sarkis, Racine, WI (US)

(72) Inventor: Michael T. Sarkis, Racine, WI (US)

(73) Assignee: DIVERSEY, INC., Sturtevant, WI (US)

(21) Appl. No.: 14/122,014

(22) PCT Filed: May 25, 2012
(86) PCT No.: PCT/US2012/039649

§ 371 Date: Nov. 25, 2013

Related U.S. Application Data
(60) Provisional application No. 61/489,990, filed on May 25, 2011.

(51) Int. Cl. C09D 5/20

(52) U.S. Cl. CPC C09D 5/20
USPC 428/212

(57) ABSTRACT

The present invention provides peelable floor surface coating systems and methods for producing the same.

### CROSS-REFERENCE TO RELATED APPLICATIONS

This patent application claims priority to U.S. Provisional Patent Application No. 61/489,990 filed May 25, 2011, the content of which is incorporated herein by reference in its entirety.

### INTRODUCTION

Floor care programs today are primarily used to both protect and enhance the appearance of a floor substrate, such as vinyl, linoleum, wood, concrete, marble, terrazzo, ceramic, and the like. These flooring materials are prone to wear and deterioration with traffic, such as pedestrian or vehicular traffic. Sacrificial coatings are often used to protect flooring materials from physical wear, scratching, staining, and chemical damage. These coatings are part of a floor care program which can include many different types of products, but generally involve the use of a sealer and/or finish applied to the surface of a floor substrate. This finish is then maintained with the use of cleaners and tools, which can include various buffing or burnishing machines. Although these programs are very effective, they are considered a large expense to customers. Additionally, if the surface becomes worn or unsatisfactory over time, it is necessary to entirely remove the floor finish or sealer utilizing various chemical compositions, commonly known as strippers. Such chemical stripping is time-consuming and labor-intensive, hazardous to use, and can degrade many substrates after multiple strip-out cycles significantly decreasing the longevity of the substrate.

It has also been common to treat many flooring substrates with durable semi-permanent coatings, such as those utilizing urethanes, epoxy, or silane technologies. These coating systems suffer from their lack of chemical removability and repairability, and removal often consists of sanding, mechanical abrasion, or chemical stripping. These are significant limitations and often result in unsatisfactory results.

Polymer-based floor coatings are an example of finishes or coatings that are typically applied with a mop or other applicator as an aqueous emulsion or solvent solution that dries to a hard protective film. The removal of these coatings from floor surfaces has traditionally required the use of corrosive chemical solutions, typically comprised of mixtures of alkalis and volatile solvents. Accordingly, recent trends in protective floor coatings are to move away from these traditional finishes and move toward the more durable, highly cross-linked coatings, such as UV-cured urethanes, polyurethane dispersions, and epoxies. These coatings, while they have enhanced durability over more traditional floor finishes, suffer in that they, too, eventually have to be removed from the floor due to scratching, scuffs, etc. However, while more traditional floor finishes can be removed chemically, the highly cross-linked nature of these more durable films makes them difficult, if not impossible, to remove by any means other than physical abrasion.

Additionally, with regard to either chemical or a mechanical abrasive stripping, often times the underlying flooring substrate or surface is damaged, for instance in the case of wood flooring where utilization of chemicals and/or water damage the wood surface.

Significant difficulties and deficiencies exist in repair, remediation or removal of the sacrificial or durable, semi-permanent coatings or finishes. Thus, there is an ongoing search for a peelable floor surface coating system which would enable a surface to be coated with a finish, which can be quickly and easily applied, yet is readily removable and/or repairable after damage or wear.

In summary, a considerable number of deficiencies exist in the art relating to coating systems or finishes for surfaces, such as floor surfaces and the like.

### SUMMARY

This disclosure provides peelable floor surface coating systems comprising: a first coating composition comprising a first polymer composition, wherein when the first coating composition is applied as a first liquid to a floor surface, the first liquid dries to form a first coating; and a second coating composition comprising a second polymer composition, wherein when the second coating composition is applied to the first coating as a second liquid, the second liquid dries to form a second coating. The first coating and second coating form a peelable coating, wherein an adhesive strength between the first coating and second coating is greater than an adhesive strength between the first coating and the floor surface. In some embodiments, the first polymer composition may comprise an acrylic emulsion polymer, a vinyl emulsion polymer, a vinyl-acrylic emulsion polymer, a styrene-acrylic emulsion polymer, a styrene-butadiene emulsion polymer, or a combination thereof having a T_{g} from about 23° C. to about 120° C. In some embodiments, the floor surface is a surface of a floor. In some embodiments, the floor surface is a surface of a base coating.

In some embodiments, the second polymer composition may comprise at least one of an interpenetrating polymer network emulsion polymer, a hybrid emulsion polymer, or a combination thereof. In some embodiments, the second polymer composition may comprise a polyurethane emulsion polymer having a T_{g} from about −80° C. to about 80° C. In some embodiments, the second polymer composition may further comprise a polyester, a polycarbonate, a polyether, a polybutadiene, a polyamide, a polyurea, a polyester-polyurea, or a combination thereof. In some embodiments, the second coating composition may further comprise an acrylic emulsion polymer, a vinyl emulsion polymer, a vinyl-acrylic emulsion polymer, a styrene-acrylic emulsion polymer, or a combination thereof having a T_{g} from about 20° C. to about 120° C.

In some embodiments, the polyurethane emulsion polymer may have an acid number greater than one. In some embodiments, the second polymer composition comprises a hybrid emulsion polymer comprising an interpenetrating polymer network, wherein the interpenetrating polymer network comprises an acrylic, a styrene-acrylic, a styrene, a vinyl, or a vinyl-acrylic polymer. In some embodiments, the hybrid emulsion polymer may further comprise about 20 wt % to about 80 wt % of a polyurethane on a dry weight basis based on total dry weight of the hybrid emulsion polymer. In some embodiments, the hybrid emulsion polymer and interpenetrating polymer network may further comprise poly(methyl methacrylate), poly(tert-butyl methacrylate), poly(styrene), or a combination thereof.

In some embodiments, at least one of the first polymer composition and the second polymer composition may comprise about 0.1 wt % to about 20 wt % of a multifunctional organic crosslinking monomer on active wt % based on 100 parts of the first polymer composition or the second polymer composition, respectively. In some embodiments, at least one of the first polymer composition and the second polymer composition may comprise about 0.1 wt % to about 20 wt % of a monomer comprising an organic acid group on active wt % based on 100 parts of the first polymer composition or the second polymer composition, respectively. In some embodiments, at least one of the first polymer composition and the second polymer composition may comprise acrylic acid monomer, methacrylic acid monomer, or a combination thereof. In some embodiments, at least one of the first coating composition and the second coating composition may further comprise an organic solvent coalescing agent, a wetting agent, a leveling agent, a wax emulsion, a polyvalent metal ionic crosslinker, an alkali soluble or dispersible resin, a alkali agent, a polyfunctional crosslinker, or a combination thereof. In some embodiments, at least one of the first coating composition and the second coating composition may comprise about 0.01 wt % to about 40 wt % of a wax emulsion on active wt % based on 100 parts of the first or second coating composition, respectively. In some embodiments, at least one of the first coating composition and the second coating composition may comprise about 0.01 wt % to about 10 wt % of the polyvalent metal ionic crosslinker on active wt % based on 100 parts of the first coating composition or the second coating composition, respectively.

In some embodiments, the multifunctional organic crosslinking monomer may comprise trimethylolpropane triacrylate, divinyl benzene, triallyl cyanurate, diallyl maleate, glycidyl methacrylate, acetoacetoxyethyl methacrylate, N-methylol acrylamide, diacetoneacrylamide or a combination thereof. In some embodiments, the wax emulsion may comprise a wax with an acid number greater than one, for example an oxidized polyethylene, a maleated polypropylene, or a combination thereof. In some embodiments, the polyvalent metal ionic crosslinker may comprise zinc oxide. In some embodiments, the first polymer composition may comprise an alkali soluble or dispersible resin with an acid number greater than one. In some embodiments, the first polymer composition may comprise about 1% to about 50% of an alkali soluble or dispersible resin on active wt % based on 100 parts of the first polymer composition.

In some embodiments, the dry weight first coating composition deposition may be greater than about 0.0001 g/sq. inch and the dry weight second coating composition deposition is greater than about 0.03 g/sq. inch. In some embodiments, the peel strength of the peelable coating from the floor surface may be from about 50 g-force/25 mm to about 2000 g-force/25 mm. In some embodiments, the elongation at breaking point of the peelable coating may be from about 50% to about 1000%. In some embodiments, the ultimate tensile strength of the peelable coating may be from about 500 psi to about 20,000 psi.

This disclosure also provides protected surfaces comprising a floor and the peelable floor surface coating system of the specification.

This disclosure also provides methods of forming a peelable coating on a floor surface, the methods comprising: applying a first coating composition comprising a first polymer composition as a first liquid to the floor surface whereby the first liquid dries to form a first coating; and applying a second coating composition comprising a second polymer composition as a second liquid to the first coating whereby the second liquid dries to form a second coating, wherein the first coating and second coating form a peelable coating, and wherein an adhesive strength between the first coating and second coating is greater than an adhesive strength between the first coating and the floor surface.

### BRIEF DESCRIPTION OF THE DRAWINGS

FIG. 1 shows a cross-section of a peelable floor surface coating system.

FIG. 2 shows a cross-section of a peelable floor surface coating system wherein a peelable coating is being peeled away from the floor surface.

FIG. 2A shows a cross-section of a peelable floor surface coating system wherein the second coating is peeled away from the first coating leaving only the first coating adhered to the floor surface.

FIG. 3 shows a cross-section of a peelable floor surface coating system wherein a peelable coating is applied to the surface of a base coating.

FIG. 4 shows a cross-section of a peelable floor surface coating system wherein a peelable coating is being peeled away from a base coating.

FIG. 4A shows a cross-section of a peelable floor surface coating system wherein the second coating is peeled away from the first coating leaving only the first coating adhered to a base coating.

### DETAILED DESCRIPTION

The present disclosure is not limited in its disclosure to the specific details of construction, arrangement of components, or method steps set forth herein. The compositions and methods disclosed herein are capable of being made, practiced, used, carried out and/or formed in various ways. The phraseology and terminology used herein is for the purpose of description only and should not be regarded as limiting. Ordinal indicators, such as first, second, and third, as used in the description and the claims to refer to various structures or method steps, are not meant to be construed to indicate any specific structures or steps, or any particular order or configuration to such structures or steps. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification, and no structures shown in the drawings, should be construed as indicating that any non-claimed element is essential to the practice of the invention. The use herein of the terms “including,” “comprising,” or “having,” and variations thereof, is meant to encompass the items listed thereafter and equivalents thereof, as well as additional items. Unless specified or limited otherwise, the terms “mounted,” “connected,” “supported,” and “coupled” and variations thereof encompass both direct and indirect mountings, connections, supports, and couplings. Further, “connected” and “coupled” are not restricted to physical or mechanical connections or couplings.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein. All references cited herein are fully incorporated by reference, unless explicitly indicated otherwise. The present disclosure shall control in the event there are any disparities.

As used herein, the term “emulsion” is interchangeable with the terms “dispersion,” “latex,” or other terms describing water-borne polymers and resins that are known and used by those skilled in the art.

The term “active weight percent” (“wt %”) refers to the active component of the ingredient referenced in a formulation. For example, water and organic solvents and monomers, for example, are active ingredients but components that are dissolved or stabilized or dispersed or emulsified in water, like emulsion polymers, polyurethane emulsions, wax emulsions, alkali soluble or dispersible resins, protective polymer colloids, polyvalent metal ionic crosslinkers, some surface active agents (surfactants), etc., contain active ingredients based on the % non-volatile (% NV) component of that material.

As used herein, the term “interpenetrating polymer network” (“IPN”) refers to a polymer composition comprising two or more polymer networks, wherein at least one of the polymer networks is polyurethane, and wherein the polymer networks are at least partially intertwined but not substantially covalently bonded. An interpenetrating polymer network can arise, for example, when an free radical emulsion polymerization reaction is carried out in the presence of a formed emulsion polymer. See, for example, Journal of Polymer Science: Polymer Chemistry Edition, Vol. 17, 3083-3093 (1979).

As used herein, the term “hybrid emulsion polymer” refers to a polymer composition including an interpenetrating polymer network (“IPN”) that is primarily a microphase separated polymer morphology consisting of a continuous polyurethane polymer matrix phase and microphase separated domains of an acrylic or styrene-acrylic or styrene or vinyl or vinyl-acrylic polymer dispersed within the polyurethane polymer matrix phase and prepared by the polymerization of such monomers in the presence of polyurethane emulsions.

As used herein, the term “physical blend” refers to a polymer composition including a mixture of two or more polymer networks that do not form an interpenetrating polymer network. For example, a physical blend polymer composition may be prepared by combining and mixing a composition including acrylic emulsion polymers with a composition including polyurethane emulsion polymers.

As used herein, the term “acid number” refers to the amount of KOH required to fully neutralize a given dry sample of substance, resin, polymer, or wax and is defined as milligrams (“mg”) of KOH/dry gram of substance. For example, a polyurethane emulsion with an acid number greater than one may refer to Urotuf L522-MPW-40 which has an acid number of about 23.0 mg KOH/dry gram Urotuf L522-MPW-40. In another example, a wax emulsion comprising a wax with an acid number greater than one may refer to A-C®316 wax (oxidized high density polyethylene as a 35% w/w water dispersion of A-C® 316 wax) which has an acid number of about 16.0 mg KOH/dry gram A-C®316 wax. In another example, an alkali soluble resin (“ASR”) having an acid number greater than one may refer to Joncryl B-98 styrene-acrylic acid ASR (28% w/w aqueous solution of an ammonium salt of Joncryl B-98) which has an acid number of about 215 mg KOH/dry gram Joncryl B-98 ASR.

The present disclosure has potential applications on any surface where protection (e.g., scuff and black heel mark resistance, scratch resistance, slip resistance, water resistance, soil resistance, ethanol resistance, stain resistance, etc.) is desirable. Such surfaces include floors, food preparation surfaces, kitchen surfaces, bathroom surfaces, walls, etc. The surfaces to be finished may be made from a large variety of materials, including, but not limited to, engineered stone, engineered wood, vinyl, marble, granite, terrazzo, ceramic, linoleum, wood, metal, plastic, rubber, concrete, stone, vinyl composition tiles (“VCT”), and glass.

### Peelable Floor Surface Coating System

The present disclosure relates to a peelable floor surface coating system including a first coating composition that forms a first coating upon application to a surface, and a second coating composition that forms a second coating upon application to the first coating. The second coating and the first coating form a peelable coating. The peelable floor surface coating system optionally may include a base coating applied to the surface before application of the first coating composition. The peelable floor surface coating system optionally may include a topcoat layer composition applied on top of the second coating. In addition, the coating system optionally includes a removal tool and or instructions for use. The peelable coating has a tensile strength that is greater than its adhesive strength to the surface or to the first coating composition or optionally to the base coating. This allows the peelable coating to be non-chemically removed from the surface with minimal to no damage to the surface. The optional removal tool may be a razor blade or the like or it may be a tool such as that described in U.S. application Ser. No. 12/863,966 filed Jul. 21, 2010, which is incorporated by reference herein in its entirety. One of ordinary skill in the art would be able to determine suitable removal tool for use in the invention.

Other peelable coating systems, such as those disclosed in WO2008/144535, incorporated herein by reference in its entirety, are known.

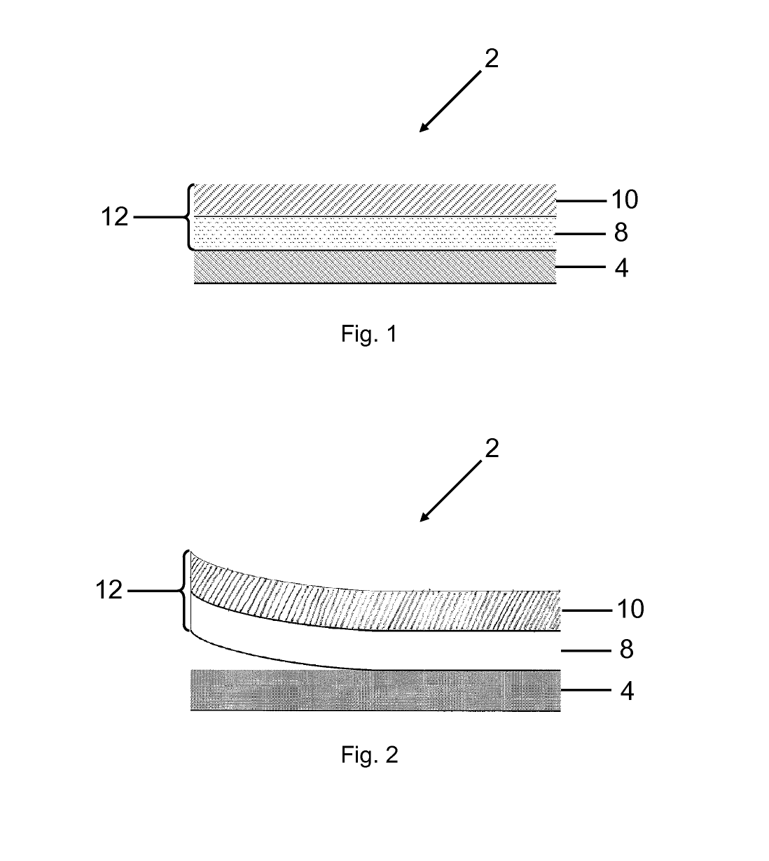

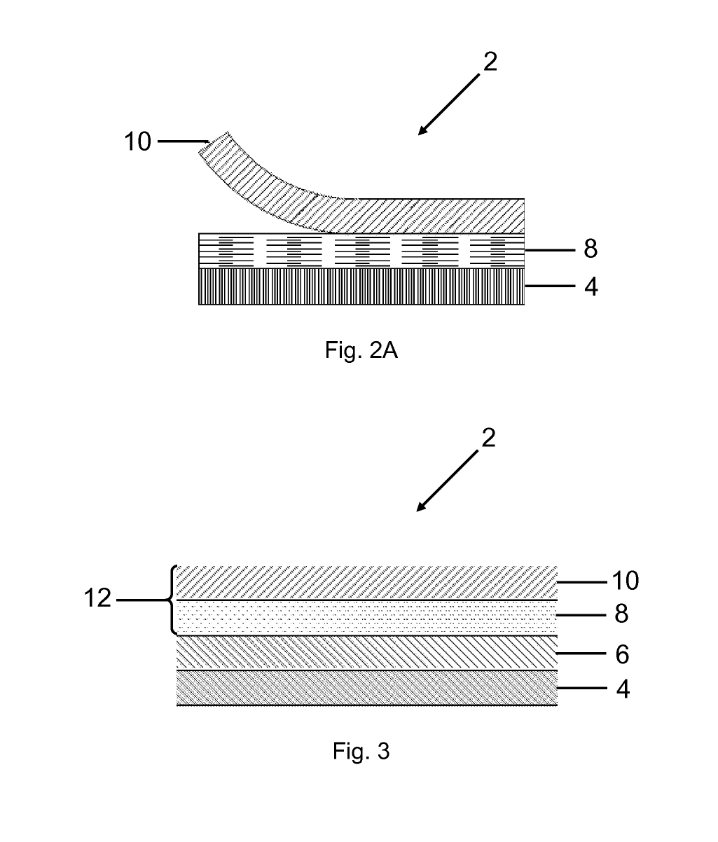

FIG. 1 shows an exemplary embodiment of a peelable floor surface coating system 2 applied to a floor surface 4. The peelable floor surface coating system 2 includes a first coating 8 comprising a first coating composition and is disposed on top of a floor surface 4. The peelable floor surface coating system 2 further includes a second coating 10 comprising a second coating composition and is disposed on top of the first coating 8. In some embodiments, the first coating 8 and second coating 10 are designed to remain adhered to one another, forming a peelable coating 12, yet peel away from the floor surface 4 to enable stripping and refinishing of the floor surface 4 with minimal to no damage to the surface, as shown in FIG. 2. In some embodiments, the second coating 10 may peel away from the first coating 8 leaving only the first coating 8 adhered to the floor surface 4, as shown in FIG. 2A.

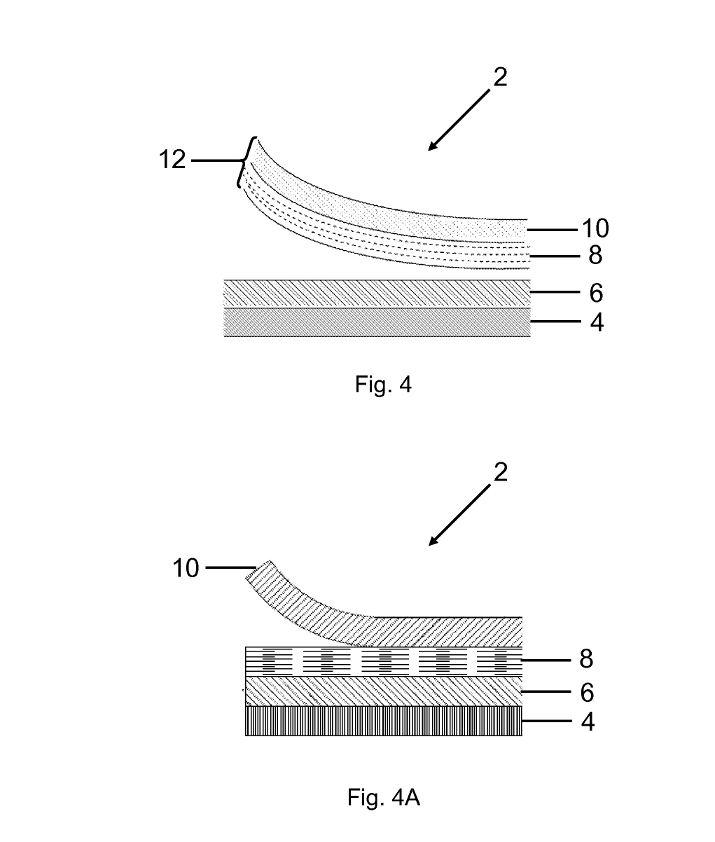

FIG. 3 shows another exemplary embodiment of a peelable floor surface coating system 2 applied to a floor surface 4. The peelable floor surface coating system 2 includes a first coating 8 comprising a first coating composition and is disposed on top of a base coating 6. The peelable floor surface coating system 2 further includes a second coating 10 comprising a second coating composition and is disposed on top of the first coating 8. Where used, the base coating 6 is designed to remain adhered to the floor surface 4 to be finished. In some embodiments, the first coating 8 and second coating 10 are designed to remain adhered to one another, forming a peelable coating 12, yet peel away from the base coating 6, as shown in FIG. 4. In some embodiments, the second coating 10 may peel away from the first coating 8 leaving the first coating 8 adhered to the base coating 6, as shown in FIG. 4A.

### First Coating Composition

The first coating composition can include a first polymer composition. In addition, the first coating composition can also include additives to enhance performance. For example, the first coating composition can include an organic solvent coalescing agent, a wetting agent, a leveling agent, a wax emulsion, a polyvalent metal ionic crosslinker, an alkali soluble or dispersible resin, an alkali agent, a polyfunctional crosslinker, or a combination thereof. The first coating composition may include components as detailed in Table 1.

TABLE 1
First Coating Composition

| | Amount |
|---|---|
| | (Active wt % on 100 Wet Parts |
| Component | First Coating Composition) |
| First Polymer Composition | 1-75 |
| Organic Solvent Coalescing Agent | 0-50 |
| Wetting Agent | 0-10 |
| Leveling Agent | 0-50 |
| Wax Emulsion | 0-50 |
| Polyvalent Metal Ionic Crosslinker | 0-10 |
| Alkali Soluble or Dispersible Resin | 0-50 |
| Alkali Agent | 0-10 |
| Polyfunctional Crosslinker | 0-10 |
| Water | 25-99 |

### First Polymer Composition

The first coating composition can include at least a first polymer composition. Emulsion polymers are known to those skilled in the relevant art and are disclosed, for example, in U.S. Pat. No. 3,308,078, U.S. Pat. No. 3,328,325, U.S. Pat. No. 4,517,330, U.S. Pat. No. 5,705,560, U.S. Pat. No. 5,760,113, U.S. Pat. No. 5,760,129, and U.S. Pat. No. 6,020,413, all of which are hereby incorporated by reference in their entireties. Polymers suitable for use in the first polymer composition may be prepared by techniques known to those skilled in the art such as, without limitation, by emulsion polymerization, dispersion polymerization, suspension polymerization, and inverse-emulsion polymerization. In some embodiments, the first polymer composition may include an emulsion polymer composition formed by the free radical polymerization of ethylenically-unsaturated monomers, such as, for example, an emulsion polymerization method which involves a free radical polymerization of monomer-in-water for the preparation of synthetic polymer or resin water-borne emulsions, latexes, or dispersions. Suitable first polymer compositions can include, but are not limited to, at least one of an acrylic emulsion polymer, a vinyl emulsion polymer, a vinyl-acrylic emulsion polymer, a styrene-acrylic emulsion polymer, a styrene-butadiene emulsion polymer, and a combination thereof. Other suitable polymer compositions are known to those skilled in the art. In some embodiments, a physical blend of more than one polymer composition can be used. The first polymer composition may include components as detailed in Table 2.

TABLE 2
First Polymer Composition

| | Amount |
|---|---|
| | (Active wt % on |
| | 100 Wet Parts of First |
| Component | Polymer Composition) |
| Monomer | 20-75 |
| Organic Acid Functional Monomer | 0-20 |
| Multi-Functional Crosslinking Monomer | 0-20 |
| Surface-active Agents | 0-10 |
| Protective Polymer Colloid | 0-50 |
| Free Radical Initiator | 0.01-2 |
| Modifier | 0-1 |
| Buffer | 0-1 |
| Alkali Agent | 0-10 |
| Oxidizing Agent Redox Scavenger | 0-1 |
| Reducing Agent Redox Scavenger | 0-1 |
| Water | 25-80 |

### Monomer

In some embodiments, the first polymer composition can include at least one ethylenically-unsaturated monomer. In some embodiments, the first polymer composition can include more than one ethylenically-unsaturated monomer. The ethylenically-unsaturated monomers may include, for example, styrene and substituted styrenes monomers, such as, without limitation, alpha-methyl styrene, para-methyl styrene, tert-butyl styrene, and vinyl toluene; acrylate and methacrylate monomers, such as, without limitation, methyl methacrylate, tert-butyl methacrylate, isobutyl methacrylate, ethyl methacrylate, butyl methacrylate, hexyl methacrylate, lauryl methacrylate, benzyl methacrylate, cyclohexyl methacrylate, isobornyl methacrylate, stearyl methacrylate, hydroxyethyl methacrylate, hydroxypropyl methacrylate, gylcidyl methacrylate, acetoacetoxyethyl methacrylate, acetoacetoxypropyl methacrylate, acetoacetoxybutyl methacrylate, 2,3-di(acetoacetoxy)propyl methacrylate, dimethylaminoethyl methacrylate, tert-butylaminoethyl methacrylate, methacryloxypropyltrimethoxysilane, methacryloxypropyltriethoxysilane, methacryloxypropyltriisopropoxysilane, butyl acrylate, 2-ethylhexyl acrylate, methyl acrylate, ethyl acrylate, propyl acrylate, isopropyl acrylate, hexyl acrylate, isobutyl acrylate, tert-butyl acrylate, benzyl acrylate, isobornyl acrylate, cyclohexyl acrylate, laurel acrylate, hydroxyethyl acrylate, hydroxypropyl acrylate, gylcidyl acrylate, acetoacetoxyethyl acrylate, acryloxypropyltrimethoxysilane, acryloxypropyltriethoxysilane, and acryloxypropyltriisopropoxysilane; acrylic amides such as, without limitation, acrylamide, methacrylamide, N-methyl acrylamide, N-methyl methacrylamide, N-methylol acrylamide, N-methylol methacrylamide, diacetoneacrylamide, and diacetonemethacrylamide; α,β-ethylenically unsaturated mono- and dicarboxylic acids such as, without limitation, methacrylic acid, acrylic acid, crotonic acid, maleic acid, fumaric acid, and itaconic acid; vinyl esters of alkanoic acids having from 1 to about 18 carbon atoms, such as, without limitation, vinyl acetate, vinyl formate, vinyl propionate, vinyl butyrate, vinyl isobutyrate, vinyl valerate, vinyl 2-ethylhexanoate, vinyl isooctanoate, vinyl nonoate, vinyl decanoate, vinyl pivalate, vinyl laurate, vinyl stearate, vinyl benzoate, and vinyl versatate; vinyl halide monomers such as, without limitation, vinyl chloride, vinylidene chloride, vinylidene fluoride, vinyltrimethoxysilane, vinyltriethoxysilane, and vinyltriisopropoxysilane; heterocyclic vinyl monomers such as, without limitation, vinyl pyrrolidones and vinyl pyridines; vinyl amides, such as, without limitation, vinyl formamide, and vinyl acetamide; diene monomers, such as, without limitation, butadiene, isoprene, chloroprene; other vinyl monomers such as, without limitation, ethylene, acrylonitrile, and methacrylonitrile; vinyl alkyl ethers having an alkyl group with 1 to about 18 carbon atoms such as, without limitation, methyl vinyl ether, ethyl vinyl ether, butyl vinyl ether, and stearyl vinyl ether; polyethylenically unsaturated monomers such as, without limitation, vinyl crotonate, allyl acrylate, allyl methacrylate, divinyl adipate, diallyl adipate, diallyl maleate, divinyl benzene, diallyl phthalate, ethylene glycol diacrylate, ethylene glycol dimethacrylate, butanediol diacrylate, butanediol dimethacrylate, hexanediol diacrylate, hexanediol dimethacrylate, methylene bis acrylamide, triallyl cyanurate, trimethylolpropane triacrylate, and trimethylolpropane trimethacrylate; and additional functional monomers such as, without limitation, phosphate esters of polyethylene glycol monomethacrylate, phosphate esters of polypropylene glycol monomethacrylate, vinyl sulfonic acid, and 2-acrylamido-2-methylpropane sulfonic acid.

In some embodiments, the monomer concentration may be about 20 wt % to about 75 wt % on active wt % based on 100 parts of the first polymer composition. In some embodiments, the amount of monomer may be less than about 60 wt %, or less than about 50 wt % on active wt % based on 100 parts of the first polymer composition. In other embodiments, the monomer concentration may be present in at least about 25 wt % or at least about 30 wt % on active wt % based on 100 parts of the first polymer composition. This includes ranges of about 25 to about 60 wt % and about 30 to about 50 wt % on active wt % based on 100 parts first polymer composition.

### Organic Acid Functional Monomer

In some embodiments, the first polymer composition may include a monomer comprising an organic acid group (i.e., an organic acid functional monomer). The organic acid functional monomer can include, for example, α,β-ethylenically unsaturated mono- and dicarboxylic acids, such as, for example, acrylic acid monomer, methacrylic acid monomer, crotonic acid monomer, maleic acid monomer, fumaric acid monomer, itaconic acid monomer, and combinations thereof.

In some embodiments, the amount of organic acid functional monomer may be less than about 20 wt %, less than about 15 wt %, less than about 10 wt %, or less than about 5 wt % on active wt % based on 100 parts of the first polymer composition. This includes ranges of about 0 wt % to about 20 wt % on active wt % based on 100 parts of the first polymer composition. In other embodiments, the amount of monomer may be at least about 0.01 wt %, at least about 0.02 wt %, at least about 0.03 wt %, or at least about 0.04 wt % on active wt % based on 100 parts of the first polymer composition. This includes ranges of about 0.01 wt % to about 20 wt %, about 0.02 wt % to about 15 wt %, about 0.03 wt % to about 10 wt %, and about 0.04 wt % to about 5 wt % on active wt % based on 100 parts of the first polymer composition.

### Multi-Functional Crosslinking Monomer

In some embodiments, the first polymer composition may include a multifunctional organic crosslinking monomer. Multifunctional organic crosslinking monomer may include a monomer molecule comprising more than one ethylenically-unsaturated functionality or a monomer molecule comprising at least one ethylenically-unsaturated functionality and at least one functional group including, without limitation, carboxylic acid, hydroxyl, epoxide, amine, methylol, silane, diacetone, acetoacetoxy, aziridine, hydrazide, and isocyanate functionality. The multifunctional organic crosslinking monomer can include, for example, trimethylolpropane triacrylate (“TMPTA”), divinyl benzene (“DVB”), triallyl cyanurate (“TAC”), diallyl maleate (“DAM”), vinyl crotonate, allyl acrylate, allyl methacrylate, divinyl adipate, diallyl adipate, diallyl phthalate, ethylene glycol diacrylate, ethylene glycol dimethacrylate, butanediol diacrylate, butanediol dimethacrylate, hexanediol diacrylate, hexanediol dimethacrylate, methylene bis acrylamide, trimethylolpropane trimethacrylate, gylcidyl methacrylate, acetoacetoxyethyl methacrylate, acetoacetoxypropyl methacrylate, acetoacetoxybutyl methacrylate, 2,3-di(acetoacetoxy)propyl methacrylate, gylcidyl acrylate, acetoacetoxyethyl acrylate, N-methyl acrylamide, N-methyl methacrylamide, N-methylol acrylamide, N-methylol methacrylamide, diacetoneacrylamide, diacetonemethacrylamide, hydroxyethyl methacrylate, hydroxypropyl methacrylate, hydroxyethyl acrylate, hydroxypropyl acrylate, tert-butylaminoethyl methacrylate, methacryloxypropyltrimethoxysilane, methacryloxypropyltriethoxysilane, methacryloxypropyltriisopropoxysilane, acryloxypropyltrimethoxysilane, acryloxypropyltriethoxysilane, acryloxypropyltriisopropoxysilane, vinyltrimethoxysilane, vinyltriethoxysilane, vinyltriisopropoxysilane, methacrylic acid, acrylic acid, crotonic acid, maleic acid, fumaric acid, and itaconic acid, and combinations thereof.

In some embodiments, the multifunctional organic crosslinking monomer concentration may be less than about 20 wt %, less than about 15 wt %, less than about 10 wt %, or less than about 5 wt % on active wt % based on 100 parts of the first polymer composition. This includes ranges of about 0 wt % to about 20 wt % on active wt % based on 100 parts of the first polymer composition. In other embodiments, the multifunctional organic crosslinking monomer may be present in at least about 0.01 wt %, at least about 0.02 wt %, at least about 0.03 wt %, or at least about 0.04 wt % on active wt % based on 100 parts of the first polymer composition. This includes ranges of about 0.01 wt % to about 20 wt %, about 0.02 wt % to about 15 wt %, about 0.03 wt % to about 10 wt %, and about 0.04 wt % to about 5 wt %.

### Surface-Active Agent

In some embodiments, surface-active agents can include, for example, anionic, cationic, or nonionic surfactants. Examples of anionic surfactants include, without limitation, organophosphate surfactants (mono and/or diester alkyl phosphate esters, mono and/or diester alkyl ether phosphate esters, such as the ammonium, trethylamine, lithium, sodium, potassium, calcium, zinc, rubidium, cesium, beryllium, magnesium, strontium, barium neutralized salts of mono and/or diester alkyl phosphate esters and mono and/or diester alkyl ether phosphate esters), sulfate surfactants (alkyl, alkyl ether, alkyl aryl ether sulfates), sulfonate surfactants (dodecylbenzene, alpha olefin, alkyl naphthalene sulfonates), sulfosuccinate surfactants (mono and diester sulfosuccinates), diethylene oxide disulfonate surfactants, sulfonamide surfactants, sulfoester surfactants, and combinations thereof. Examples of cationic surfactants include, without limitation, benzyl quats, amine oxides, ethoxylated fatty amines, fatty imidazolines, and combinations thereof. Examples of nonionic surfactants include, without limitation, alcohol ethoxylates, secondary alcohol ethoxylates, phenol ethoxylates, alkyl phenol ethoxylates, EO/PO blocked copolymers, sorbitan esters, ethoxylated sorbitan esters, mercaptan ethoxylates, and fatty acids such as alkali metal and amine salts of higher fatty acids having, for example, 12 to 18 carbons such as tall oil fatty acid, as well as combinations thereof.

In some embodiments, the surface-active agent concentration may be about 0 wt % to about 10 wt % on active wt % based on 100 parts first polymer composition. In some embodiments, the surface-active agent concentration may be less than about 5 wt % or less than about 3 wt % on active wt % based on 100 parts of the first polymer composition. In other embodiments, the surface-active agent may be present in at least about 0.01 wt % or at least about 0.1 wt % on active wt % based on 100 parts first polymer composition. This includes ranges of about 0.01 to about 5 wt % and about 0.1 to about 3 wt % on active wt % based on 100 parts of the first polymer composition.

### Protective Polymer Colloid

In some embodiments, protective polymer colloid may be used to prepare and stabilize the emulsion polymer. In some embodiments, protective polymer colloid can include, for example, alkali soluble or dispersible resins such as, acrylic-acrylic acid, styrene-acrylic acid resins, styrene-α-methyl styrene-acrylic acid resins, styrene-acrylic-acrylic acid resins, styrene-α-methyl styrene-acrylic-acrylic acid resins, acrylic-methacrylic acid, styrene-methacrylic acid resins, styrene-α-methyl styrene-methacrylic acid resins, styrene-acrylic-methacrylic acid resins, styrene-α-methyl styrene-acrylic-methacrylic acid resins, such as those described in U.S. Pat. No. 4,529,787, which is hereby incorporated by reference in its entirety, styrene-maleic anhydride resins, polycarboxypolyamide resins such as those described in U.S. Pat. No. 6,518,334, which is hereby incorporated by reference in its entirety, partially acetylated polyvinyl alcohol, casein, hydroxyethyl starch, carboxymethyl cellulose, hydroxyethyl cellulose, gum Arabic, and combinations thereof. The protective polymer colloid may comprise a polymer resin with an acid number greater than one.

In some embodiments, the protective polymer colloid concentration may be about 0 wt % to about 50 wt % on active wt % based on 100 parts of the first polymer composition. In some embodiments, the amount of protective polymer colloid may be less than about 40 wt % or less than about 30 wt % on active wt % based on 100 parts of the first polymer composition. In other embodiments, the amount of protective polymer colloid may be at least about 1 wt % or at least about 2 wt % on active wt % based on 100 parts of the parts first polymer composition. This includes ranges of about 1 to about 35 wt % and about 2 to about 30 wt % on active wt % based on 100 parts of the first polymer composition.

### Free Radical Initiator

Free radical initiators can be used alone thermally or in conjunction with reducing agents as a redox couple to generate free radicals. Examples of free radical initiators can include, without limitation, peroxides, hydroperoxides, persulfates, perbenzoates, and perpivalates as free radical generating oxidizing agents. Free radical generating oxidizing agent initiators can include, without limitation, ammonium persulfate, sodium persulfate, potassium persulfate, hydrogen peroxide, tert-butyl hydroperoxide, cumene hydroperoxide, tert-amyl hydroperoxide, tert-butylperpivalate, tert-butyl perbenzoate, benzoyl peroxide, and combinations thereof. In some embodiments, reducing agents can include, for example, sodium formaldehyde sulfoxylate, ferrous salts, sodium dithionite, sodium hydrogen sulfite, sodium metabisulfite, sodium sulfite, sodium thiosulfate, ascorbic acid, erythorbic acid, sodium erythorbate, and combinations thereof.

In some embodiments, the free radical initiator concentration may be about 0.01 wt % to about 2 wt % on active wt % based on 100 parts of the first polymer composition. In some embodiments, the free radical initiator concentration may be less than about 1 wt % or less than about 0.5 wt % on active wt % based on 100 parts of the first polymer composition. In other embodiments, the free radical initiator concentration may be at least about 0.005 wt % or at least about 0.01 wt % on active wt % based on 100 parts first polymer composition. This includes ranges of about 0.005 to about 1 wt % and about 0.01 wt % to about 0.5 wt % on active wt % based on 100 parts of the first polymer composition.

### Modifier

In some embodiments, a modifier may be used to control the polymerization reaction by restricting cross-linking and controlling the molecular weight. Examples of modifiers can include, without limitation, aldehydes, mercaptans such as mercaptopropionic acid, butyl mercatopropionate, isooctyl mercaptopropionate, octyl mercaptan, dodecyl mercatan, thiol glycolic acid, chlorinated hydrocarbons, and combinations thereof.

In some embodiments, the modifier concentration may be about 0 wt % to about 1 wt % on active wt % based on 100 parts of the first polymer composition. In some embodiments, the modifier concentration may be less than about 0.5 wt % or less than about 0.05 wt % on active wt % based on 100 parts of the first polymer composition. In other embodiments, the modifier may be present in at least about 0.001 wt % or at least about 0.01 wt % on active wt % based on 100 parts of the first polymer composition. This includes ranges of about 0.001 wt % to about 0.5 wt % and about 0.01 to about 0.05 wt % on active wt % based on 100 parts of the first polymer composition.

### Buffer

In some embodiments, a buffer can be used to control the pH of the emulsion polymerization composition. Examples of buffers can include, without limitation, phosphates, citrates, acetates, carbonates, and combinations thereof.

In some embodiments, the buffer concentration may be about 0 wt % to about 1 wt % on active wt % based on 100 parts of the first polymer composition. In some embodiments, the buffer concentration may be less than about 0.5 wt % or less than about 0.05 wt % on active wt % based on 100 parts of the first polymer composition. In other embodiments, the buffer concentration may be at least about 0.001 wt % or at least about 0.01 wt % on active wt % based on 100 parts of the first polymer composition. This includes ranges of about 0.001 wt % to about 0.5 wt % and about 0.01 to about 0.05 wt % on active wt % based on 100 parts of the first polymer composition.

### Alkali Agent

In some embodiments, the first polymer composition may comprise an alkali agent which can be used to control or adjust latex pH and/or provide crosslinking with functional chemistries contained in the emulsion polymer. Examples include, without limitation, amines, hydroxides, carbonates, hydrazides, aziridines and combinations thereof. The alkali agent can include, without limitation, ammonium hydroxide (ammonia), triethyl amine, dimethylethanol amine, amino-2-methyl-1-propanol, 2-dimethylamino-2-methyl-1-propanol, ethanol amine, dimethylethanol amine, hydrazine, ethylene diamine, diethylene triamine, triethylene tetraamine, propylene diamine, butylene diamine, hexamethylene diamine, cyclohexylene diamine, piperazine, 2-methyl piperazine, phenylene diamine, toluene diamine, tris(2-aminoethyl)amine, 4,4′-methylenebis(2-chloroaniline), 3,3′-dichloro-4,4′-diphenyl diamine, 2,6-diaminopyridine, 4,4′-diaminophenyl methane, isophorone diamine, trimethoxysilylpropyl diethylenetriamine, triethoxysilylpropyl diethylenetriamine, N-methylaminopropyl trimethoxysilane, aminoethylaminopropylmethyl dimethoxysilane, aminoethylaminopropylmethyl diethoxysilane, aminoethylaminopropylmethyl trimethoxysilane, aminoethylaminopropylmethyl triethoxysilane, aminopropylmethyl dimethoxysilane, aminopropylmethyl diethoxysilane, aminopropyl trimethoxysilane, aminopropyl triethoxysilane, N-methylaminopropyl triethoxysilane, aminobutyl trimethoxysilane, aminobutyl triethoxysilane, sodium hydroxide, potassium hydroxide, rubidium hydroxide, cesium hydroxide, hydroxide beryllium, magnesium hydroxide, calcium hydroxide, strontium hydroxide, barium hydroxide, zinc ammonium carbonate, sodium bicarbonate, adipic dihydrazide, and polyfunctional aziridines, such as, for example, Crosslinker CX-100 (DSM NeoResins Inc., Wilmington, Mass.) and combinations thereof.

In some embodiments, the alkali agent concentration may be about 0 wt % to about 10 wt % on active wt % based on 100 parts of the first polymer composition. In some embodiments, the alkali agent concentration may be less than about 5 wt % or less than about 3 wt % on active wt % based on 100 parts of the first polymer composition. In other embodiments, the alkali agent concentration may be at least about 0.01 wt % or at least about 0.1 wt % on active wt % based on 100 parts of the first polymer composition. This includes ranges of about 0.01 to about 5 wt % and about 0.1 to about 3 wt % on active wt % based on 100 parts of the first polymer composition.

### Oxidizing Agent Redox Scavenger

In some embodiments, oxidizing agents can be used alone thermally or in conjunction with reducing agents as a redox couple to generate free radicals. Examples of oxidizing agent redox scavengers can include, without limitaiton, peroxides, hydroperoxides, persulfates, perbenzoates, and perpivalates as free radical generating oxidizing agents. In some embodiments, the free radical generating oxidizing agents can include, for example, ammonium persulfate, sodium persulfate, potassium persulfate, hydrogen peroxide, tert-butyl hydroperoxide, cumene hydroperoxide, tert-amyl hydroperoxide, tert-butylperpivalate, tert-butyl perbenzoate, benzoyl peroxide, and combinations thereof.

In some embodiments, the oxidizing agent redox scavenger concentration may be about 0 wt % to about 1 wt % on active wt % based on 100 parts of the first coating composition. In some embodiments, the oxidizing agent redox scavenger concentration may be about 0.01 wt % to about 0.5 wt % on active wt % based on 100 parts of the first coating composition.

### Reducing Agent Redox Scavenger

In some embodiments, the reducing agent redox scavenger can include, for example, sodium formaldehyde sulfoxylate, ferrous salts, sodium dithionite, sodium hydrogen sulfite, sodium metabisulfite, sodium sulfite, sodium thiosulfate, ascorbic acid, erythorbic acid, sodium erythorbate, and combinations thereof.

In some embodiments, reducing agent redox scavenger concentration may be about 0 wt % to about 1 wt % on active wt % based on 100 parts first coating composition. In some embodiments, the reducing agent redox scavenger concentration may be about 0.01 wt % to about 0.5 wt % on active wt % based on 100 parts of the first coating composition.

The balance of the first polymer composition may be water.

In some embodiments, suitable first polymer compositions include those that contain a polymer with a glass transition temperature (T_{g}) of from about −10° to about 120° C. For example, in some embodiments, the T_{g} may be less than about 120° C., less than about 100° C., less than about 85° C., less than about 70° C., or less than about 55° C. In some embodiments, the T_{g} may be greater than about −10° C., greater than about 0° C., greater than about 10° C., or greater than about 20° C. In those embodiments in which a physical blend of polymer is used, each polymer may have a different T_{g}.

Suitable formulations for the first polymer composition can have a solids level of about 20% to about 75% on active wt % based on 100 parts of the first coating composition, the solids primarily comprising one or more polymers such as those listed above. In some embodiments, the solids may be at least about 25 wt % or at least about 30 wt % on active wt % based on 100 parts of the first coating composition. In other embodiments, the solids level is less than about 70 wt % or less than about 60 wt % on active wt % based on 100 parts of the first coating composition. This includes ranges of about 25 wt % to about 70 wt % and about 30 wt % to about 60 wt % on active wt % based on 100 parts of the first coating composition.

Suitably the pH of the first polymer composition is greater than about 1, and may be less than about 10. This includes a pH of between about 5 and about 9.

### Organic Solvent Coalescing Agent

Some embodiments of the first coating composition can include organic solvent coalescing agents. Organic solvent coalescing agents may be selected from organic solvents that are totally or partially soluble in water to organic solvents that are insoluble in water. Organic solvent coalescing agents can include, but are not limited to, glycol ethers including ethylene or propylene glycol, ethylene glycol 2-ethylhexyl ether, ethylene glycol phenyl ether, diethylene glycol methyl ether, diethylene glycol ethyl ether, diethylene glycol propyl ether, diethylene glycol butyl ether, diethylene glycol 2-ethylhexyl ether, propylene glycol phenyl ether, dipropylene glycol methyl ether, dipropylene glycol propyl ether, and dipropylene glycol n-butyl ether; pyrrolidone solvents including, but not limited to, 2-pyrrolidone, N-methyl-2-pyrrolidone, N-ethyl-2-pyrrolidone, N-octyl-2-pyrrolidone, N-dodecyl-2-pyrrolidone, N-(2-hydroxyethyl)-2-pyrrolidone, and N-cyclohexyl-2-pyrrolidone; phosphate ester solvents including, but not limited to, tributoxyethyl phosphate, triethyl phosphate, triethoxyethyl phosphate, tributyl phosphate, triphenyl phosphate, and tricresyl phosphate; dibenzoate solvents including, but not limited to, propylene glycol dibenzoate, dipropylene glycol dibenzoate, polypropylene glycol dibenzoate, ethylene glycol dibenzoate, diethylene glycol dibenzoate, polyethylene glycol dibenzoate, and neopentyl glycol dibenzoate; monobenzoate solvents including, but not limited to, isodecyl benzoate, and dipropylene glycol methyl ether benzoate; phthalate solvents including, but not limited to, diethyl phthalate, dibutyl phthalate, butyl benzyl phthalate, and 2,2,4-trimethyl-1,3-pentanediol diisobutyrate; and combinations thereof.

In some embodiments, the organic solvent coalescing agent concentration may be about 0 wt % to about 50 wt % on active wt % based on 100 parts of the first coating composition. In some embodiments, the amount of organic solvent coalescing agent may be less than about 30 wt % or less than about 20 wt % on active wt % based on 100 parts of the first coating composition. In other embodiments, the organic solvent coalescing agent may be present in at least about 0.1 wt % or at least about 0.2 wt % on active wt % based on 100 parts of the first coating composition. This includes ranges of about 0.1 wt % to about 30 wt % and about 0.2 wt % to about 20 wt % on active wt % based on 100 parts of the first coating composition.

### Wetting Agent

Some embodiments of the first coating composition can include a wetting agent. Wetting agents can include, for example, tributoxyethyl phosphate, fluorochemical surfactants, such as ethoxylated non-ionic fluorochemicals, anionic fluorochemical surfactants based on carboxylic acid, phosphate, sulfate, or sulfonate functionality, alcohol ethoxylate surfactants, organophosphate surfactants, organo-silicones, fluorine containing emulsion polymers or fluorine containing aqueous polymer dispersions, or others known to those of skill in the art.

The wetting agent can be less than about 10 wt % or less than about 7.5 wt % or less than about 5 wt % on active wt % based on 100 parts of the first coating composition. In other embodiments, the amount of wetting agent can be at least about 0.01 wt % or at least about 0.1 wt % on active wt % based on 100 parts of the first coating composition. This includes ranges of about 0 wt % to about 10 wt %, about 0.01 wt % to about 7.5 wt %, and about 0.1 wt % to about 5 wt % on active wt % based on 100 parts of the first coating composition.

### Leveling Agent

Some embodiments of the first coating composition can include a leveling agent. Leveling agents can include, for example, tributoxyethyl phosphate, salts of alkali soluble or dispersible resins (“ASR”), salts of fatty acids, such as tall oil fatty acid, nonionic surfactants, surfactants such as, but not limited to, organophosphate surfactants, acetylene based surfactants, organosulfate surfactants, organosulfonate surfactants, mono and diester organosulfosuccinate surfactants, organosilicone surfactants, polysiloxane surfactants, and combinations thereof. In some embodiments, the leveling agent concentration may be about 0 wt % to about 50 wt % on active wt % based on 100 parts of the first coating composition.

In some embodiments, the amount of leveling agent may be less than about 40 wt % or less than about 20 wt % or less than about 10 wt % on active wt % based on 100 parts of the first coating composition. In other embodiments, the amount of leveling agent may be at least about 0.1 wt %, at least about 0.2 wt %, or at least about 0.3 wt % on active wt % based on 100 parts of the first coating composition. This includes ranges of about 0.1 wt % to about 40 wt %, about 0.2 wt % to about 20 wt %, and about 0.3 wt % to about 10 wt % on active wt % based on 100 parts of the first coating composition.

### Wax Emulsion

Some embodiments of the first coating composition can include a wax emulsion. Wax emulsions can include, for example, plant (e.g. vegetable), animal, insect, synthetic, and/or mineral waxes. Suitable waxes include, but are not limited to, candelilla wax, Fisher-Tropsch wax, oxidized petroleum wax such as oxidized polyethylenes, oxidized polypropylenes, microcrystalline wax, lanolin wax, wax derived from cocoa butter, carnauba, cottonseed wax, stearin wax, Japan wax, bayberry wax, myrtle wax, wax derived from mace, palm kernel wax, beeswax, spermaceti, Chinese insect wax, wax made from mutton tallow, polyethylene wax, polypropylene wax, waxes based on copolymers of propylene and acrylic acid and/or methacrylic acid, wax based on copolymers of ethylene and acrylic acid and/or methacrylic acid, wax based on copolymers of ethylene and acrylic acid and/or methacrylic acid and/or maleic anhydride, wax based on copolymers of ethylene and styrene and/or other vinyl monomers, wax obtained from hydrogenation of coconut oil or soybean oil, mineral waxes such as paraffin, ceresin, montan, ozokerite, and maleated polypropylenes, and combinations thereof. In some embodiments, the wax emulsion may comprise a wax with an acid number greater than one.

In some embodiments, the wax emulsion concentration may be about 0 wt % to about 50 wt % on active wt % based on 100 parts first coating composition. In some embodiments, the amount of wax emulsion may be less than about 50 wt % or less than about 40 wt % or less than about 30 wt % on active wt % based on 100 parts of the first coating composition. In other embodiments, the amount of wax emulsion may be at least about 5 wt % or at least about 10 wt % on active wt % based on 100 parts of the first coating composition. This includes ranges of about 5 to about 40 wt % and about 10 to about 30 wt % on active wt % based on 100 parts of the first coating composition.

### Polyvalent Metal Ionic Crosslinker

Some embodiments of the first coating composition can include polyvalent metal ionic crosslinkers. Polyvalent metal ionic crosslinkers can include, for example, zinc ammonium carbonate. In some embodiments of the first coating composition, suitable polyvalent metals may be used as ionic crosslinking agents as described in U.S. Pat. No. 3,308,078 and U.S. Pat. No. 4,517,330. Suitable polyvalent metals can include, but are not limited to, beryllium, cadmium, copper, calcium, magnesium, zinc, zirconium, barium, strontium, aluminum, bismuth, antimony, lead, cobalt, nickel, were the metal compound is typically a metal complex, a metal salt of an organic acid, or a metal chelate. Ammonia and amine complexes of these may be particularly useful because of their high solubility. Particularly suitable are zinc ammonium carbonate, zinc oxide, zinc carbonate, zinc acetate, zinc glycinate, zinc benzoate, zinc salicylate, zinc glycolate, calcium oxide, calcium hydroxide, calcium carbonate, calcium acetate, calcium glycinate, and calcium glycolate.

In some embodiments, the amount of polyvalent metal ionic crosslinker can be less than about 10 wt % or less than about 5 wt % or less than about 2.5 wt % on active wt % based on 100 parts of the first coating composition. In other embodiments, the polyvalent metal ionic crosslinker concentration can be at least about 0.01 wt % or at least about 0.1 wt % on active wt % based on 100 parts of the first coating composition. This includes ranges of about 0 wt % to about 10 wt %, about 0.01 wt % to about 5 wt %, and about 0.1 wt % to about 2.5 wt % on active wt % based on 100 parts of the first coating composition. Some embodiments utilize about 1 wt % the polyvalent metal ionic crosslinker on active wt % based on 100 parts first coating composition. Still other embodiments include about 0.03 wt % polyvalent metal ionic crosslinker on active wt % based on 100 parts of the first coating composition.

In some embodiments, additions of zinc to the first coating composition and second coating composition may be made by additions of a solution of solubilized zinc oxide (i.e., zinc ammonium carbonate, the solution equates to adding 0.15 g ZnO/g solution). In some embodiments, zinc additions may be based on a molar ratio of active ZnO moles to the total moles of the carboxylic acid (“COOH”) functionality of the first coating composition polymer. In some embodiments, zinc additions may be based on a molar ratio of active ZnO moles to the total moles of the carboxylic acid functionality of the second coating composition polymer. In some embodiments, the mole ratio of ZnO/COOH to first coating composition polymer and second coating composition polymer may be at least about 0.01, at least about 0.02, or at least about 0.03. In some embodiments, the mole ratio may be up to about 0.5, up to about 0.4, or up to about 0.3. This includes mole ratio ranges of about 0.01 to about 0.5, about 0.02 to about 0.4, and about 0.03 to about 0.3.

### Alkali Soluble or Dispersible Resin

Some embodiments of the first coating composition can include alkali soluble or dispersible resins. Alkali soluble or dispersible resins can include, for example, polymers that include a polymerizable organic acid moiety such as, without limitation, acrylic acid (“AA”), methacrylic acid (“MAA”), or maleic anhydride. Suitable alkali soluble or dispersible resins may include, but are not limited to, acrylic-acrylic acid resins, styrene-acrylic acid resins, styrene-α-methyl styrene-acrylic acid resins, styrene-acrylic-acrylic acid resins, styrene-α-methyl styrene-acrylic-acrylic acid resins, acrylic-methacrylic acid, styrene-methacrylic acid resins, styrene-α-methyl styrene-methacrylic acid resins, styrene-acrylic-methacrylic acid resins, styrene-α-methyl styrene-acrylic-methacrylic acid resins, such as those described in U.S. Pat. No. 4,529,787, styrene-maleic anhydride resins, and polycarboxypolyamide resins as described in U.S. Pat. No. 6,518,334.

In some embodiments, the alkali soluble or dispersible resin may have an acid number greater than one. In some embodiments, the alkali soluble or dispersible resin concentration may be in the range of up to about 50 wt % or up to about 40 wt % or up to about 20 wt % or up to about 10 wt % on active wt % based on 100 parts of the first coating composition. In other embodiments, the alkali soluble or dispersible resin may be present on active wt % based on 100 parts of the first coating composition in at least about 0.1 wt % or at least about 0.2 wt % or at least about 0.3 wt % on active wt % based on 100 parts of the first coating composition. This includes ranges of about 0 wt % to about 50 wt %, about 0.1 wt % to about 40 wt %, about 0.2 wt % to about 20 wt %, and about 0.3 wt % to about 10 wt % on active wt % based on 100 parts of the first coating composition.

### Alkali Agent

Some embodiments of the first coating composition can include an alkali agent. In some embodiments, the alkali agent can include, for example, amines, hydroxides, carbonates, hydrazides, aziridines, which can be used to control or adjust latex pH and/or provide crosslinking with functional chemistries contained in the emulsion polymer. In some embodiments, alkali sources can include, without limitation, ammonium hydroxide (ammonia), triethyl amine, dimethylethanol amine, amino-2-methyl-1-propanol, 2-dimethylamino-2-methyl-1-propanol, ethanol amine, dimethylethanol amine, hydrazine, ethylene diamine, diethylene triamine, triethylene tetraamine, propylene diamine, butylene diamine, hexamethylene diamine, cyclohexylene diamine, piperazine, 2-methyl piperazine, phenylene diamine, toluene diamine, tris(2-aminoethyl)amine, 4,4′-methylenebis(2-chloroaniline), 3,3′-dichloro-4,4′-diphenyl diamine, 2,6-diaminopyridine, 4,4′-diaminophenyl methane, isophorone diamine, trimethoxysilylpropyl diethylenetriamine, triethoxysilylpropyl diethylenetriamine, N-methylaminopropyl trimethoxysilane, aminoethylaminopropylmethyl dimethoxysilane, aminoethylaminopropylmethyl diethoxysilane, aminoethylaminopropylmethyl trimethoxysilane, aminoethylaminopropylmethyl triethoxysilane, aminopropylmethyl dimethoxysilane, aminopropylmethyl diethoxysilane, aminopropyl trimethoxysilane, aminopropyl triethoxysilane, N-methylaminopropyl triethoxysilane, aminobutyl trimethoxysilane, aminobutyl triethoxysilane, sodium hydroxide, potassium hydroxide, rubidium hydroxide, cesium hydroxide, hydroxide beryllium, magnesium hydroxide, calcium hydroxide, strontium hydroxide, barium hydroxide, zinc ammonium carbonate, sodium bicarbonate, adipic dihydrazide, polyfunctional aziridines, such as Crosslinker CX-100 (DSM NeoResins Inc., Wilmington, Mass.), and combinations thereof.

In some embodiments, the alkali agent concentration may be about 0 wt % to about 10 wt % on active wt % based on 100 parts of the first coating composition. In some embodiments, the alkali agent may be present in up to about 5 wt % or up to about 3 wt % on active wt % based on 100 parts of the first coating composition. In other embodiments, the alkali agent may be present in at least about 0.01 wt % or at least about 0.1 wt % on active wt % based on 100 parts of the first coating composition. This includes ranges of about 0.01 to about 5 wt % and about 0.1 to about 3 wt % on active wt % based on 100 parts of the first coating composition.

### Polyfunctional Crosslinker

Some embodiments of the first coating composition can include a polyfunctional crosslinker to crosslink with functional groups contained in the first polymer composition. Suitable polyfunctional crosslinkers can include, but are not limited to, polycarbodiimides, such as, for example, Crosslinker XL-1 (DSM NeoResins Inc., Wilmington, Mass.) or polyfunctional isocyantes, such as, for example, Bayhydur water dispersible polyfunctional isocyantes based on hexamethylene or isophorone diisocyanate chemistry (Bayer Material Science AG, Leverkuser, Germany), or polyfunctional aziridines, such as, for example, Crosslinker CX-100 (DSM NeoResins Inc., Wilmington, Mass.).

In some embodiments, polyfunctional crosslinker concentration may be about 0 wt % to about 10 wt % on active wt % based on 100 parts of the first coating composition.

The balance of the first coating composition may be water.

Suitably the pH of the first coating composition is greater than about 5, and may be less than about 11. This includes a pH of between about 6 and about 10.

In some embodiments, the viscosity of the first coating composition can be between about 1 centipoise (“cps”) and about 10,000 cps, about 1 cps and about 1,000 cps, about 1 cps and about 100 cps, about 1 cps and about 50 cps, about 30 cps and about 10 cps, and in some embodiments between about 1 cps and about 8 cps. In some embodiments, the viscosity of the first coating composition may be less than about 10,000 cps, less than about 1,000 cps, and less than about 100 cps, and less than about 50 cps.

The first coating composition can also include defoamers, such as, for example, polysiloxane, silicone, silicone emulsions, or acetylene-based defoamers. Various preservatives, dyes, pigments, fragrances, nanoparticles, and other additives can also be included in some embodiments.

### Physical Blend Polymers

In some embodiments, the first coating composition can contain a first polymer composition composed of a physical blend of emulsion polymers. In some embodiments physical blends of acrylic emulsion polymers and styrene-acrylic emulsion polymers. In some embodiments physical blends of styrene-acrylic emulsion polymers and styrene-butadiene emulsion polymers or physical blends of acrylic emulsion polymers and styrene-butadiene emulsion polymers.

### First Coating

The first coating 8 is applied to the floor surface 4 or optionally to the base coating 6 such that the floor surface 4 or the base coating 6 is completely, substantially, or partially covered by the first coating 8. In some embodiments, multiple coats of the first coating composition may be applied on top of the floor surface 4 to yield a suitable dry weight coating film thickness. In other embodiments, one or two coats of the first coating composition may be applied on top of the floor surface 4 to yield a suitable dry weight coating film thickness. In some embodiments, the first coating composition may be applied at a rate of about 4,000 sq. ft/gal to about 125 sq. ft/gal, where the first coating composition has a solids content of about 1 wt % to about 75 wt % solids, and which can result in a dry weight coating film thicknesses range of about 0.002 mil (0.000002 inch) or about 0.00007 grams/sq. inch to about 4.8 mil (0.0048 inch) or about 0.167 grams/sq. inch of the first coating 8 using traditional mop and bucket methods of application or other suitable applicators. In some embodiments, the first coating composition may be applied at a rate of about 4000 sq. ft/gal to about 125 sq. ft/gal, where the first coating composition has a solids content of about 5 wt % to about 50 wt % solids, and which can result in a dry weight coating film thicknesses range of about 0.01 mil (0.00001 inch) or about 0.00035 grams/sq. inch to about 3.2 mil (0.0032 inch) or about 0.111 grams/sq. inch of the first coating 8. In some embodiments, the first coating composition may be applied at a rate of about 4000 sq. ft/gal to about 125 sq. ft/gal, where the first coating composition has a solids content of about 10 wt % to about 20 wt % solids, and which can result in a dry weight coating film thicknesses range of about 0.02 mil (0.00002 inch) or about 0.0007 grams/sq. inch to about 1.3 mil (0.0013 inch) or about 0.044 grams/sq. inch of the first coating 8. In some embodiments, the first coating composition may be applied at a rate of about 4,000 sq. ft/gal to about 2000 sq. ft/gal, where the first coating composition has a solids content of about 1 wt % to about 20 wt % solids, and which can result in a dry weight coating film thicknesses range of about 0.002 mil (0.000002 inch) or about 0.00007 grams/sq. inch to about 0.2 mil (0.0002 inch) or about 0.006 grams/sq. inch of the first coating 8 using traditional mop and bucket methods of application or other suitable applicators. In some embodiments, the first coating 8 dry weight coating film thickness may be at least about 0.002 mil, at least about 0.01 mil, at least about 0.1 mil, or at least about 1 mil. However some embodiments can include a first coating 8 of more than 1 mil dry weight coating film thickness depending at least in part upon the types of the floor surface 4 and/or first coating 8 utilized. Alternatively, several thicker coat layers of the first coating composition can be applied to create a first coating 8 of suitable dry weight coating film thickness. In some embodiments, about 10, about 15, or about 20 coat layers of the first coating composition can be applied to create a first coating 8 of suitable dry weight coating film thickness.

In some embodiments, the dry weight first coating composition deposition may be greater than about 0.0001 g/sq. inch.

### Second Coating Composition

The second coating 10 and the second coating composition may each include at least a second polymer composition. In addition, the second coating composition can also include additives to enhance performance. For example, the second coating composition can include an organic solvent coalescing agent, a wetting agent, a leveling agent, a wax emulsion, a polyvalent metal ionic crosslinker, an alkali soluble or dispersible resin, an alkali agent, a polyfunctional crosslinker, or a combination thereof. Additives that may be used to enhance performance of the second coating composition may be the same as those additives use to enhance the performance of the first coating composition, and are described above. The second coating composition may include components as detailed in Table 4.

TABLE 4
Second Coating Composition

| | Amount |
|---|---|
| | (Active Wt % on 100 Wet Parts |
| Component | Second Coating Composition) |
| Second Polymer Composition | 10-75 |
| Organic Solvent Coalescing Agent | 0-50 |
| Wetting Agent | 0-10 |
| Leveling Agent | 0-50 |
| Wax Emulsion | 0-50 |
| Polyvalent Metal Ionic Crosslinker | 0-10 |
| Alkali Soluble or Dispersible Resin | 0-50 |
| Alkali Agent | 0-10 |
| Polyfunctional Crosslinker | 0-10 |
| Water | 25-90 |

### Second Polymer Composition

Examples of second polymer compositions can include, without limitation, a polyurethane emulsion, an IPN polymer emulsion, a hybrid emulsion polymer, such as, for example, a polyurethane/acrylic hybrid emulsion, or an emulsion polymer, such as, an acrylic emulsion polymer, a vinyl emulsion polymer, a vinyl-acrylic emulsion polymer, or a styrene-acrylic emulsion polymer. Other suitable polymer compositions are known to those skilled in the art. In some embodiments, a physical blend of more than one polymer composition can be used.

### Polyurethane Emulsion Polymers

In some embodiments, the second polymer composition may include polyurethane emulsion polymer compositions formed by step addition (condensation) polymerization of diol and diisocyante monomers, or precondensed oligomer diols and/or diisocyantes, and then converted into an emulsion form. Preferred polyurethane emulsion polymer compositions may include composition structures, such as, without limitation, polyester or polycarbonate based polyurethane emulsion polymers, polyether or polybutadiene or polyamide or polyurea or polyester-polyurea based polyurethane emulsion polymers, or mixtures thereof. Typically, ionizable functional group including diols or diisocyantes are employed during the step addition polymerization to allow greater ease of the polyurethane emulsification. Suitable polyurethane emulsion polymers may be prepared by, reducing, dispersing, or emulsifying polyurethane polymers into water. Suitable polyurethane emulsion polymers may be stabilized anionically, cationically, or nonionically. Polyurethane emulsion polymers may be polymerized and emulsified from, neat reacted diol and diisocyanate monomers, or reacted diol and diisocyanate monomers in a solution of organic solvent, or reacted diol and diisocyanate monomers in a solution of ethylenically-unsaturated monomer, to provide a polyurethane emulsion polymer. IPNs can be prepared from the latter by conducting a free radical emulsion polymerization of the ethylenically-unsaturated monomer in the presence of the emulsified polyurethane. Typically the diisocyanate monomer is in a stoichiometric excess which renders the polyurethane isocyanate functional before emulsification. Polyurethane emulsion polymers may be chain extended during the emulsification process to build polyurethane molecular weight and/or crosslink density, typically, by reacting the isocyanate functional polyurethane with diamines or polyfunctional amines. Polyurethane emulsion polymers are known to those skilled in the relevant arts and are disclosed, for example, in U.S. Pat. No. 4,501,852, U.S. Pat. No. 4,644,030, U.S. Pat. No. 4,927,876, U.S. Pat. No. 5,037,700, U.S. Pat. No. 5,055,516, U.S. Pat. No. 5,137,961, U.S. Pat. No. 5,173,526, U.S. Pat. No. 5,231,130, U.S. Pat. No. 5,270,383, U.S. Pat. No. 5,371,133, and U.S. Pat. No. 5,945,473, all of which are hereby incorporated by reference in their entireties. In some embodiments, the polyurethane emulsion polymer may comprise a polyurethane with an acid number greater than one.

In some embodiments, the second polymer composition may be a polyurethane emulsion polymer with a concentration that may be about 0% to 75% on active wt % based on 100 parts of the second coating composition. In some embodiments, the polyurethane emulsion polymer may be up to about 10 wt % or up to about 20 wt % on an active wt % based on 100 parts of the second coating composition. In other embodiments, the polyurethane emulsion polymer can be present in an amount of at least about 60 wt % or at least 50 wt % on active wt % based on 100 parts of the second coating composition. This includes ranges of about 10 wt % to about 60 wt % and about 20 wt % to about 50 wt % on active wt % based on 100 parts of the second coating composition.

In some embodiments, suitable second polymer compositions may include a polyurethane emulsion polymer that has a glass transition value (T_{g}) of from about −80° to about 80° C. For example, the T_{g} may be less than about 80° C., less than about 60° C., less than about 50° C., or less than about 0° C. The T_{g} may be greater than about −80° C., greater than about −60° C., or greater than about −50° C. This includes ranges of about −60° C. to about 60° C., about −50° C. to about 50° C., and about −50° C. to about 0° C. In those embodiments in which a physical blend of polymer compositions is used, each polymer composition may have a different T_{g}. In some embodiments, the polyurethane emulsion polymer may include a polyester, a polycarbonate, a polyether, a polybutadiene, a polyamide, a polyurea, or a polyester-polyurea structure, or a combination thereof. In some embodiments, the polyurethane may have an acid number greater than one.

### Hybrid Emulsion Polymers

In some embodiments, suitable second polymer compositions may include a hybrid emulsion polymer. A hybrid emulsion polymer may refer to a polymer composition including an IPN that is primarily a microphase separated polymer morphology consisting of a continuous polyurethane polymer matrix phase and microphase separated domains of an acrylic or styrene-acrylic or styrene or vinyl, or vinyl-acrylicpolymer dispersed within the polyurethane polymer matrix phase prepared by the polymerization of such monomers in the presence of polyurethane emulsions. In some embodiments, a hybrid emulsion polymer can be a polyurethane/acrylic hybrid emulsion. Polyurethane emulsion polymer components comprising hybrid emulsion polymer compositions may be the same polyurethane emulsion polymers as those described above under polyurethane emulsion polymers. Components that may be used to prepare hybrid emulsion polymer to be used as second polymer compositions may be the same as those components used to prepare first polymer compositions as described above. In some embodiments, components of a hybrid emulsion polymer can include those listed in Table 5.

TABLE 5
Hybrid Emulsion Polymer

| | Amount |
|---|---|
| | (Active wt % on 100 wet parts |
| Component | Hybrid Emulsion Polymer) |
| Polyurethane Emulsion | 15-60 |
| Monomer | 2-50 |
| Multi-Functional Crosslinking | 0-15 |
| Monomer | |
| Surface-active agents | 0-6 |
| Protective Polymer Colloid | 0-40 |
| Free Radical Initiator | 0.01-2 |
| Modifier | 0-1 |
| Buffer | 0-1 |
| Alkali Agent | 0-5 |
| Oxidizing Agent Redox Scavenger | 0-1 |
| Reducing Agent Redox Scavenger | 0-1 |
| Water | 25-83 |

In some embodiments, the acrylic or styrene-acrylic or styrene or vinyl or vinyl-acrylic polymer component of the hybrid emulsion polymer may include more than one of the following ethylenically-unsaturated monomers. In some embodiments, the acrylic or styrene-acrylic or styrene or vinyl or vinyl-acrylic polymer component of the hybrid emulsion polymer may include at least one of the following ethylenically-unsaturated monomers including, but not limited to, styrene, and substituted styrenes monomers, such as, without limitation, alpha-methyl styrene, para-methyl styrene, tert-butyl styrene, vinyl toluene, and acrylate; methacrylate monomers, such as, without limitation, methyl methacrylate, tert-butyl methacrylate, isobutyl methacrylate, ethyl methacrylate, butyl methacrylate, hexyl methacrylate, lauryl methacrylate, benzyl methacrylate, cyclohexyl methacrylate, isobornyl methacrylate, stearyl methacrylate, hydroxyethyl methacrylate, hydroxypropyl methacrylate, gylcidyl methacrylate, acetoacetoxyethyl methacrylate, acetoacetoxypropyl methacrylate, acetoacetoxybutyl methacrylate, 2,3-di(acetoacetoxy)propyl methacrylate, dimethylaminoethyl methacrylate, tert-butylaminoethyl methacrylate, methacryloxypropyltrimethoxysilane, methacryloxypropyltriethoxysilane, methacryloxypropyltriisopropoxysilane, butyl acrylate, 2-ethylhexyl acrylate, methyl acrylate, ethyl acrylate, propyl acrylate, isopropyl acrylate, hexyl acrylate, isobutyl acrylate, tert-butyl acrylate, benzyl acrylate, isobornyl acrylate, cyclohexyl acrylate, laurel acrylate, hydroxyethyl acrylate, hydroxypropyl acrylate, gylcidyl acrylate, acetoacetoxyethyl acrylate, acryloxypropyltrimethoxysilane, acryloxypropyltriethoxysilane, and acryloxypropyltriisopropoxysilane; acrylic amides such as, without limitation, acrylamide, methacrylamide, N-methyl acrylamide, N-methyl methacrylamide, N-methylol acrylamide, N-methylol methacrylamide, diacetoneacrylamide, and diacetonemethacrylamide; α,β-ethylenically unsaturated mono- and dicarboxylic acids such as, without limitation, methacrylic acid, acrylic acid, crotonic acid, maleic acid, fumaric acid, and itaconic acid; vinyl esters of alkanoic acids having from 1 to about 18 carbon atoms such as, without limitation, vinyl acetate, vinyl formate, vinyl propionate, vinyl butyrate, vinyl isobutyrate, vinyl valerate, vinyl 2-ethylhexanoate, vinyl isooctanoate, vinyl nonoate, vinyl decanoate, vinyl pivalate, vinyl laurate, vinyl stearate, vinyl benzoate, and vinyl versatate; vinyl halide monomers such as, without limitation, vinyl chloride, vinylidene chloride, vinylidene fluoride, vinyltrimethoxysilane, vinyltriethoxysilane, and vinyltriisopropoxysilane; heterocyclic vinyl monomers such as, without limitation, vinyl pyrrolidones, and vinyl pyridines; vinyl amides, such as, without limitation, vinyl formamide, and vinyl acetamide; other vinyl monomers such as, without limitation, acrylonitrile and methacrylonitrile; vinyl alkyl ethers having an alkyl group with 1 to about 18 carbon atoms such as, without limitation, methyl vinyl ether, ethyl vinyl ether, butyl vinyl ether, and stearyl vinyl ether; polyethylenically unsaturated monomers such as, without limitation, vinyl crotonate, allyl acrylate, allyl methacrylate, divinyl adipate, diallyl adipate, diallyl maleate, divinyl benzene, diallyl phthalate, ethylene glycol diacrylate, ethylene glycol dimethacrylate, butanediol diacrylate, butanediol dimethacrylate, hexanediol diacrylate, hexanediol dimethacrylate, methylene bis acrylamide, triallyl cyanurate, trimethylolpropane triacrylate, and trimethylolpropane trimethacrylate; and additional functional monomers such as, without limitation, phosphate esters of polyethylene glycol monomethacrylate, phosphate esters of polypropylene glycol monomethacrylate, vinyl sulfonic acid, and 2-acrylamido-2-methylpropane sulfonic acid. In some embodiments, the monomer may comprise about 2 wt % to about 50 wt %, about 2.5 wt % to about 25 wt %, or about 3 wt % to about 15 wt % on active wt % based on 100 parts of the hybrid emulsion polymer.

In some embodiments, the second polymer composition may include a hybrid emulsion polymer, such as, for example, a polyurethane/acrylic hybrid emulsion with a concentration that may be about 0 wt % to about 75 wt %, about 10 wt % to about 60 wt %, or about 20 wt % to about 50 wt % on active wt % based on 100 parts of the second coating composition.

In some embodiments, the second polymer composition may include a hybrid emulsion polymer composition comprising a polyurethane emulsion polymer component and an acrylic or styrene-acrylic or styrene or vinyl or vinyl-acrylic polymer component. In some embodiments, the second polymer composition may include a hybrid emulsion polymer composition comprising a polyurethane emulsion polymer component and a acrylic or styrene-acrylic or styrene or vinyl or vinyl-acrylic polymer component in a ratio of about 20 wt % to about 80 wt % dry weight polyurethane based on total dry weight of the hybrid emulsion polymer composition. In some embodiments, the hybrid emulsion polymer may have an acid number greater than one.

In some embodiments, the acrylic or styrene polymer component of the hybrid emulsion polymer composition can include, but not limited to, for example, poly(methyl methacrylate), poly(tert-butyl methacrylate), poly(styrene), or a copolymer thereof. In some embodiments, the polyurethane and at least one of poly(methyl methacrylate), poly(tert-butyl methacrylate), poly(styrene), or a copolymer thereof may form an interpenetrating polymer network.

### Emulsion Polymers

Suitable emulsion polymers for use in the second polymer composition may include emulsion polymers suitable for use in the first polymer composition and are described above. In some embodiments, the emulsion polymer concentration in the second coating composition may be about 0 wt % to about 50 wt %, about 0.1 wt % to about 30 wt %, about 0.5 wt % to about 20 wt %, or about 1 wt % to about 10 wt % on active wt % based on 100 parts of the second coating composition.

In some embodiments, the second polymer composition may also include an emulsion polymer, such as, an acrylic emulsion polymer, a vinyl emulsion polymer, a vinyl-acrylic emulsion polymer, a styrene-acrylic emulsion polymer, or a combination thereof. In some embodiments, the emulsion polymer may have a T_{g} from about 20° C. to about 120° C., about 30° C. to about 110° C., about 40° C. to about 100° C., or about 50° C. to about 90° C. In those embodiments in which a physical blend of polymer compositions is used, each polymer composition may have a different T_{g}.

### Physical Blend Polymers

In some embodiments, the second coating composition can include a second polymer composition comprising a physical blend of emulsion polymers. In some embodiments, the physical blend of emulsion polymers can include a physical blend of acrylic or styrene-acrylic emulsion polymers and polyurethane emulsion polymers. In some embodiments, the physical blend of emulsion polymers can include a physical blend of hybrid emulsion polymers and acrylic or styrene-acrylic emulsion polymers or a physical blend of hybrid emulsion polymers and polyurethane emulsion polymers. In some embodiments, the physical blend of emulsion polymers can include a physical blend of hybrid emulsion polymers and acrylic or styrene-acrylic emulsion polymers and polyurethane emulsion polymers.

Additives that may be used to enhance performance of the second coating composition (i.e., an organic solvent coalescing agent, a wetting agent, a leveling agent, a wax emulsion, a polyvalent metal ionic crosslinker, an alkali soluble or dispersible resin, an alkali agent, and a polyfunctional crosslinker) may be the same as those additives use to enhance the performance of the first coating composition, and are described above.

In some embodiments, additional components that affect the optical properties (“optical components”) of the second coating 10 may be added to the second coating composition in order to reduce the glossiness of the second coating 10 and to produce a matte finish (“matte optical components”). A matte finish can improve the appearance of the floor by making defects less noticeable, and can give the floor a more uniform appearance. Suitable matte optical components may include, but are not limited to, fumed silica, silica gels, magnesium aluminum silicate clays such as smectite clays including, without limitation, bentonite, montmorillonite, nontronile; saponite such as, without limitation, Van gel and Veegum clays (R.T. Vanderbilt Co. Inc., Norwalk, Conn.); Laponite clays (Southern Clay Products Inc., Austin, Tex.), ethoxylated or propoxylated polyethylene, xanthan gum, emulsion polymer pigments, and hollow glass microspheres. These components are typically used in a range of about 0 wt % to about 10 wt % of the second coating composition. The components that are added to reduce gloss and produce a matte finish can have a different index of refraction than the first coating 8, the base coating 6 or floor surface 4. Other suitable optical components are known to those skilled in the art. In some embodiments, the optical components may comprise about 0 wt % to about 10 wt %, about 0.01 wt % to about 9 wt %, or about 0.1 wt % to about 5 wt % on active wt % based on 100 parts of the second coating composition.

The balance of the second coating composition may be water.

Suitably the pH of the second coating composition is greater than about 5, and may be less than about 11. This includes a pH of between about 6 and about 10.

In some embodiments, the viscosity of the second coating composition can be between about 1 centipoise (“cps”) and about 10,000 cps, about 1 cps and about 1,000 cps, about 1 cps and about 100 cps, about 1 cps and about 50 cps, about 30 cps and about 10 cps, and in some embodiments between about 1 cps and about 8 cps. In some embodiments, the viscosity of the second coating composition may be less than about 10,000 cps, less than about 1,000 cps, less than about 100 cps, and less than about 50 cps.

### Second Coating

The second coating 10 may be applied to the first coating 8 such that the first coating 8 is substantially or completely covered by the second coating 10. In some embodiments, multiple coats of the second coating composition may be applied on top of the first coating 8 in order to yield a suitable dry weight coating film thickness. In other embodiments, one or two coats of the second coating composition may be applied on top of the first coating 8 in order to yield a suitable dry weight coating film thickness. In some embodiments, the second coating composition may be applied at a rate of about 2,000 sq. ft/gal to about 125 sq. ft/gal, where the second coating composition has a solids content of about 25 wt % to about 75 wt % solids, and which can result in a dry weight coating film thicknesses range of about 1 mil (0.001 inch) or about 0.03 grams/sq. inch to about 50 mil (0.05 inch) or about 2.0 grams/sq. inch of the second coating 10 using traditional mop and bucket methods of application or other suitable applicators. In some embodiments, the second coating composition may be applied at a rate of about 1,500 sq. ft/gal to about 250 sq. ft/gal, where the second coating composition has a solids content of about 25 wt % to about 50 wt % solids, and which can result in a dry weight coating film thicknesses range of about 1.5 mil (0.0015 inch) or about 0.05 grams/sq. inch to about 16 mil (0.016 inch) or about 0.6 grams/sq. inch of the second coating 10. In some embodiments, the second coating composition may be applied at a rate of about 1,250 sq. ft/gal to about 500 sq. ft/gal, where the second coating composition has a solids content of about 25 wt % to about 50 wt % solids, and which can result in a dry weight coating film thicknesses range of about 1.75 mil (0.00175 inch) or about 0.06 grams/sq. inch to about 8 mil (0.008 inch) or about 0.3 grams/sq. inch of the second coating 10. In some embodiments, the second coating 10 dry weight coating film thickness may be at least about 1 mil, at least about 2 mil, at least about 3 mil, or at least about 4 mil. However some embodiments can include a second coating 10 of less than 1 mil dry weight coating film thickness depending at least in part upon the types of first coating 8 and/or second coating 10 utilized. Alternatively, several thinner coat layers of the second coating composition can be applied to create a second coating 10 of suitable dry weight coating film thickness. In some embodiments, about 10, about 15, or about 20 coat layers of the second coating composition can be applied to create a second coating 10 of suitable dry weight coating film thickness.

In some embodiments, dry weight second coating composition deposition is greater than about 0.03 g/sq. inch.

In some embodiments, the adhesion of the second coating 10 to the first coating 8 may be such that the layers remain adhered to each other when the layers are physically peeled from the floor surface 4 or the optional base coating 6.

In some embodiments, the adhesion of the second coating 10 to the first coating 8 may be such that the layers separate from each other when the second coating 10 is physically peeled from the floor surface 4 or the optional base coating 6, and the first coating 8 remains adhered on the top floor surface 4 or the optional base coating 6 after second coating 10 is removed.

### Peelable Coating

In another aspect, a method of coating a surface is provided. In some embodiments, the method includes applying a first coating composition comprising a first polymer composition to the surface to form a first coating and applying a second coating composition comprising a second polymer composition to the first coating to form a second coating, wherein the first coating and the second coating form a peelable coating.

In some embodiments, peel strength of peelable coating systems 2 may be assessed by peeling a one-inch wide film strips 90° to the film surface with a peel rate of about 1,000 milimeters/minute (“mm/min”). In some embodiments, the peel strength may be determined using an INSTRON® 3345 single column testing instrument with a 500 N (50,985 g-force) load cell capacity. In some embodiments, the peel force may range from about 50 g-force to about 2000 g-force, about 100 g-force to about 1750 g-force, and about 200 g-force to 1500 g-force. The peel force may be greater than about 50 g-force, greater than about 100 g-force, or greater than about 200 g-force. The peel force may be less than about 2000 g-force, less than about 1750 g-force, or less than about 1500 g-force.

In some embodiments, tensile property and elongation values of peelable coating systems 2 may be assessed by placing a one-inch wide by three-inch long film strip specimen in tension and applying a extension force of about 30 mm/min to the specimen. In some embodiments, the tensile property and elongation values may be determined using an INSTRON® 3345 single column testing instrument with a 500 N (50,985 g-force) load cell capacity. As used herein, the term “ultimate tensile strength” shall be defined as the maximum stress that a sample endures during a tensile property test. As used herein, the term “break force” shall be defined as the force applied to a sample at the point where the sample breaks or tears during a tensile property test. Specimen ultimate tensile strength can be expressed in force per unit cross-sectional area of the unstrained specimen in units of pounds/square inch (psi). Specimen break force can be expressed in units of gram-force (gf). In some embodiments, the ultimate tensile strength may range from about 500 psi to about 20,000 psi, about 1000 psi to about 15,000 psi, and about 1500 psi to about 10,000 psi. The ultimate tensile strength may be greater than about 500 psi, greater than about 1000 psi, or greater than about 1500 psi. The ultimate tensile strength may be less than about 20,000 psi, less than about 15,000 psi, or less than about 10,000 psi. In some embodiments, the break force may range from about 500 gf to about 20,000 gf, about 1000 gf to about 15,000 gf, and about 1500 gf to about 10,000 gf. The break force may be greater than about 500 gf, greater than about 1000 gf, or greater than about 1500 gf. The break force may be less than 20,000 gf, less than about 15,000 gf, or less than 10,000 gf. Elongation values are a measurement of the increase in specimen length from the point of initial load application to the point of film specimen rupture in a tension test. Elongation values are expressed as percent (%) elongation. In some embodiments, the % elongation may range from about 50% to about 1000%, about 100% to about 800%, about 150% to about 600%. Elongation may be greater than about 50%, greater than about 100%, or greater than about 150%. Elongation may be less than about 1000%, less than about 800%, or less than about 600%. ASTM test method D2370 covers the determination of tensile strength and elongation values of a specimen.

In some embodiments, the peelable coating 12 may rate at least fair, at least good, at least very good according to the Snell Capsule rating scale using ASTM test method D 1630-94.

### Optional Base Coating

The optional base coating may be an existing surface that has been modified with a coating or a treatment rendering the surface chemically altered. Examples of existing base coatings are traditional floor finishes, such as, polymer-based floor coatings, such as, for example, coatings of VECTRA™, SIGNATURE™, CAREFREE™, PLAZA PLUS™, JONCRETE™ MATTE, and JONCRETE™ SA (all available from Diversey Inc., Sturtevant, Wis.) or durable semi-permanent coatings, such as those including urethanes, epoxy, or silane technologies, or, durable, highly cross-linked coatings, such as those including UV-cured polymers such as UV-cured urethanes, UV-cured acrylics, crosslinked polyurethanes, crosslinked acrylics, and crosslinked epoxies, or substrates including factory-applied coatings, concrete treatments, such as, for example, penetrating sealers (e.g., fluorinated or silicone surfactant based), densifiers (e.g., silicates or siliconates) or other suitable coatings and treatments that are known to those skilled in the art. Base coatings that may be used in some embodiments are disclosed in U.S. Patent Application 61/264,465 filed Nov. 25, 2010, and in U.S. Patent Application 61/264,471 filed Nov. 25, 2010, the contents of which are hereby incorporated by reference in their entireties.

In some embodiments, a base coating may have a dry weight coating thickness of about 0.01 mil to about 100 mils.

Additional components that can be added to any of the compositions described and/or illustrated herein include embedded particles, such as abrasives to increase traction and prevent slipping. Suitably, the particles have a size of about 50 to about 500 microns. Embedded particles can also be added to the second coating composition to provide a slip-resistant surface.

Another component that can be added to any of the compositions described and/or illustrated herein is an optical component such as a reflective particle material that improves the appearance of the floor and can enhance the lighting of a space in which the peelable floor surface coating system 2 is installed. Suitably, these include glass microspheres or metallized glass microspheres ranging in size from about 1 to about 100 micrometers. Among other advantages, addition of one or more components such as those listed above which change the optical properties of a layer can aid proper application of the coatings, insofar as the added components help in visualizing where the coatings have and have not been already applied. This is especially important in cases in which the coatings form thin, clear layers that can be difficult to distinguish from one another, such that even a difference in finish (e.g. a matte-finish first coating 8 being applied on top of a glossy base coating 6) can assist in applying the coatings to determine where the new coating has been applied.

The base coating 6 has a greater adhesion to floor surface 4 than to the first coating 8. In some embodiments the adhesion of the second coating 10 applied to the first coating 8 is greater than the adhesion of the first coating 8 to the floor surface 4 or the optional base coating 6. Also in some embodiments, the adhesion of the second coating 10 to the first coating 8 is sufficiently strong that the second coating 10 and the first coating 8 are adhered together during the physical removal of the layers. The second coating 10 can confer durability and aesthetic characteristics to the peelable floor surface coating system 2, such as, for example, water resistance, alcohol resistance, scratch resistance, soil resistance, scuff and black heel mark resistance, stain resistance, slip resistance, and gloss.

### Optional Topcoat Layer

The optional topcoat layer may include a traditional floor finish, such as, for example, polymer-based floor coatings. Polymer-based floor coatings may include, for example, coatings of VECTRA™, SIGNATURE™, CAREFREE™, PREMIA™ (all available from Diversey Inc., Sturtevant, Wis.), or durable semi-permanent coatings, such as those including urethanes, epoxy, or silane technologies, or, durable, highly cross-linked coatings, such as those including UV-cured polymers such as UV-cured urethanes, UV-cured acrylics, crosslinked polyurethanes, crosslinked acrylics, and crosslinked epoxies, or other suitable coatings that are known to those skilled in the art.

In some embodiments, a topcoat layer may have a dry weight coating thickness of about 0.01 mil to about 100 mils.

In some embodiments, multiple layers of the peelable floor surface coating system 2 can be applied on top of one another so that the older, top layer can be peeled off at a later time to reveal a fresh wear surface. Each of the multiple layers of the peelable floor surface coating system 2 includes at least the first coating 8 and second coating 10.

In practice, prior to finishing or coating a floor surface 4 with a peelable floor surface coating system 2 according to any of the embodiments described herein, the floor surface 4 can initially be cleaned or stripped of any other finish or dirt. Those skilled in the art would readily understand how to accomplish this task. Stripping can be performed using a conventional stripper such as PROSTRIP or FREEDOM from Diversey, Inc. of Sturtevant, Wis., AX-IT or EXTREME from Betco Corp. of Toledo, Ohio, or DA-70 or SQUARE ONE from Spartan Chemical Company of Maumee, Ohio.

After the floor surface 4 has been allowed to dry following stripping, at least one coat of the first coating 8 can be applied to the floor surface 4 and further coated with multiple coats of the second coating 10. The first coating and second coating compositions can be applied utilizing a mop and bucket, a flat mop, a T-bar, a roller applicator, or other application device and technique known to those of skill in the art. In some embodiments, coating compositions are applied at a coating rate of about 125 square feet per gallon to 4,000 square feet per gallon, depending at least in part upon the viscosity of the first and second coating compositions. For a composition with a higher viscosity, it may be desirable to use an applicator that rolls on or spreads the composition, such as a T-bar, pad, or roller. In some embodiments, coating compositions are allowed to dry for about 30-120 minutes per coat depending on the amount of coating being deposited.

When subsequently addressing the removal of the second coating 10 after it has been damaged, scuffed, dirtied, etc., the need for conventional stripping agents is eliminated. In practice, to remove the second coating 10, which may have become damaged, worn, or dirty over time, one makes a small, inconspicuous cut in the surface of the finish, and grasps, by hand or with a tool, a corner or edge of the first coating 8 with the second coating 10 disposed thereon and begins to peel, in sheet form, the first coating 8 and second coating 10 away from the floor surface 4. The term “sheet” is in no way meant to imply any particular size or dimension. However, in practice, the larger the “sheet” removed, the quicker the overall removal is accomplished. The base coating 6 (if present) remains affixed or adhered to the floor surface 4 during such removal process, as shown in FIG. 4. As conventional stripping agents are eliminated from the removal process, the removal process can be less expensive, less energy-intensive, less time-consuming, and less hazardous, and also eliminates the need for stripping chemicals.

To accomplish the removal of the first coating 8 and second coating 10 i.e., the peelable coating 12, a user can manually peel sections or sheets of the peelable coating 12 in multiple repeat steps, or can accomplish it in one large sheet. Alternatively, as an example, a tool that scores the layers and includes a roller can be used and run over the floor to more neatly and efficiently remove the layers in uniform sheets. After removal of the layers, a new first coating 8 can be applied over the floor surface 4 (or directly upon the base coating 6 in suitable applications as described above). A second coating 10 can then be applied on top of the first coating 8 after it has cured or dried. This can be accomplished as previously described in the initial application of the peelable floor surface coating system 2.

It may be desirable in some cases to repair only a portion of a damaged second coating 10 or peelable floor surface coating system 2. To accomplish this, the damaged area can be removed using any suitable technique, such as cutting out using a razor blade or other tool suitable for cutting the layers, and peeling only the cut out section away creating an exposed surface. After removal, the first coating 8 can be re-applied to an exposed surface (i.e., the area where the section was removed) to form a repaired first coating 8. After the first coating 8 dries, a second coating 10 can then be applied to obtain a repaired coating. Due to the polymeric nature of the first coating 8, it can re-form one complete film with the original first coating 8 around it, such that in some embodiments it can be peeled as part of a larger piece of the already existing layers during subsequent removal.

To remove the first coating 8 and the layers thereon, a starter mechanism can be pulled through the top layers (i.e., the first coating 8, the second coating 10 and, optionally, any topcoat layers thereon) to create a defined edge that can be used to peel the peelable coating 12 from the underlying floor surface 4 or the optional base coating 6. The starter mechanism can be accessed by way of a starter strip, which can be exposed above the various layers, or by cutting through the top layers 8, 10 to reach an embedded starter strip. The starter mechanism may be such as that described in PCT/US10/58040 filed Nov. 24, 2010, which is incorporated by reference herein in its entirety. One of ordinary skill in the art would be able to determine a suitable starter mechanism for use in the invention.

In other embodiments, the peelable floor surface coating system 2 is applied to surfaces other than floors, including, for example, other substantially horizontal surfaces, such as surgical tables, food preparation surfaces, kitchen surfaces, bathroom surfaces, desks, tables, as well as vertical surfaces, such as walls, windows, and the like, as well as irregular surfaces, such as food preparation equipment, vessels, tanks, parts, and the like, to name but a few possible uses.

It should be understood that there may be one or more additional layers between the layers described above. In this manner, the layers may be applied directly or indirectly to one another.

### EXAMPLES

### Example 1

### Preparation of Styrene-Acrylic and Acrylic Emulsion Polymers for Use in an Aqueous First Coating Composition

First Polymer Composition Samples FP1 through FP23 were prepared using Example 1 procedure. Only variable monomer type and amount differentiates samples. First Polymer compositions (“FP”) are shown in Table 6.

### First Polymer Composition Sample Number FP5.

Procedure: A four-necked round bottom flask (2 L) was equipped with a heating/cooling system means to control and change temperature, a cold water condenser, a variable rate anchor paddle for agitation, and mechanical pumps as a means for metering in monomers. The flask was charged with deionized (“DI”) water (540 g), RHODAFAC® RS-410 (13.3 g 100%; Rhodia Inc., Cranbury, N.J.), TERGITOL™ 15-S-3 (3.0 g 100%; Dow Chemical Company, Midland, Mich.), and an aqueous NaOH solution (3.1 g of a 50% w/w solution). These contents were mixed at 180 revolutions per minute (“rpm”) and heated to 85° C.

At 85° C., ammonium persulfate (APS) (2.86 g) dissolved in DI water (12.0 g) was added to the flask contents and the mixture was heated at 85° C. for 3 minutes. The internal contents temperature of 85° C. was maintained throughout the polymerization reaction procedure by means of the heating/cooling system. After the 3 minute hold period, the free radical emulsion polymerization process was initiated by feeding into the flask contents a homogeneous mixture of monomers including styrene (Sty) (145.2 g), methyl methacrylate (MMA) (19.1 g), butyl acrylate (BA) (160.4 g), and methacrylic acid (MAA) (57.4 g) uniformly over a period of 75 minutes. When the monomer feed was completed, the monomer feed lines and pump were flushed into the flask with DI water (30 g) and the contents were heated at 85° C. for 90 minutes to complete the polymerization process. After the 90 minute heating period, the flask contents were cooled to 40° C. and ammonium hydroxide (NH₄OH) (1.5 g, 28% w/w water solution of ammonia) dissolved in DI water (15 g) was added to the flask contents over a period of 5 minutes. When the final emulsion polymer was completely cooled to room temperature, the emulsion polymer physical properties were evaluated.

The resulting emulsion polymer FP5 had the following measured physical properties:

Percent Non-Volatiles (% NV)=40.1%

pH=5.6

Brookfield Viscosity=29 centipoise (LVF 60 rpm/spindle #1 at 25° C.)

Particle Size=65 nm (Brookhaven BI-90 PS Analyzer)

Percent Coagulum=0.017% (325 mesh screen)

Acid Number=98.3 (colorimetric titration method)

Residual Monomer=Non-detectable by gas chromatography (5 ppm detectable limit)

TABLE 6
First Polymer Compositions FP1-FP23

| | FP Sty/Acrylic Polymer | | | | | | | | |
|---|---|---|---|---|---|---|---|---|---|
| | FP1 | FP2 | FP3 | FP4 | FP5 | FP6 | FP7 | FP8 | FP9 |
| | FP Sty/Acrylic Polymer Tg (° C.) | | | | | | | | |
| | 80° C. | 66° C. | 51° C. | 37° C. | 23° C. | 7° C. | −10° C. | −23° C. | −34° C. |
| DI-Water | 540.0 | 540.0 | 540.0 | 540.0 | 540.0 | 540.0 | 540.0 | 540.0 | 540.0 |
| Rhodafac | 13.3 | 13.3 | 13.3 | 13.3 | 13.3 | 13.3 | 13.3 | 13.3 | 13.3 |
| RS-410 | | | | | | | | | |
| (100%) | | | | | | | | | |
| Tergitol 15- | 3.0 | 3.0 | 3.0 | 3.0 | 3.0 | 3.0 | 3.0 | 3.0 | 3.0 |
| S-3 (100%) | | | | | | | | | |
| 50% NaOH | 3.1 | 3.1 | 3.1 | 3.1 | 3.1 | 3.1 | 3.1 | 3.1 | 3.1 |
| DI-Water | 12.0 | 12.0 | 12.0 | 12.0 | 12.0 | 12.0 | 12.0 | 12.0 | 12.0 |
| APS | 2.86 | 2.86 | 2.86 | 2.86 | 2.86 | 2.86 | 2.86 | 2.86 | 2.86 |
| Styrene | 145.2 | 145.2 | 145.2 | 145.2 | 145.2 | 126.1 | 80.2 | 38.2 | 0.0 |
| MMA | 129.9 | 103.1 | 76.4 | 49.7 | 19.1 | 0.0 | 0.0 | 0.0 | 0.0 |
| BA | 49.7 | 76.4 | 103.1 | 129.9 | 160.4 | 198.6 | 244.5 | 286.5 | 324.7 |
| MAA | 57.3 | 57.3 | 57.3 | 57.3 | 57.3 | 57.3 | 57.3 | 57.3 | 57.3 |
| DI-Water | 30.0 | 30.0 | 30.0 | 30.0 | 30.0 | 30.0 | 30.0 | 30.0 | 30.0 |
| DI-Water | 15.0 | 15.0 | 15.0 | 15.0 | 15.0 | 15.0 | 15.0 | 15.0 | 15.0 |
| 28% | 1.5 | 1.5 | 1.5 | 1.5 | 1.5 | 1.5 | 1.5 | 1.5 | 1.5 |
| NH₄OH | | | | | | | | | |
| % NV | 40.0% | 40.0% | 40.0% | 40.0% | 40.0% | 40.0% | 40.0% | 40.0% | 40.0% |

| | FP Acrylic Polymer | | | | | | | | | |
|---|---|---|---|---|---|---|---|---|---|---|
| | FP10 | FP11 | FP12 | FP13 | FP14 | FP15 | FP16 | FP17 | FP18 | FP19 |
| | FP Acrylic Polymer Tg (° C.) | | | | | | | | | |
| | 37° C. | 37° C. | 22° C. | 22° C. | 6° C. | 6° C. | −10° C. | −10° C. | −24° C. | −24° C. |
| DI-Water | 656.0 | 637.0 | 656.0 | 637.0 | 656.0 | 637.0 | 656.0 | 637.0 | 656.0 | 637.0 |
| Rhodafac | 13.0 | 13.0 | 13.0 | 13.0 | 13.0 | 13.0 | 13.0 | 13.0 | 13.0 | 13.0 |
| RS-410 | | | | | | | | | | |
| (100%) | | | | | | | | | | |
| Tergitol | 3.5 | 3.5 | 3.5 | 3.5 | 3.5 | 3.5 | 3.5 | 3.5 | 3.5 | 3.5 |
| 15-S-3 | | | | | | | | | | |
| (100%) | | | | | | | | | | |
| 50% | 3.0 | 3.0 | 3.0 | 3.0 | 3.0 | 3.0 | 3.0 | 3.0 | 3.0 | 3.0 |
| NaOH | | | | | | | | | | |
| DI-Water | 50.0 | 50.0 | 50.0 | 50.0 | 50.0 | 50.0 | 50.0 | 50.0 | 50.0 | 50.0 |
| APS | 2.5 | 2.5 | 2.5 | 2.5 | 2.5 | 2.5 | 2.5 | 2.5 | 2.5 | 2.5 |
| MMA | 245.0 | 245.0 | 213.5 | 213.5 | 178.5 | 178.5 | 140.0 | 140.0 | 101.5 | 101.5 |
| BA | 105.0 | 105.0 | 136.5 | 136.5 | 171.5 | 171.5 | 210.0 | 210.0 | 248.5 | 248.5 |
| TMPTA | 10.5 | 0.0 | 10.5 | 0.0 | 10.5 | 0.0 | 10.5 | 0.0 | 10.5 | 0.0 |
| % NV | 40.0% | 40.0% | 40.0% | 40.0% | 40.0% | 40.0% | 40.0% | 40.0% | 40.0% | 40.0% |

| | FP Acrylic Polymer | | | |
|---|---|---|---|---|
| | FP20 | FP21 | FP22 | FP23 |
| | FP Acrylic Polymer Tg (° C.) | | | |
| | −39° C. | −39° C. | −54° C. | −54° C. |
| DI-Water | 656.0 | 637.0 | 656.0 | 637.0 |
| Rhodafac RS-410 (100%) | 13.0 | 13.0 | 13.0 | 13.0 |
| Tergitol 15-S-3 (100%) | 3.5 | 3.5 | 3.5 | 3.5 |
| 50% NaOH | 3.0 | 3.0 | 3.0 | 3.0 |
| DI-Water | 50.0 | 50.0 | 50.0 | 50.0 |
| APS | 2.5 | 2.5 | 2.5 | 2.5 |
| MMA | 52.5 | 52.5 | 0.0 | 0.0 |
| BA | 297.5 | 297.5 | 350.0 | 350.0 |
| TMPTA | 10.5 | 0.0 | 10.5 | 0.0 |
| % NV | 40.0% | 40.0% | 40.0% | 40.0% |

### Example 2

### Preparation of a ASR Supported Styrene-Acrylic Emulsion Polymer for Use in an Aqueous First Coating Composition

First Polymer Composition Samples FP24 through FP32 were prepared using the procedure below. Only variable monomer type and amount differentiates samples. First Polymer compositions (“FP”) are shown in Table 7.

### First Polymer Composition Sample Number FP26

### Procedure:

A four-necked round bottom flask (2 L) was equipped with a heating/cooling system means to control and change temperature, a cold water condenser, a variable rate anchor paddle for agitation, and mechanical pumps as a means for metering in monomers. The flask was charged with deionized (“DI”) water (227.5 g), 371.0 g of a 28% w/w aqueous solution of an ammonium salt of Joncryl B-98 styrene-acrylic acid alkali soluble resin (“ASR”) from (BASF, Wyandotte, Mich.), and ammonium hydroxide (NH₄OH) (7.4 g, 28% w/w water solution of ammonia). These contents were mixed at 180 revolutions per minute (“rpm”) and heated to 85° C.

At 85° C., ammonium persulfate (2.5 g) dissolved in DI water (15.0 g) was added to the flask contents and the mixture was heated at 85° C. for 3 minutes. The internal contents temperature of 85° C. was maintained throughout the polymerization reaction procedure by means of the heating/cooling system. After the 3 minute hold period, the free radical emulsion polymerization process was initiated by feeding into the flask contents a homogeneous mixture of monomers including styrene (91.9 g), methyl methacrylate (MMA) (91.9 g), 2-ethylhexyl acrylate (2-EHA) (103.4 g), and trimethylolpropane triacrylate (TMPTA) (8.9 g) uniformly over a period of 75 minutes. When the monomer feed was completed, the monomer feed lines and pump were flushed into the flask with DI water (44.0 g) and tertiarybutyl hydroperoxide (TBHP) (1.0 g, 70% w/w water solution of TBHP) dissolved in DI water (12.0 g) was added to the contents and held at 85° C. for 15 minutes. After the 15 minute hold, sodium erythorbate (NaE) (1.5 g) dissolved in DI water (22.0 g) was added to the flask contents over a period of 5 minutes and the contents was held 30 additional minutes at 85° C. to complete the polymerization process. After the 30 minute heating period, the flask contents were cooled to cooled to room temperature and the emulsion polymer physical properties were evaluated.

The resulting emulsion polymer FP26 had the following measured physical properties:

Percent Non-Volatiles (% NV)=40.1%

pH=8.5

Brookfield Viscosity=19 centipoise (LVF 60 rpm/spindle #1 at 25° C.)

Particle Size=62 nm (Brookhaven BI-90 PS Analyzer)

Percent Coagulum=0.023% (325 mesh screen)

Residual Monomer=133 ppm 2-EHA by gas chromatography (5 ppm detectable limit)

TABLE 7
First Polymer Compositions FP24-FP32

| FP ASR/Sty/Acrylic Polymer | | | | | | | | |
|---|---|---|---|---|---|---|---|---|
| FP24 | FP25 | FP26 | FP27 | FP28 | FP29 | FP30 | FP31 | FP32 |

| | FP ASR/Sty/Acrylic Polymer Tg (° C.) | | | | | | | | |
|---|---|---|---|---|---|---|---|---|---|
| | 50° C. | 35° C. | 20° C. | 5° C. | −10° C. | −24° C. | −36° C. | −47° C. | −57° C. |
| DI-Water | 227.5 | 227.5 | 227.5 | 227.5 | 227.5 | 227.5 | 227.5 | 227.5 | 227.5 |
| B-98 ASR (28%) | 371.0 | 371.0 | 371.0 | 371.0 | 371.0 | 371.0 | 371.0 | 371.0 | 371.0 |
| 28% NH₄OH | 7.4 | 7.4 | 7.4 | 7.4 | 7.4 | 7.4 | 7.4 | 7.4 | 7.4 |
| DI-Water | 15.0 | 15.0 | 15.0 | 15.0 | 15.0 | 15.0 | 15.0 | 15.0 | 15.0 |
| APS | 2.5 | 2.5 | 2.5 | 2.5 | 2.5 | 2.5 | 2.5 | 2.5 | 2.5 |
| Styrene | 120.6 | 106.3 | 91.9 | 77.5 | 63.2 | 47.4 | 33.0 | 18.7 | 4.3 |
| MMA | 120.6 | 106.3 | 91.9 | 77.5 | 63.2 | 47.4 | 33.0 | 18.7 | 4.3 |
| 2-EHA | 46.0 | 74.7 | 103.4 | 132.1 | 160.8 | 192.4 | 221.1 | 249.9 | 278.6 |
| TMPTA | 8.9 | 8.9 | 8.9 | 8.9 | 8.9 | 8.9 | 8.9 | 8.9 | 8.9 |
| DI-Water Flush | 44.0 | 44.0 | 44.0 | 44.0 | 44.0 | 44.0 | 44.0 | 44.0 | 44.0 |
| DI-Water | 12.0 | 12.0 | 12.0 | 12.0 | 12.0 | 12.0 | 12.0 | 12.0 | 12.0 |
| 70% TBHP | 1.0 | 1.0 | 1.0 | 1.0 | 1.0 | 1.0 | 1.0 | 1.0 | 1.0 |
| DI-Water | 22.0 | 22.0 | 22.0 | 22.0 | 22.0 | 22.0 | 22.0 | 22.0 | 22.0 |
| NaE (100%) | 1.5 | 1.5 | 1.5 | 1.5 | 1.5 | 1.5 | 1.5 | 1.5 | 1.5 |
| % NV | 40.0% | 40.0% | 40.0% | 40.0% | 40.0% | 40.0% | 40.0% | 40.0% | 40.0% |

### Example 3

### Preparation of an Aqueous First Coating Composition Based on a Styrene-Acrylic, or Acrylic or ASR/-Styrene-Acrylic Emulsion Polymer Composition

First Coating Composition Samples FCC1 through FCC96 were prepared using the procedure below. Only variable polymer types and solvent types and levels as well as wax type and level differentiate samples. First Coating Compositions (“FCC”) are shown in Table 8.

### First Coating Composition Sample Number FCC16

An aqueous first coating composition (FCC16) based on a styrene-acrylic emulsion polymer (Example 1 First Polymer Composition “FP5”) with a glass transition temperature (“Tg”) of 23° C. (Flory-Fox) was prepared as described below.

### Procedure:

A beaker (1000 mL) equipped with a magnetic stir plate and a magnetic stir bar agitation means was charged with DI water (213.1 g) and agitated at about 150 rpm. To the flask contents was added Carbitol DE (15.5 g; diethylene glycol monoethyl ether, Dow Chemical, Midland, Mich.), Carbitol DB (2.5 g; diethylene glycol monobutyl ether, Dow Chemical, Midland, Mich.), KP-140 (8.1 g; tributoxyethyl phosphate, Chemtura, Middlebury, Conn.), ZONYL® FSJ (0.2 g; 40% active fluorochemical; E.I. du Pont de Nemours & Company, Inc., Wilmington, Del.) dissolved in DI water (4.8 g) and mixed for 5 minutes. After the 5 minute mixing, First Polymer Composition FP5 (207.5 g; prepared as described in Example 1) was added and mixed for 15 minutes. After the 15 minute mixing period, zinc ammonium carbonate (14.9 g as a 15% w/w solution of zinc oxide, Hydrite Chemical, Milwaukee, Wis.) was added uniformly over a period of 30 minutes and then the contents were mixed for an additional 60 minutes.

The resulting first coating composition FCC16 had the following measured physical properties:

Percent Non-Volatiles (% NV)=20.1%

pH=8.2,

Brookfield Viscosity=4.9 centipoise (LVF 60 rpm/spindle #1 at 25° C.)

Percent Coagulum=0.008% (325 mesh screen)

TABLE 8
First Coating Compositions FCC1-FCC96

| | FCC | | | | | | | | | | |
|---|---|---|---|---|---|---|---|---|---|---|---|
| | FCC | FCC | FCC | FCC | FCC | FCC | FCC | FCC | FCC | FCC | FCC |
| | 1 | 2 | 3 | 4 | 5 | 6 | 7 | 8 | 9 | 10 | 11 |
| FCC | 80° C. | 80° C. | 80° C. | 66° C. | 51° C. | 51° C. | 51° C. | 51° C. | 51° C. | 51° C. | 51° C. |
| Polymer | | | | | | | | | | | |
| Tg (° C.) | | | | | | | | | | | |
| Water | 262.4 | 258.7 | 257.2 | 239.4 | 226.9 | 223.2 | 221.7 | 239.5 | 262.5 | 258.7 | 257.3 |
| Carbitol DE | 36.4 | 36.4 | 36.4 | 33.0 | 29.5 | 29.5 | 29.5 | 29.5 | 29.5 | 29.5 | 29.5 |
| Carbitol DB | 2.5 | 2.5 | 2.5 | 2.5 | 2.5 | 2.5 | 2.5 | 2.5 | 2.5 | 2.5 | 2.5 |
| KP-140 | 24.7 | 24.7 | 24.7 | 19.4 | 14.1 | 14.1 | 14.1 | 14.1 | 14.1 | 14.1 | 14.1 |
| 1% FSJ | 5.0 | 5.0 | 5.0 | 5.0 | 5.0 | 5.0 | 5.0 | 5.0 | 5.0 | 5.0 | 5.0 |
| 15% ZAC | 0.0 | 14.9 | 20.8 | 20.8 | 0.0 | 14.9 | 20.8 | 20.8 | 0.0 | 14.9 | 20.8 |
| 35% AC316¹ | 0.0 | 0.0 | 0.0 | 0.0 | 0.0 | 0.0 | 0.0 | 23.7 | 47.4 | 47.4 | 47.4 |
| FP1 (40%) | 207.5 | 207.5 | 207.5 | 0.0 | 0.0 | 0.0 | 0.0 | 0.0 | 0.0 | 0.0 | 0.0 |
| FP2 (40%) | 0.0 | 0.0 | 0.0 | 207.5 | 0.0 | 0.0 | 0.0 | 0.0 | 0.0 | 0.0 | 0.0 |
| FP3 (40%) | 0.0 | 0.0 | 0.0 | 0.0 | 207.5 | 207.5 | 207.5 | 207.5 | 207.5 | 207.5 | 207.5 |
| % NV | 20.0% | 20.0% | 20.0% | 20.0% | 20.0% | 20.0% | 20.0% | 20.0% | 20.0% | 20.0% | 20.0% |

¹A-C ® 316, oxidized polyethylene with an Acid Number of about 16 (Honeywell Specialty Chemicals, Morristown, NJ; prepared as a 35%
w/w A-C ® 316 aqueous dispersion in water)

| | FCC | | | | | | | | | | | | |
|---|---|---|---|---|---|---|---|---|---|---|---|---|---|
| | FCC | FCC | FCC | FCC | FCC | FCC | FCC | FCC | FCC | FCC | FCC | FCC | FCC |
| | 12 | 13 | 14 | 15 | 16 | 17 | 18 | 19 | 20 | 21 | 22 | 23 | 24 |
| FCC | 37° C. | 37° C. | 37° C. | 23° C. | 23° C. | 23° C. | 23° C. | 23° C. | 23° C. | 23° C. | 7° C. | 7° C. | 7° C. |
| Polymer | | | | | | | | | | | | | |
| Tg (° C.) | | | | | | | | | | | | | |
| Water | 217.8 | 235.6 | 253.4 | 215.1 | 213.2 | 211.7 | 229.5 | 252.5 | 248.7 | 247.3 | 204.8 | 222.6 | 240.4 |
| Carbitol DE | 21.0 | 21.0 | 21.0 | 15.5 | 15.5 | 15.5 | 15.5 | 15.5 | 15.5 | 15.5 | 10.0 | 10.0 | 10.0 |
| Carbitol DB | 2.5 | 2.5 | 2.5 | 2.5 | 2.5 | 2.5 | 2.5 | 2.5 | 2.5 | 2.5 | 2.5 | 2.5 | 2.5 |
| KP-140 | 11.0 | 11.0 | 11.0 | 8.1 | 8.1 | 8.1 | 8.1 | 8.1 | 8.1 | 8.1 | 5.0 | 5.0 | 5.0 |
| 1% FSJ | 5.0 | 5.0 | 5.0 | 5.0 | 5.0 | 5.0 | 5.0 | 5.0 | 5.0 | 5.0 | 5.0 | 5.0 | 5.0 |
| 15% ZAC | 20.8 | 20.8 | 20.8 | 0.0 | 14.9 | 20.8 | 20.8 | 0.0 | 14.9 | 20.8 | 20.8 | 20.8 | 20.8 |
| 35% AC316 | 0.0 | 23.7 | 47.4 | 0.0 | 0.0 | 0.0 | 23.7 | 47.4 | 47.4 | 47.4 | 0.0 | 23.7 | 47.4 |
| FP4 (40%) | 207.5 | 207.5 | 207.5 | 0.0 | 0.0 | 0.0 | 0.0 | 0.0 | 0.0 | 0.0 | 0.0 | 0.0 | 0.0 |
| FP5 (40%) | 0.0 | 0.0 | 0.0 | 207.5 | 207.5 | 207.5 | 207.5 | 207.5 | 207.5 | 207.5 | 0.0 | 0.0 | 0.0 |
| FP6 (40%) | 0.0 | 0.0 | 0.0 | 0.0 | 0.0 | 0.0 | 0.0 | 0.0 | 0.0 | 0.0 | 207.5 | 207.5 | 207.5 |
| % NV | 20.0% | 20.0% | 20.0% | 20.0% | 20.0% | 20.0% | 20.0% | 20.0% | 20.0% | 20.0% | 20.0% | 20.0% | 20.0% |

| | FCC | | | | | | | | | | | |
|---|---|---|---|---|---|---|---|---|---|---|---|---|
| | FCC | FCC | FCC | FCC | FCC | FCC | FCC | FCC | FCC | FCC | FCC | FCC |
| | 25 | 26 | 27 | 28 | 29 | 30 | 31 | 32 | 33 | 34 | 35 | 36 |
| FCC | −10° C. | −10° C. | −10° C. | −10° C. | −10° C. | −10° C. | −10° C. | −10° C. | −10° C. | −10° C. | −10° C. | −10° C. |
| Polymer | | | | | | | | | | | | |
| Tg (° C.) | | | | | | | | | | | | |
| Water | 203.2 | 201.3 | 199.8 | 196.9 | 225.7 | 225.7 | 220.5 | 213.3 | 217.6 | 240.6 | 236.8 | 235.4 |
| Carbitol DE | 5.0 | 5.0 | 5.0 | 5.0 | 5.0 | 5.0 | 5.0 | 5.0 | 5.0 | 5.0 | 5.0 | 5.0 |
| Carbitol DB | 2.5 | 2.5 | 2.5 | 2.5 | 2.5 | 2.5 | 2.5 | 2.5 | 2.5 | 2.5 | 2.5 | 2.5 |
| KP-140 | 2.5 | 2.5 | 2.5 | 2.5 | 2.5 | 2.5 | 2.5 | 2.5 | 2.5 | 2.5 | 2.5 | 2.5 |
| 1% FSJ | 5.0 | 5.0 | 5.0 | 5.0 | 5.0 | 5.0 | 5.0 | 5.0 | 5.0 | 5.0 | 5.0 | 5.0 |
| 15% ZAC | 0.0 | 14.9 | 20.8 | 0.0 | 0.0 | 0.0 | 0.0 | 0.0 | 20.8 | 0.0 | 14.9 | 20.8 |
| 35% AC316 | 0.0 | 0.0 | 0.0 | 23.7 | 0.0 | 0.0 | 0.0 | 0.0 | 23.7 | 47.4 | 47.4 | 47.4 |
| 40% E43¹ | 0.0 | 0.0 | 0.0 | 0.0 | 20.7 | 0.0 | 0.0 | 0.0 | 0.0 | 0.0 | 0.0 | 0.0 |
| 40% | 0.0 | 0.0 | 0.0 | 0.0 | 0.0 | 20.7 | 0.0 | 0.0 | 0.0 | 0.0 | 0.0 | 0.0 |
| ME46940M1² | | | | | | | | | | | | |
| 32% ML743³ | 0.0 | 0.0 | 0.0 | 0.0 | 0.0 | 0.0 | 25.9 | 0.0 | 0.0 | 0.0 | 0.0 | 0.0 |
| 25% Aqua | 0.0 | 0.0 | 0.0 | 0.0 | 0.0 | 0.0 | 0.0 | 33.2 | 0.0 | 0.0 | 0.0 | 0.0 |
| Slip 952⁴ | | | | | | | | | | | | |
| FP7 (40%) | 207.5 | 207.5 | 207.5 | 207.5 | 207.5 | 207.5 | 207.5 | 207.5 | 207.5 | 207.5 | 207.5 | 207.5 |
| % NV | 20.0% | 20.0% | 20.0% | 20.0% | 20.0% | 20.0% | 20.0% | 20.0% | 20.0% | 20.0% | 20.0% | 20.0% |

¹Epolene E43, maleated polypropylene with an Acid Number @ 47, from (Eastman Chemical, Kingsport, TN; prepared as a 40% w/w E43
aqueous dispersion in water)
²ME46940M1, 40% NV dispersion of a 0 Acid Number Polyethylene (Michelman, Cincinnati, OH)
³ML743, 32% NV dispersion of a 0 Acid Number Paraffin (Michelman, Cincinnati, OH)
⁴Aqua Slip 952, 25% NV dispersion of Carnauba wax with an Acid Number of about10 (Lubrizol, Cleveland, OH)

| | FCC | | | | | | | | | | | | |
|---|---|---|---|---|---|---|---|---|---|---|---|---|---|
| | FCC | FCC | FCC | FCC | FCC | FCC | FCC | FCC | FCC | FCC | FCC | FCC | FCC |
| | 37 | 38 | 39 | 40 | 41 | 42 | 43 | 44 | 45 | 46 | 47 | 48 | 49 |
| FCC | −23° C. | −34° C. | −34° C. | −34° C. | 37° C. | 37° C. | 37° C. | 22° C. | 22° C. | 22° C. | 6° C. | 6° C. | 6° C. |
| Polymer | | | | | | | | | | | | | |
| Tg (° C.) | | | | | | | | | | | | | |
| Water | 202.3 | 205.9 | 205.0 | 203.6 | 220.3 | 220.3 | 238.1 | 212.4 | 212.4 | 232.0 | 207.3 | 207.3 | 225.1 |
| Carbitol DE | 2.5 | 1.25 | 1.25 | 1.25 | 21.0 | 21.0 | 21.0 | 15.5 | 15.5 | 15.5 | 10.0 | 10.0 | 10.0 |
| Carbitol DB | 2.5 | 2.5 | 2.5 | 2.5 | 2.5 | 2.5 | 2.5 | 2.5 | 2.5 | 2.5 | 2.5 | 2.5 | 2.5 |
| KP-140 | 2.5 | 2.5 | 2.5 | 2.5 | 11.0 | 11.0 | 11.0 | 8.1 | 8.1 | 8.1 | 5.0 | 5.0 | 5.0 |
| 1% FSJ | 5.0 | 5.0 | 5.0 | 5.0 | 5.0 | 5.0 | 5.0 | 5.0 | 5.0 | 5.0 | 5.0 | 5.0 | 5.0 |
| 28% NH₄OH | 0.0 | 2.75 | 0.0 | 0.0 | 2.75 | 2.75 | 2.75 | 2.75 | 2.75 | 2.75 | 2.75 | 2.75 | 2.75 |
| 15% ZAC | 20.8 | 0.0 | 14.9 | 20.8 | 0.0 | 0.0 | 0.0 | 0.0 | 0.0 | 0.0 | 0.0 | 0.0 | 0.0 |
| 35% AC316 | 0.0 | 0.0 | 0.0 | 0.0 | 0.0 | 0.0 | 23.7 | 0.0 | 0.0 | 23.7 | 0.0 | 0.0 | 23.7 |
| FP8 (40%) | 207.5 | 0.0 | 0.0 | 0.0 | 0.0 | 0.0 | 0.0 | 0.0 | 0.0 | 0.0 | 0.0 | 0.0 | 0.0 |
| FP9 (40%) | 0.0 | 207.5 | 207.5 | 207.5 | 0.0 | 0.0 | 0.0 | 0.0 | 0.0 | 0.0 | 0.0 | 0.0 | 0.0 |
| FP10 (40%) | 0.0 | 0.0 | 0.0 | 0.0 | 0.0 | 207.5 | 207.5 | 0.0 | 0.0 | 0.0 | 0.0 | 0.0 | 0.0 |
| FP11 (40%) | 0.0 | 0.0 | 0.0 | 0.0 | 207.5 | 0.0 | 0.0 | 0.0 | 0.0 | 0.0 | 0.0 | 0.0 | 0.0 |
| FP12 (40%) | 0.0 | 0.0 | 0.0 | 0.0 | 0.0 | 0.0 | 0.0 | 0.0 | 207.5 | 207.5 | 0.0 | 0.0 | 0.0 |
| FP13 (40%) | 0.0 | 0.0 | 0.0 | 0.0 | 0.0 | 0.0 | 0.0 | 207.5 | 0.0 | 0.0 | 0.0 | 0.0 | 0.0 |
| FP14 (40%) | 0.0 | 0.0 | 0.0 | 0.0 | 0.0 | 0.0 | 0.0 | 0.0 | 0.0 | 0.0 | 0.0 | 207.5 | 207.5 |
| FP15 (40%) | 0.0 | 0.0 | 0.0 | 0.0 | 0.0 | 0.0 | 0.0 | 0.0 | 0.0 | 0.0 | 207.5 | 0.0 | 0.0 |
| % NV | 20.0% | 20.0% | 20.0% | 20.0% | 20.0% | 20.0% | 20.0% | 20.0% | 20.0% | 20.0% | 20.0% | 20.0% | 20.0% |

| | FCC | | | | | | | | | |
|---|---|---|---|---|---|---|---|---|---|---|
| | FCC | FCC | FCC | FCC | FCC | FCC | FCC | FCC | FCC | FCC |
| | 50 | 51 | 52 | 53 | 54 | 55 | 56 | 57 | 58 | 59 |
| FCC | −10° C. | −10° C. | −10° C. | −10° C. | −10° C. | −10° C. | −10° C. | −10° C. | −10° C. | −10° C. |
| Polymer | | | | | | | | | | |
| Tg (° C.) | | | | | | | | | | |
| Water | 203.2 | 203.2 | 194.2 | 194.2 | 223.0 | 217.8 | 223.0 | 223.0 | 217.8 | 210.6 |
| Carbitol DE | 5.0 | 5.0 | 5.0 | 5.0 | 5.0 | 5.0 | 5.0 | 5.0 | 5.0 | 5.0 |
| Carbitol DB | 2.5 | 2.5 | 2.5 | 2.5 | 2.5 | 2.5 | 2.5 | 2.5 | 2.5 | 2.5 |
| KP-140 | 2.5 | 2.5 | 2.5 | 2.5 | 2.5 | 2.5 | 2.5 | 2.5 | 2.5 | 2.5 |
| 1% FSJ | 5.0 | 5.0 | 5.0 | 5.0 | 5.0 | 5.0 | 5.0 | 5.0 | 5.0 | 5.0 |
| 28% NH₄OH | 2.75 | 2.75 | 2.75 | 2.75 | 2.75 | 2.75 | 2.75 | 2.75 | 2.75 | 2.75 |
| 35% AC316 | 0.0 | 0.0 | 23.7 | 23.7 | 0.0 | 0.0 | 0.0 | 0.0 | 23.7 | 47.4 |
| 40% E43 | 0.0 | 0.0 | 0.0 | 0.0 | 0.0 | 0.0 | 20.7 | 0.0 | 0.0 | 0.0 |
| 40% | 0.0 | 0.0 | 0.0 | 0.0 | 20.7 | 0.0 | 0.0 | 20.7 | 0.0 | 0.0 |
| ME46940M1 | | | | | | | | | | |
| 32% ML743 | 0.0 | 0.0 | 0.0 | 0.0 | 0.0 | 25.9 | 0.0 | 0.0 | 25.9 | 0.0 |
| 25% Aqua | 0.0 | 0.0 | 0.0 | 0.0 | 0.0 | 0.0 | 0.0 | 0.0 | 0.0 | 33.2 |
| Slip 952 | | | | | | | | | | |
| FP16 (40%) | 0.0 | 207.5 | 207.5 | 0.0 | 207.5 | 207.5 | 0.0 | 0.0 | 0.0 | 0.0 |
| FP17 (40%) | 207.5 | 0.0 | 0.0 | 207.5 | 0.0 | 0.0 | 207.5 | 207.5 | 207.5 | 207.5 |
| % NV | 20.0% | 20.0% | 20.0% | 20.0% | 20.0% | 20.0% | 20.0% | 20.0% | 20.0% | 20.0% |

| | FCC | | | | | | | | |
|---|---|---|---|---|---|---|---|---|---|
| | FCC | FCC | FCC | FCC | FCC | FCC | FCC | FCC | FCC |
| | 60 | 61 | 62 | 63 | 64 | 65 | 66 | 67 | 68 |
| FCC | −24° C. | −24° C. | −24° C. | −39° C. | −39° C. | −39° C. | −54° C. | −54° C. | −54° C. |
| Polymer | | | | | | | | | |
| Tg (° C.) | | | | | | | | | |
| Water | 204.8 | 204.8 | 222.6 | 206.1 | 206.1 | 223.8 | 206.7 | 206.7 | 224.5 |
| Carbitol DE | 2.5 | 2.5 | 2.5 | 1.25 | 1.25 | 1.25 | 0.625 | 0.625 | 0.625 |
| Carbitol DB | 2.5 | 2.5 | 2.5 | 2.5 | 2.5 | 2.5 | 2.5 | 2.5 | 2.5 |
| KP-140 | 2.5 | 2.5 | 2.5 | 2.5 | 2.5 | 2.5 | 2.5 | 2.5 | 2.5 |
| 1% FSJ | 5.0 | 5.0 | 5.0 | 5.0 | 5.0 | 5.0 | 5.0 | 5.0 | 5.0 |
| 28% NH₄OH | 2.75 | 2.75 | 2.75 | 2.75 | 2.75 | 2.75 | 2.75 | 2.75 | 2.75 |
| 35% AC316 | 0.0 | 0.0 | 23.7 | 0.0 | 0.0 | 23.7 | 0.0 | 0.0 | 23.7 |
| FP18 (40%) | 0.0 | 207.5 | 207.5 | 0.0 | 0.0 | 0.0 | 0.0 | 0.0 | 0.0 |
| FP19 (40%) | 207.5 | 0.0 | 0.0 | 0.0 | 0.0 | 0.0 | 0.0 | 0.0 | 0.0 |
| FP20 (40%) | 0.0 | 0.0 | 0.0 | 0.0 | 207.5 | 207.5 | 0.0 | 0.0 | 0.0 |
| FP21 (40%) | 0.0 | 0.0 | 0.0 | 207.5 | 0.0 | 0.0 | 0.0 | 0.0 | 0.0 |
| FP22 (40%) | 0.0 | 0.0 | 0.0 | 0.0 | 0.0 | 0.0 | 0.0 | 207.5 | 207.5 |
| FP23 (40%) | 0.0 | 0.0 | 0.0 | 0.0 | 0.0 | 0.0 | 207.5 | 0.0 | 0.0 |
| % NV | 20.0% | 20.0% | 20.0% | 20.0% | 20.0% | 20.0% | 20.0% | 20.0% | 20.0% |

| | FCC | | | | | | |
|---|---|---|---|---|---|---|---|
| | FCC | FCC | FCC | FCC | FCC | FCC | FCC |
| | 69 | 70 | 71 | 72 | 73 | 74 | 75 |
| FCC | 50° C. | 35° C. | 20° C. | 5° C. | -10° C. | -10° C. | -10° C. |
| Polymer | | | | | | | |
| Tg (° C.) | | | | | | | |
| Water | 226.9 | 223.0 | 215.1 | 210.0 | 203.2 | 222.8 | 225.7 |
| Carbitol DE | 29.5 | 21.0 | 15.5 | 10.0 | 5.0 | 5.0 | 5.0 |
| Carbitol DB | 2.5 | 2.5 | 2.5 | 2.5 | 2.5 | 2.5 | 2.5 |
| KP-140 | 14.1 | 11.0 | 8.1 | 5.0 | 2.5 | 2.5 | 2.5 |
| 1% FSJ | 5.0 | 5.0 | 5.0 | 5.0 | 5.0 | 5.0 | 5.0 |
| 35% AC316 | 0.0 | 0.0 | 0.0 | 0.0 | 0.0 | 23.7 | 0.0 |
| 40% | 0.0 | 0.0 | 0.0 | 0.0 | 0.0 | 0.0 | 20.7 |
| ME46940M1 | | | | | | | |
| 32% ML743 | 0.0 | 0.0 | 0.0 | 0.0 | 0.0 | 0.0 | 0.0 |
| FP24 (40%) | 207.5 | 0.0 | 0.0 | 0.0 | 0.0 | 0.0 | 0.0 |
| FP25 (40%) | 0.0 | 207.5 | 0.0 | 0.0 | 0.0 | 0.0 | 0.0 |
| FP26 (40%) | 0.0 | 0.0 | 207.5 | 0.0 | 0.0 | 0.0 | 0.0 |
| FP27 (40%) | 0.0 | 0.0 | 0.0 | 207.5 | 0.0 | 0.0 | 0.0 |
| FP28 (40%) | 0.0 | 0.0 | 0.0 | 0.0 | 207.5 | 207.5 | 207.5 |
| FP29 (40%) | 0.0 | 0.0 | 0.0 | 0.0 | 0.0 | 0.0 | 0.0 |
| FP30 (40%) | 0.0 | 0.0 | 0.0 | 0.0 | 0.0 | 0.0 | 0.0 |
| FP31 (40%) | 0.0 | 0.0 | 0.0 | 0.0 | 0.0 | 0.0 | 0.0 |
| FP32 (40%) | 0.0 | 0.0 | 0.0 | 0.0 | 0.0 | 0.0 | 0.0 |
| % NV | 20.0% | 20.0% | 20.0% | 20.0% | 20.0% | 20.0% | 20.0% |
| | FCC | | | | | | |
| | FCC | FCC | FCC | FCC | FCC | FCC | FCC |
| | 76 | 77 | 78 | 79 | 80 | 81 | 82 |
| FCC | −10° C. | −24° C. | −24° C. | −24° C. | −36° C. | −47° C. | −57° C. |
| Polymer | | | | | | | |
| Tg (° C.) | | | | | | | |
| Water | 220.5 | 207.5 | 225.3 | 243.1 | 208.7 | 209.4 | 210.0 |
| Carbitol DE | 5.0 | 2.5 | 2.5 | 2.5 | 1.25 | 0.625 | 0.0 |
| Carbitol DB | 2.5 | 2.5 | 2.5 | 2.5 | 2.5 | 2.5 | 2.5 |
| KP-140 | 2.5 | 2.5 | 2.5 | 2.5 | 2.5 | 2.5 | 2.5 |
| 1% FSJ | 5.0 | 5.0 | 5.0 | 5.0 | 5.0 | 5.0 | 5.0 |
| 35% AC316 | 0.0 | 0.0 | 23.7 | 47.4 | 0.0 | 0.0 | 0.0 |
| 40% | 0.0 | 0.0 | 0.0 | 0.0 | 0.0 | 0.0 | 0.0 |
| ME46940M1 | | | | | | | |
| 32% ML743 | 25.9 | 0.0 | 0.0 | 0.0 | 0.0 | 0.0 | 0.0 |
| FP24 (40%) | 0.0 | 0.0 | 0.0 | 0.0 | 0.0 | 0.0 | 0.0 |
| FP25 (40%) | 0.0 | 0.0 | 0.0 | 0.0 | 0.0 | 0.0 | 0.0 |
| FP26 (40%) | 0.0 | 0.0 | 0.0 | 0.0 | 0.0 | 0.0 | 0.0 |
| FP27 (40%) | 0.0 | 0.0 | 0.0 | 0.0 | 0.0 | 0.0 | 0.0 |
| FP28 (40%) | 207.5 | 0.0 | 0.0 | 0.0 | 0.0 | 0.0 | 207.5 |
| FP29 (40%) | 0.0 | 207.5 | 207.5 | 207.5 | 0.0 | 0.0 | 0.0 |
| FP30 (40%) | 0.0 | 0.0 | 0.0 | 0.0 | 207.5 | 0.0 | 0.0 |
| FP31 (40%) | 0.0 | 0.0 | 0.0 | 0.0 | 0.0 | 207.5 | 0.0 |
| FP32 (40%) | 0.0 | 0.0 | 0.0 | 0.0 | 0.0 | 0.0 | 207.5 |
| % NV | 20.0% | 20.0% | 20.0% | 20.0% | 20.0% | 20.0% | 20.0% |

| | FCC | | | | | | |
|---|---|---|---|---|---|---|---|
| | FCC | FCC | FCC | FCC | FCC | FCC | FCC |
| | 83 | 84 | 85 | 86 | 87 | 88 | 89 |
| FCC | 54° C. | 54° C. | 24° C. | 24° C. | -5° C. | -5° C. | -5° C. |
| Polymer | | | | | | | |
| Tg (° C.) | | | | | | | |
| Water | 226.9 | 244.7 | 215.1 | 234.7 | 207.5 | 225.3 | 228.3 |
| Carbitol DE | 29.5 | 29.5 | 15.5 | 15.5 | 7.5 | 7.5 | 7.5 |
| Carbitol DB | 2.5 | 2.5 | 2.5 | 2.5 | 2.5 | 2.5 | 2.5 |
| KP-140 | 14.1 | 14.1 | 8.1 | 8.1 | 3.75 | 3.75 | 3.75 |
| 1% FSJ | 5.0 | 5.0 | 5.0 | 5.0 | 5.0 | 5.0 | 5.0 |
| 35% AC316 | 0.0 | 23.7 | 0.0 | 23.7 | 0.0 | 23.7 | 0.0 |
| 40% | 0.0 | 0.0 | 0.0 | 0.0 | 0.0 | 0.0 | 20.7 |
| ME46940M1 | | | | | | | |
| 32% ML743 | 0.0 | 0.0 | 0.0 | 0.0 | 0.0 | 0.0 | 0.0 |
| Genflo 8045¹ | 207.5 | 207.5 | 0.0 | 0.0 | 0.0 | 0.0 | 0.0 |
| (51%) | | | | | | | |
| Genflo 3112² | 0.0 | 0.0 | 207.5 | 207.5 | 0.0 | 0.0 | 0.0 |
| (46.3%) | | | | | | | |
| Genflo 3003³ | 0.0 | 0.0 | 0.0 | 0.0 | 207.5 | 207.5 | 207.5 |
| (50%) | | | | | | | |
| Genflo 3075⁴ | 0.0 | 0.0 | 0.0 | 0.0 | 0.0 | 0.0 | 0.0 |
| (50%) | | | | | | | |
| Genflo 3088⁵ | 0.0 | 0.0 | 0.0 | 0.0 | 0.0 | 0.0 | 0.0 |
| (48.3%) | | | | | | | |
| Genflo 8028⁶ | 0.0 | 0.0 | 0.0 | 0.0 | 0.0 | 0.0 | 0.0 |
| (50%) | | | | | | | |
| % NV | 20.0% | 20.0% | 20.0% | 20.0% | 20.0% | 20.0% | 20.0% |

| | FCC | | | | | | |
|---|---|---|---|---|---|---|---|
| | FCC | FCC | FCC | FCC | FCC | FCC | FCC |
| | 90 | 91 | 92 | 93 | 94 | 95 | 96 |
| FCC | −5° C. | −30° C. | −30° C. | −50° C. | −50° C. | −80° C. | −80° C. |
| Polymer | | | | | | | |
| Tg (° C.) | | | | | | | |
| Water | 223.1 | 208.1 | 225.9 | 209.4 | 227.2 | 210.0 | 227.8 |
| Carbitol DE | 7.5 | 1.88 | 1.88 | 0.625 | 0.625 | 0.0 | 0.0 |
| Carbitol DB | 2.5 | 2.5 | 2.5 | 2.5 | 2.5 | 2.5 | 2.5 |
| KP-140 | 3.75 | 2.5 | 2.5 | 2.5 | 2.5 | 2.5 | 2.5 |
| 1% FSJ | 5.0 | 5.0 | 5.0 | 5.0 | 5.0 | 5.0 | 5.0 |
| 35% AC316 | 0.0 | 0.0 | 23.7 | 0.0 | 23.7 | 0.0 | 23.7 |
| 40% | 0.0 | 0.0 | 0.0 | 0.0 | 0.0 | 0.0 | 0.0 |
| ME46940M1 | | | | | | | |
| 32% ML743 | 25.9 | 0.0 | 0.0 | 0.0 | 0.0 | 0.0 | 0.0 |
| Genflo 8045¹ | 0.0 | 0.0 | 0.0 | 0.0 | 0.0 | 0.0 | 0.0 |
| (51%) | | | | | | | |
| Genflo 3112² | 0.0 | 0.0 | 0.0 | 0.0 | 0.0 | 0.0 | 0.0 |
| (46.3%) | | | | | | | |
| Genflo 3003³ | 207.5 | 0.0 | 0.0 | 0.0 | 0.0 | 0.0 | 0.0 |
| (50%) | | | | | | | |
| Genflo 3075⁴ | 0.0 | 207.5 | 207.5 | 0.0 | 0.0 | 0.0 | 0.0 |
| (50%) | | | | | | | |
| Genflo 3088⁵ | 0.0 | 0.0 | 0.0 | 207.5 | 207.5 | 0.0 | 0.0 |
| (48.3%) | | | | | | | |
| Genflo 8028⁶ | 0.0 | 0.0 | 0.0 | 0.0 | 0.0 | 207.5 | 207.5 |
| (50%) | | | | | | | |
| % NV | 20.0% | 20.0% | 20.0% | 20.0% | 20.0% | 20.0% | 20.0% |

¹Genflo 8045 Styrene-Butadiene emulsion polymer, Tg of about 54° C., (51% NV) (OMNOVA Solution Inc., Mogadore, OH)
²Genflo 3112 Styrene-Butadiene emulsion polymer, Tg of about 24° C., (46.3% NV) (OMNOVA Solution Inc., Mogadore, OH)
³Genflo 3003 Styrene-Butadiene emulsion polymer, Tg of about −5° C., (50% NV) (OMNOVA Solution Inc., Mogadore, OH)
⁴Genflo 3075 Styrene-Butadiene emulsion polymer, Tg of about −30° C., (50% NV) (OMNOVA Solution Inc., Mogadore, OH)
⁵Genflo 3088 Styrene-Butadiene emulsion polymer, Tg of about −50° C., (48.3% NV) (OMNOVA Solution Inc., Mogadore, OH)
⁶Genflo 8028 Styrene-Butadiene emulsion polymer, Tg of about −80° C., (50% NV) (OMNOVA Solution Inc., Mogadore, OH)

### Example 4

### Preparation of a Polyurethane/Acrylic Hybrid Emulsion Polymer for Use in an Aqueous Second Coating Composition

Second Polymer Composition Samples SP1 through SP21 were prepared using the procedure described below. Only variable PU emulsion type and amount and monomer type and amount differentiates samples. Second Polymer compositions (“SP”) are shown in Table 9.

### Second Polymer Composition Sample Number SP2.

### Procedure:

A four-necked round bottom flask (1 L) was equipped with a heating/cooling system means to control and change temperature, a cold water condenser, a variable rate anchor paddle for agitation, and mechanical pumps as a means for metering in monomers. The flask was charged with UROTUF® L522-MPW-40 polyurethane dispersion (167.5 g, 40% NV; Reichhold, Durham, N.C.) and DI water (71.0 g) and the contents were mixed at 200 rpm and heated to 80° C. At 30° C., methyl methacrylate (MMA) monomer (33.0 g) was added to the contents of the flask and the contents were heated to 80° C. and held for a period of 45 minutes. After the 45 minute hold period, the free-radical polymerization process was initiated by the addition of ammonium persulfate (APS) (0.25 g) dissolved in DI water (14.0 g) to the flask contents and the mixture was held at 80° C. for 90 minutes to complete the polymerization process. An internal contents temperature of 80° C. was maintained throughout the polymerization reaction procedure by means of the heating/cooling system. After the 90 minute hold period the polyurethane/acrylic hybrid emulsion polymer was cooled to room temperature and filtered through a 100 mesh screen.

The resulting polyurethane/acrylic hybrid emulsion polymer SP2 had the following measured physical properties:

Percent Non-Volatiles (% NV)=35.1%

pH=7.6

Brookfield Viscosity=13 centipoise (LVF 60 rpm/spindle #1 at 25° C.)

Percent Coagulum=0.021% (325 mesh screen)

Residual Monomer=113 ppm methyl methacrylate by gas chromatography (5 ppm detectable limit)

TABLE 9
Second Polymer Compositions SP1-SP21 PU/Acrylic or PU/Sty/Acrylic or PU/Sty Hybrid Polymers

| PU/Acrylic | | | | | | | | | | | |
|---|---|---|---|---|---|---|---|---|---|---|---|
| Hybrid in SP | | | | | | | | | | | |
| Example Type | SP1 | SP2 | SP3 | SP4 | SP5 | SP6 | SP7 | SP8 | SP9 | SP10 | SP11 |
| Urotuf L522 | 187.5 | 167.5 | 187.5 | 125.0 | 167.5 | 177.5 | 167.5 | 167.5 | 167.5 | 167.5 | |
| (40%) | | | | | | | | | | | |
| Urotuf L63¹ | | | | | | | | | | | 176.3 |
| (38%) | | | | | | | | | | | |
| DI-Water | 59.0 | 71.0 | 59.0 | 96.5 | 71.0 | 65.0 | 71.0 | 71.0 | 71.0 | 71.0 | 62.2 |
| MMA | 25.0 | 33.0 | | 50.0 | | 14.5 | | 8.25 | 16.5 | 24.75 | 33.0 |
| TBMA | | | 25.0 | | 33.0 | 14.5 | | | | | |
| Styrene | | | | | | | 33.0 | 24.75 | 16.5 | 8.25 | |
| DI-Water | 14.0 | 14.0 | 14.0 | 14.0 | 14.0 | 14.0 | 14.0 | 14.0 | 14.0 | 14.0 | 14.0 |
| APS | 0.25 | 0.25 | 0.25 | 0.25 | 0.25 | 0.25 | 0.25 | 0.25 | 0.25 | 0.25 | 0.25 |
| % NV | 35.0% | 35.0% | 35.0% | 35.0% | 35.0% | 35.0% | 35.0% | 35.0% | 35.0% | 35.0% | 35.0% |

¹Urotuf L63, 38% NV Polyurethane Dispersion (Reichhold, Durham, NC)

| PU/Acrylic | | | | | | | | | | |
|---|---|---|---|---|---|---|---|---|---|---|
| Hybrid in SP | | | | | | | | | | |
| Example Type | SP12 | SP13 | SP14 | SP15 | SP16 | SP17 | SP18 | SP19 | SP20 | SP21 |
| Urotuf L63 | 176.3 | | | | | | | | | |
| (38%) | | | | | | | | | | |
| NeoRez | | 191.4 | | | | | | | | |
| R2180¹ (35%) | | | | | | | | | | |
| Bahydrol | | | 191.4 | | | | | | | |
| UH2606² (35%) | | | | | | | | | | |
| Bahydrol | | | | 181.1 | | | | | | |
| UH2558³ (37%) | | | | | | | | | | |
| Bahydrol | | | | | 191.4 | | | | | |
| 2593/1⁴ (35%) | | | | | | | | | | |
| Bahydrol | | | | | | 167.5 | | | | |
| UHXP2719⁵ (40%) | | | | | | | | | | |
| Bahydrol | | | | | | | 167.5 | | | |
| UH2557⁶ (35%) | | | | | | | | | | |
| Urotuf L57⁷ | | | | | | | | 187.5 | 167.5 | 167.5 |
| (35%) | | | | | | | | | | |
| DI-Water | 62.2 | 47.1 | 97.0 | 57.4 | 97.0 | 71.0 | 71.0 | 59.0 | 71.0 | 71.0 |
| MMA | | 33.0 | 33.0 | 33.0 | 33.0 | 33.0 | 33.0 | 25.0 | 33.0 | |
| TBMA | 33.0 | | | | | | | | | |
| IBMA | | | | | | | | | | 33.0 |
| DI-Water | 14.0 | 14.0 | 14.0 | 14.0 | 14.0 | 14.0 | 14.0 | 14.0 | 14.0 | 14.0 |
| APS | 0.25 | 0.25 | 0.25 | 0.25 | 0.25 | 0.25 | 0.25 | 0.25 | 0.25 | 0.25 |
| % NV | 35.0% | 35.0% | 30.0% | 35.0% | 30.0% | 35.0% | 35.0% | 35.0% | 35.0% | 35.0% |

¹NeoRez R2180, 35% NV Polyurethane Dispersion (DSM NeoResins Inc., Wilmington, MA)
²Bahydrol UH2606, 35% NV Polyurethane Dispersion (Bayer Material Science AG, Leverkuser, Germany)
³Bahydrol UH2558, 37% NV Polyurethane Dispersion (Bayer Material Science AG, Leverkuser, Germany)
⁴Bahydrol 2593/1, 35% NV Polyurethane Dispersion (Bayer Material Science AG, Leverkuser, Germany)
⁵Bahydrol UHXP2719, 40% NV Polyurethane Dispersion (Bayer Material Science AG, Leverkuser, Germany)
⁶Bahydrol UH2557, 35% NV Polyurethane Dispersion (Bayer Material Science AG, Leverkuser, Germany)
⁷Urotuf L57, 35% NV Polyurethane Dispersion (Reichhold, Durham, NC)

Samples SP22-SP24 were prepared as described in Example 1. Formulations for samples SP22-SP24 are shown in Table 10.

TABLE 10
Styrene-Acrylic or Acrylic Emulsion Polymers for Preparing
Physical Blends with Polyurethane Emulsions

| | SP Blend Polymer | | |
|---|---|---|---|
| | SP22 | SP23 | SP24 |
| | SP Blend Polymer | | |
| | Tg (° C.) | | |
| | 51° C. | 23° C. | 105° C. |
| DI-Water | 540.0 | 540.0 | 540.0 |
| Rhodafac RS-410 (100%) | 13.3 | 13.3 | 13.3 |
| Tergitol 15-S-3 (100%) | 3.0 | 3.0 | 3.0 |
| 50% NaOH | 3.1 | 3.1 | 3.1 |
| DI-Water | 12.0 | 12.0 | 12.0 |
| APS | 2.86 | 2.86 | 2.86 |
| Styrene | 145.2 | 145.2 | 0.0 |
| MMA | 76.4 | 19.1 | 382.0 |
| BA | 103.1 | 160.4 | 0.0 |
| MAA | 57.3 | 57.3 | 0.0 |
| DI-Water | 30.0 | 30.0 | 30.0 |
| DI-Water | 15.0 | 15.0 | 15.0 |
| 28% NH₄OH | 1.5 | 1.5 | 1.5 |
| % NV | 40.0% | 40.0% | 40.0% |

### Example 5

### Preparation of an Aqueous Second Coating Composition Based on Polyurethane/Acrylic Hybrid Emulsion Polymer

Second Coating Composition Samples SCC1 through SCC36 were prepared using Example 5 procedure. Only variable Second Polymer type and amount and solvent type and amount differentiates samples. Second Coating Compositions (“SCC”) are shown in Table 11.

### Second Coating Composition Sample Number SCC2

An aqueous second coating composition based on a polyurethane/acrylic hybrid emulsion polymer (Example 4 Second Polymer Composition SP2) was prepared as described below.

### Procedure:

A beaker (1000 mL) equipped with a magnetic stir plate and a magnetic stir bar agitation means was charged DI water (33.5 g) and agitated at about 150 rpm. To the flask contents were added Carbitol DE (3.0 g diethylene glycol monoethyl ether), KP-140 (2.4 g tributoxyethyl phosphate), ZONYL® FSJ (0.04 g 40% active fluorochemical; E.I. du Pont de Nemours & Company, Inc., Wilmington, Del.) dissolved in DI water (0.96 g) and mixed for five minutes. After the five minute hold period, A-C® 316 wax (7.2 g oxidized high density polyethylene with an acid number of about 16 as a 35% w/w water dispersion of A-C® 316 wax; Honeywell International Inc., Morristown, N.J.) aqueous dispersion was added and mixed for five minutes. After the five minute hold period, Peelable Polymer Composition SP2 (68.6 g) prepared as described in Example 4 was added and mixed for sixty additional minutes.

The resulting second coating composition SCC2 had physical properties that were:

Percent Non-Volatiles (% NV)=25.0%

pH=7.6

Brookfield Viscosity=6.4 centipoise (LVF 60 rpm/spindle #1 at 25° C.)

Percent Coagulum=0.012% (325 mesh screen).

TABLE 11
Second Coating Compositions SCC1-SCC36

| | SCC Sample Type | | | | | | | | | | |
|---|---|---|---|---|---|---|---|---|---|---|---|
| | SCC1 | SCC2 | SCC3 | SCC4 | SCC5 | SCC6 | SCC7 | SCC8 | SCC9 | SCC10 | SCC11 |
| SP1 (35%) | 68.6 | | | | | | | | | | |
| SP2 (35%) | | 68.6 | | | | | | | | | |
| SP3 (35%) | | | 68.6 | | | | | | | | |
| SP4 (35%) | | | | 68.6 | | | | | | | |
| SP5 (35%) | | | | | 68.6 | | | | | | |
| SP6 (35%) | | | | | | 68.6 | | | | | |
| SP7 (35%) | | | | | | | 68.6 | | | | |
| SP8 (35%) | | | | | | | | 68.6 | | | |
| SP9 (35%) | | | | | | | | | 68.6 | | |
| SP10 (35%) | | | | | | | | | | 68.6 | |
| SP11 (35%) | | | | | | | | | | | 68.6 |
| Water | 33.5 | 33.5 | 33.5 | 33.5 | 33.5 | 33.5 | 33.5 | 33.5 | 33.5 | 33.5 | 33.5 |
| Carbitol DE | 3.0 | 3.0 | 3.0 | 3.0 | 3.0 | 3.0 | 3.0 | 3.0 | 3.0 | 3.0 | 3.0 |
| 1% Zonyl FSJ | 1.0 | 1.0 | 1.0 | 1.0 | 1.0 | 1.0 | 1.0 | 1.0 | 1.0 | 1.0 | 1.0 |
| 35% AC316 | 7.2 | 7.2 | 7.2 | 7.2 | 7.2 | 7.2 | 7.2 | 7.2 | 7.2 | 7.2 | 7.2 |
| KP-140 | 2.4 | 2.4 | 2.4 | 2.4 | 2.4 | 2.4 | 2.4 | 2.4 | 2.4 | 2.4 | 2.4 |
| % NV | 25.0% | 25.0% | 25.0% | 25.0% | 25.0% | 25.0% | 25.0% | 25.0% | 25.0% | 25.0% | 25.0% |

| | SCC Sample Type | | | | | | | | | |
|---|---|---|---|---|---|---|---|---|---|---|
| | SCC12 | SCC13 | SCC14 | SCC15 | SCC16 | SCC17 | SCC18 | SCC19 | SCC20 | SCC21 |
| SP12 (35%) | 68.6 | | | | | | | | | |
| SP13 (35%) | | 68.6 | | | | | | | | |
| SP14 (30%) | | | 80.0 | | | | | | | |
| SP15 (35%) | | | | 68.6 | | | | | | |
| SP16 (30%) | | | | | 80.0 | | | | | |
| SP17 (35%) | | | | | | 68.6 | | | | |
| SP18 (35%) | | | | | | | 68.6 | | | |
| SP19 (35%) | | | | | | | | 68.6 | | |
| SP20 (35%) | | | | | | | | | 68.6 | |
| SP21 (35%) | | | | | | | | | | 68.6 |
| Water | 33.5 | 33.5 | 22.1 | 33.5 | 22.1 | 33.5 | 33.5 | 33.5 | 33.5 | 33.5 |
| Carbitol DE | 3.0 | 3.0 | 3.0 | 3.0 | 3.0 | 3.0 | 3.0 | 3.0 | 3.0 | 3.0 |
| 1% Zonyl FSJ | 1.0 | 1.0 | 1.0 | 1.0 | 1.0 | 1.0 | 1.0 | 1.0 | 1.0 | 1.0 |
| 35% AC316 | 7.2 | 7.2 | 7.2 | 7.2 | 7.2 | 7.2 | 7.2 | 7.2 | 7.2 | 7.2 |
| KP-140 | 2.4 | 2.4 | 2.4 | 2.4 | 2.4 | 2.4 | 2.4 | 2.4 | 2.4 | 2.4 |
| % NV | 25.0% | 25.0% | 25.0% | 25.0% | 25.0% | 25.0% | 25.0% | 25.0% | 25.0% | 25.0% |

| | SCC Sample Type | | | | | | | | | |
|---|---|---|---|---|---|---|---|---|---|---|
| | SCC22 | SCC23 | SCC24 | SCC25 | SCC26 | SCC27 | SCC28 | SCC29 | SCC30 | SCC31 |
| Urotuf L522 | 60.0 | | | | | | | | | |
| (40%) | | | | | | | | | | |
| NeoPac | | 30.7 | | | | | | | | |
| R9045¹ (45%) | | | | | | | | | | |
| Urotuf L63 | | | 63.2 | | | | | | | |
| (38%) | | | | | | | | | | |
| Bahydrol | | | | 68.6 | | | | | | |
| UH2606 (35%) | | | | | | | | | | |
| NeoRez | | | | | 68.6 | | | | | |
| R2180 (35%) | | | | | | | | | | |
| Urotuf L57 | | | | | | 68.6 | | | | |
| (35%) | | | | | | | | | | |
| SP2 (35%) | | | | | | | 68.6 | 68.6 | 68.6 | 68.6 |
| Water | 42.1 | 52.1 | 33.5 | 33.5 | 33.5 | 33.5 | 33.5 | 33.5 | 33.5 | 33.5 |
| Carbitol DE | 3.0 | 3.5 | 3.0 | 3.0 | 3.0 | 3.0 | 3.0 | 3.0 | 3.0 | 3.0 |
| NEP² | | 3.5 | | | | | | | | |
| 28% NH₄OH | | 0.3 | | | | | 0.25 | 0.25 | 0.25 | 0.25 |
| 15% ZAC | | | | | | | 0.29 | 0.44 | 0.59 | 0.74 |
| 1% Zonyl FSJ | 1.0 | 1.0 | 1.0 | 1.0 | 1.0 | 1.0 | 1.0 | 1.0 | 1.0 | 1.0 |
| 35% AC316 | 7.2 | 5.7 | 7.2 | 7.2 | 7.2 | 7.2 | 7.2 | 7.2 | 7.2 | 7.2 |
| KP-140 | 2.4 | 2.1 | 2.4 | 2.4 | 2.4 | 2.4 | 2.4 | 2.4 | 2.4 | 2.4 |
| % NV | 25.0% | 20.0% | 25.0% | 25.0% | 25.0% | 25.0% | 25.0% | 25.0% | 25.0% | 25.0% |

¹NeoPac R9045, 45% NV Urethane/Acrylic Hybrid Copolymer Dispersion from DSM NeoResins Inc., Wilmington, MA
²NEP, N-ethyl-2-pyrrolidone from International Specialty Products, Wayne, NJ

| SCC | SCC32 | SCC33 | SCC34 | SCC35 | SCC36 |
|---|---|---|---|---|---|
| SCC | 51° C. | 51° C. | 23° C. | 23° C. | 105° C. |
| Polymer | | | | | |
| Tg (° C.) | | | | | |
| Water | | | | | |
| Carbitol DE | 29.5 | 29.5 | 15.5 | 15.5 | 36.5 |
| Carbitol DB | 2.5 | 2.5 | 2.5 | 2.5 | 2.5 |
| KP-140 | 14.1 | 14.1 | 8.1 | 8.1 | 24.7 |
| 1% FSJ | 5.0 | 5.0 | 5.0 | 5.0 | 5.0 |
| 15% ZAC | 14.9 | 0.0 | 14.9 | 0.0 | 0.0 |
| 28% NH₄OH | 0.0 | 0.0 | 0.0 | 0.0 | 3.5 |
| 35% AC316 | 23.7 | 23.7 | 23.7 | 23.7 | 23.7 |
| SP22 (40%) | 207.5 | 207.5 | | | |
| SP23 (40%) | | | 207.5 | 207.5 | |
| SP24 (40%) | | | | | 207.5 |
| % NV | 25.0% | 25.0% | 25.0% | 25.0% | 25.0% |

Table 12 shows formulations for variable SCC coatings comprised of blends of 75% SCC2 (67% L522/33% MMA) and 25% other SCCs, polyurethane polymers, or polyurethane polymer hybrids.

TABLE 12
Second Coating Compositions SCC37-SCC44

| SCC Code | SCC37 | SCC38 | SCC39 | SCC40 | SCC41 | SCC42 | SCC43 | SCC44 |
|---|---|---|---|---|---|---|---|---|
| SCC2 | 75.0 | 750.0 | 75.0 | 75.0 | 75.0 | 75.0 | 75.0 | 75.0 |
| (25% NV) | | | | | | | | |
| SCC11 | 25.0 | 750.0 | | | | | | |
| (25% NV) | | | | | | | | |
| SCC13 | | | 25.0 | | | | | |
| (25% NV) | | | | | | | | |
| SCC14 | | | | 25.0 | | | | |
| (25% NV) | | | | | | | | |
| SCC15 | | | | | 25.0 | | | |
| (25% NV) | | | | | | | | |
| SCC25 | | | | | | 25.0 | | |
| (25% NV) | | | | | | | | |
| SCC26 | | | | | | | 25.0 | |
| (25% NV) | | | | | | | | |
| SCC24 | | | | | | | | 25.0 |
| (25% NV) | | | | | | | | |
| % NV | 25% | | | | | | | |
| 75% PU in | L522 | L522 | L522 | L522 | L522 | L522 | L522 | L522 |
| SCC | | | | | | | | |
| 25% PU in | L63 | L63 | R2180 | UH 2606 | UH 2558 | UH 2606 | R2180 | L63 |
| SCC | | | | | | | | |
| % Acrylic | 33% | 33% | 33% | 33% | 33% | 24.75% | 24.75% | 24.75% |
| in SCC | MMA | MMA | MMA | MMA | MMA | MMA | MMA | MMA |

Table 13 shows formulations for SCCs including physical blends of 67% SCC22 (L522 PU) and 33% acrylic or sty/acrylic polymer.

TABLE 13
Second Coating Compositions SCC45-SCC49

| SCC Code | SCC45 | SCC46 | SCC47 | SCC48 | SCC49 |
|---|---|---|---|---|---|
| SCC22 (25% NV) | 130.0 | | | | |
| SCC32 (25% NV) | 70.0 | | | | |
| SCC33 (25% NV) | | 68.4 | | | |
| SCC34 (25% NV) | | | 66.0 | | |
| SCC35 (25% NV) | | | | 64.5 | |
| SCC36 (25% NV) | | | | | 75.6 |
| 28% NH₄OH | | 0.4 | | 0.4 | 0.4 |
| % NV | 25% | | | | |
| Tg of Acrylic (° C.) | 51° C. | 51° C. | 23° C. | 23° C. | 105° C. |
| Acrylic Contains Zinc | Yes | No | Yes | No | No |

### Example 6

### Application of First Coating Composition/Second Coating Composition System to Vinyl Composition Tile

All FCCs and SCCs were applied to vinyl composition tile (“VCT”) substrates as described below. To a stripped 12 inch by 12 inch Armstrong Excelon commercial VCT (Armstrong World Industries, Lancaster, Pa.), was applied, using a 2″×2″ Kendall Curity™ gauze sponge USP type VII gauze (Tyco Healthcare, Mansfield, Mass.), FCC16 (2 mL; about 0.0028 dry grams of FCC2/square inch deposition) prepared as described in Example 3, which was allowed to dry 45 minutes. On top of the dry FCC16 coating was applied, using a 2″×2″ Kendall Curity™ gauze sponge USP type VII gauze, SCC2 (2 mL; about 0.0035 dry grams of SCC2/square inch deposition) prepared as described in Example 5, which was allowed to dry 45 minutes. The SCC2 was applied four more times in the same manner and then allowed to dry for about 18-24 hours. After drying, five more application coats of SCC2 were applied in the same manner, bringing the total number of SCC2 coats to ten, and yielding a total SCC2 dry coat deposition of about 0.035 dry grams of SCC2/square inch deposition.

### Peel Strength Determination

Peel strengths of FCC/SCC systems were assessed by peeling one-inch wide film strip specimens 90° to the film surface with a peel rate of 1000 mm/min using an INSTRON® 3345 single column testing instrument with a 500 N (50,985 g-force) load cell capacity. ASTM test method D 6862-03 covers the determination of peel strengths of a specimen.

### Delamination Resistance—Extent of Film Rupture

Delamination resistance for FCC/SCC systems were determined using a TABER® Multi-Finger Scratch/Mar Tester—Model 710 (Taber Industries, North Tonawanda, N.Y.) using the scratch mode fingers. Each finger consists of a steel tip that has a different normal force resting on the coated film of the FCC/SCC system. The five fingers have normal forces of 6N, 7N, 10N, 16N, and 20N. FCC/SCC systems were rated from excellent delamination resistance (≦½ film rupture only at 20 N finger), very good delamination resistance (≧½ film rupture only at 20 N finger), good delamination resistance (film rupture only at 16 N and above), fair delamination resistance (film rupture only at 10 N and above), and poor delamination resistance (film rupture only at 7N and above).

### Ultimate Tensile Strength, Break Force and Percent (%) Elongation Value Determination

Ultimate tensile strength, break force, and % elongation values of FCC/SCC systems were assessed by placing a one-inch wide by three-inch long by 0.025-inch to 0.035-inch thick film strip specimen in tension and applying a extension force of about 30 millimeters/minute (mm/min) to the specimen using an INSTRON® 3345 single column testing instrument with a 500 N (50,985 g-force) load cell capacity. ASTM test method D 2370 covers the determination of tensile strength and elongation values of a specimen.

### Gloss Measurement

20° and 60° angle specular gloss measurements were performed on coated VCT using a dual 20° and 60° angle Gloss Master model gloss meter (Quality Imaging Products, Marietta, Ga.). ASTM test method D 523-89 covers the determination of gloss values of coatings.

### Example 7

### Black Heel Mark Resistance (“BHMR”) and Scuff Resistance Testing

Sample Preparation for the Snell Capsule Test Procedure.

To a stripped EXCELON commercial 12 inch by 12 inch white vinyl composition tile (“VCT”) (Armstrong World Industries, Lancaster, Pa.) was applied on half (6 inch by 12 inch) of the tile VECTRA® comparative control and on the other tile half (6 inch by 12 inch) was applied a test coating. Using a 2″×2″ Kendall CURITY™ gauze sponge USP type VII gauze (Tyco Healthcare, Mansfield, Mass.), a FCC such as FCC16 was applied to only the test coating tile half (1 mL; about 0.0028 dry grams of FCC16/square inch deposition) prepared as described in Example 3, which was allowed to dry 45 minutes. No FCC was applied to the Vectra comparative control tile side. On top of the dry FCC16 coating was applied, using a 2″×2″ Kendall CURITY™ gauze sponge USP type VII gauze a SCC such as SCC2 (1 mL; about 0.0035 dry grams of SCC2/square inch deposition) prepared as described in Example 5, which was allowed to dry 45 minutes. The SCC2 was applied four more times in the same manner and then allowed to dry for about 18-24 hours. After drying, five more application coats of SCC2 were applied in the same manner, bringing the total number of SCC2 coats to ten, and yielding a total SCC2 dry coat deposition of about 0.035 dry grams of SCC2/square inch deposition. The VECTRA® comparative control tile half received 10 total coats of Vectra for a dry coat deposition of about 0.028 dry grams of VECTRA®/square inch deposition. The coated tiles were aged for 18-24 hours. The 12 inch by 12 inch coated tiles were symmetrically cut down to 9 inch by 9 inch tiles and inserted into the Snell Capsule Chamber before the Snell Capsule Test Procedure was performed.

Coated tiles were subjected to black heel and scuff marks using a Snell Capsule Test Procedure. The Snell Capsule Test Procedure uses a Programable Snell Tester (Sangyo Co. Ltd., Tokyo, Japan). The Snell capsule consists of a hexagon-shaped steel chamber containing six 5 cm×5 cm carbon black loaded vulcanized natural rubber cubes. Each face of the Snell chamber's hexagon shape has a 9 inch by 9 inch opening which can receive, and hold in place, a coated white vinyl composition facing inward toward the center of the chamber and the rubber cubes. The coated tiles facing inward to the center of the chamber are held in place centered over the 9 inch by 9 inch opening by bolts and wing nuts at each corner of the tile using a steel plate backing outside of the tile. The chamber can test 6 coated vinyl composition tiles in one test procedure. The chamber is attached to a drive shaft and an electric motor which allows the chamber to be rotated along its axis. Each program cycle consists of a clockwise rotation of the chamber for 10 seconds at 60 rpm, stopping, and then a counter clockwise rotation of the chamber for 10 seconds at 60 rpm exposing the coated tiles to a bombardment from the six rubber cubes. The Snell Capsule is rotated for 100 program cycles. Coatings are rated for black heel and scuff marks relative to a comparative control coating. The comparative control coating was VECTRA® floor finish (Diversey, Racine, Wis.). If the test coating has equal black heel and scuff marks to the comparative control, then the test coating would receive a rating of zero “0”. If the test coating has fewer black heel and scuff marks than the comparative control, the test coating receives a rating of >0. If the test coating has more black heel and scuff marks than the comparative control, the test coating receives a rating of <0. The Snell Capsule rating scale key is shown below. ASTM test method D 1630-94 covers the determination of scuff and black heel mark values from Snell Capsule testing.

### Snell Capsule Rating Scale Key

### Very Good (VG) >1

### Very Good to Good (VG/G) 1 to 0.5

### Good (G) <0.5 to 0

### Good to Fair (G/F) <0 to −0.5

### Fair (F) <−0.5 to −1

### Fair to Poor (F/P) <−1 to −1.5

### Poor (P) <−1.5

Preparation of SCCs and FCCs used in Examples

### Second Coating Compositions (“SCCs”)

SCCs of the compositions shown in Table 14 were prepared as described in Example 5.

TABLE 14
SCC Formulations

| | | | | | ZnO/COOH: | Hybrid (“H”) or |
|---|---|---|---|---|---|---|
| | | % Dry PU | Acrylic Type and Dry % | | SCC | Straight PU (“PU”) |
| SCC | PU Type | in SCC | Acrylic Polymer in SCC | Zinc | Polymer | or Physical Blend |
| Sample | in SCC | Formulation | Formulation | in SCC | Mole Ratio | (“PB”) SCC |
| 1 | L522 | 75 | 25% MMA | No | | H |
| 2 | L522 | 67 | 33% MMA | No | | H |
| 3 | L522 | 75 | 25% TBMA | No | | H |
| 4 | L522 | 50 | 50% MMA | No | | H |
| 5 | L522 | 67 | 33% TBMA | No | | H |
| 6 | L522 | 71 | 14.5% MMA/14.5% TBMA | No | | H |
| 7 | L522 | 67 | 33% Styrene | No | | H |
| 8 | L522 | 67 | 8.25% MMA/24.75% Styrene | No | | H |
| 9 | L522 | 67 | 16.5% MMA/16.5% Styrene | No | | H |
| 10 | L522 | 67 | 24.75% MMA/8.25% Styrene | No | | H |
| 11 | L63 | 67 | 33% MMA | No | | H |
| 12 | L63 | 67 | 33% TBMA | No | | H |
| 13 | R2180 | 67 | 33% MMA | No | | H |
| 14 | UH2606 | 67 | 33% MMA | No | | H |
| 15 | UH2558 | 67 | 33% MMA | No | | H |
| 16 | 2593/1 | 67 | 33% MMA | No | | H |
| 17 | UHXP2719 | 67 | 33% MMA | No | | H |
| 18 | UH2557 | 67 | 33% MMA | No | | H |
| 19 | L57 | 75 | 25% MMA | No | | H |
| 20 | L57 | 67 | 33% MMA | No | | H |
| 21 | L57 | 67 | 33% IBMA | No | | H |
| 22 | L522 | 100 | 0% | No | | PU |
| 23 | NeoPac | PU | Acrylic | No | | H |
| | R9045 | | | | | |
| 24 | L63 | 100 | 0% | No | | PU |
| 25 | UH2606 | 100 | 0% | No | | PU |
| 26 | R2180 | 100 | 0% | No | | PU |
| 27 | L57 | 100 | 0% | No | | PU |
| 28 | L522 | 67 | 33% MMA | Yes | 0.08 | H |
| 29 | L522 | 67 | 33% MMA | Yes | 0.12 | H |
| 30 | L522 | 67 | 33% MMA | Yes | 0.16 | H |
| 31 | L522 | 67 | 33% MMA | Yes | 0.2 | H |
| 32 | — | 0 | 100% Sty/Acrylic | Yes | 0.14 | |
| | | | 51° C. Tg | | | |
| 33 | — | 0 | 100% Sty/Acrylic | No | | |
| | | | 51° C. Tg | | | |
| 34 | — | 0 | 100% Sty/Acrylic | Yes | 0.14 | |
| | | | 23° C. Tg | | | |
| 35 | — | 0 | 100% Sty/Acrylic | No | | |
| | | | 23° C. Tg | | | |
| 36 | — | 0 | 100% PMMA 105° C.Tg | No | | |
| 37 | L522/L63 | 50.25% L522/ | 33% MMA | No | | H & H |
| | | 16.75% L63 | | | | PB |
| 38 | L522/L63 | 33.5% L522/ | 33% MMA | No | | H & H |
| | | 33.5% L63 | | | | PB |
| 39 | L522/R2180 | 50.25% L522/ | 33% MMA | No | | H & H |
| | | 16.75% R2180 | | | | PB |
| 40 | L522/2606 | 50.25% L522/ | 33% MMA | No | | H & H |
| | | 16.75% UH2606 | | | | PB |
| 41 | L522/2558 | 50.25% L522/ | 33% MMA | No | | H & H |
| | | 16.75% UH2558 | | | | PB |
| 42 | L522/2606 | 50.25% L522/ | 24.75% MMA | No | | H & PU |
| | | 25% UH2606 | | | | PB |
| 43 | L522/R2180 | 50.25% L522/ | 24.75% MMA | No | | H & PU |
| | | 25% R2180 | | | | PB |
| 44 | L522/L63 | 50.25% L522/ | 24.75% MMA | No | | H & PU |
| | | 25% L63 | | | | PB |
| 45 | L522 | 67 | 33% Styrene-Acrylic 51° C. Tg | Yes | 0.14 | PB |
| 46 | L522 | 67 | 33% Styrene-Acrylic 51° C. Tg | No | | PB |
| 47 | L522 | 67 | 33% Styrene-Acrylic 23° C. Tg | Yes | 0.14 | PB |
| 48 | L522 | 67 | 33% Styrene-Acrylic 23° C. Tg | No | | PB |
| 49 | L522 | 67 | 33% PMMA 105° C. Tg | No | | PB |

### First Coating Compositions (“FCCs”)

FCCs of the compositions shown in Table 15 were prepared as described in Example 3.

TABLE 15
FCC Formulations

| | | | pphm | | | | |
|---|---|---|---|---|---|---|---|
| | | FCC | MAA | Polymer | FCC Polymer | ZnO/COOH: | |
| FCC | FCC Polymer | Tg | of FCC | Stabilization | Covalently | FCC Polymer | % Wax and |
| Sample | Type | (° C.) | Polymer | Type | Crosslinked | Mole Ratio | Type in FCC |
| 1 | Styrene-Acrylic | 80 | 15 | Surfactant | No | 0 | 0 |
| 2 | Styrene-Acrylic | 80 | 15 | Surfactant | No | 0.14 | 0 |
| 3 | Styrene-Acrylic | 80 | 15 | Surfactant | No | 0.28 | 0 |
| 4 | Styrene-Acrylic | 66 | 15 | Surfactant | No | 0.28 | 0 |
| 5 | Styrene-Acrylic | 51 | 15 | Surfactant | No | 0 | 0 |
| 6 | Styrene-Acrylic | 51 | 15 | Surfactant | No | 0.14 | 0 |
| 7 | Styrene-Acrylic | 51 | 15 | Surfactant | No | 0.28 | 0 |
| 8 | Styrene-Acrylic | 51 | 15 | Surfactant | No | 0.28 | 10% AC316 |
| 9 | Styrene-Acrylic | 51 | 15 | Surfactant | No | 0 | 20% AC316 |
| 10 | Styrene-Acrylic | 51 | 15 | Surfactant | No | 0.14 | 20% AC316 |
| 11 | Styrene-Acrylic | 51 | 15 | Surfactant | No | 0.28 | 20% AC316 |
| 12 | Styrene-Acrylic | 37 | 15 | Surfactant | No | 0.28 | 0 |
| 13 | Styrene-Acrylic | 37 | 15 | Surfactant | No | 0.28 | 10% AC316 |
| 14 | Styrene-Acrylic | 37 | 15 | Surfactant | No | 0.28 | 20% AC316 |
| 15 | Styrene-Acrylic | 23 | 15 | Surfactant | No | 0 | 0 |
| 16 | Styrene-Acrylic | 23 | 15 | Surfactant | No | 0.140 | 0 |
| 17 | Styrene-Acrylic | 23 | 15 | Surfactant | No | 0.28 | 0 |
| 18 | Styrene-Acrylic | 23 | 15 | Surfactant | No | 0.28 | 10% AC316 |
| 19 | Styrene-Acrylic | 23 | 15 | Surfactant | No | 0 | 20% AC316 |
| 20 | Styrene-Acrylic | 23 | 15 | Surfactant | No | 0.14 | 20% AC316 |
| 21 | Styrene-Acrylic | 23 | 15 | Surfactant | No | 0.28 | 20% AC316 |
| 22 | Styrene-Acrylic | 7 | 15 | Surfactant | No | 0.28 | 0 |
| 23 | Styrene-Acrylic | 7 | 15 | Surfactant | No | 0.28 | 10% AC316 |
| 24 | Styrene-Acrylic | 7 | 15 | Surfactant | No | 0.28 | 20% AC316 |
| 25 | Styrene-Acrylic | −10 | 15 | Surfactant | No | 0 | 0 |
| 26 | Styrene-Acrylic | −10 | 15 | Surfactant | No | 0.14 | 0 |
| 27 | Styrene-Acrylic | −10 | 15 | Surfactant | No | 0.28 | 0 |
| 28 | Styrene-Acrylic | −10 | 15 | Surfactant | No | 0 | 10% AC316 |
| 29 | Styrene-Acrylic | −10 | 15 | Surfactant | No | 0 | 10% E43 |
| 30 | Styrene-Acrylic | −10 | 15 | Surfactant | No | 0 | 10% |
| | | | | | | | ML46940M1 |
| 31 | Styrene-Acrylic | −10 | 15 | Surfactant | No | 0 | 10% ML743 |
| 32 | Styrene-Acrylic | −10 | 15 | Surfactant | No | 0 | 10% Aqua |
| | | | | | | | Slip 952 |
| 33 | Styrene-Acrylic | −10 | 15 | Surfactant | No | 0.28 | 10% AC316 |
| 34 | Styrene-Acrylic | −10 | 15 | Surfactant | No | 0 | 20% AC316 |
| 35 | Styrene-Acrylic | −10 | 15 | Surfactant | No | 0.14 | 20% AC316 |
| 36 | Styrene-Acrylic | −10 | 15 | Surfactant | No | 0.28 | 20% AC316 |
| 37 | Styrene-Acrylic | −23 | 15 | Surfactant | No | 0.28 | 0 |
| 38 | Styrene-Acrylic | −34 | 15 | Surfactant | No | 0 | 0 |
| 39 | Styrene-Acrylic | −34 | 15 | Surfactant | No | 0.14 | 0 |
| 40 | Styrene-Acrylic | −34 | 15 | Surfactant | No | 0.28 | 0 |
| 41 | Acrylic | 37 | 0 | Surfactant | No | 0 | 0 |
| 42 | Acrylic | 37 | 0 | Surfactant | Yes | 0 | 0 |
| 43 | Acrylic | 37 | 0 | Surfactant | Yes | 0 | 10% AC316 |
| 44 | Acrylic | 22 | 0 | Surfactant | No | 0 | 0 |
| 45 | Acrylic | 22 | 0 | Surfactant | Yes | 0 | 0 |
| 46 | Acrylic | 22 | 0 | Surfactant | Yes | 0 | 10% AC316 |
| 47 | Acrylic | 6 | 0 | Surfactant | No | 0 | 0 |
| 48 | Acrylic | 6 | 0 | Surfactant | Yes | 0 | 0 |
| 49 | Acrylic | 6 | 0 | Surfactant | Yes | 0 | 10% AC316 |
| 50 | Acrylic | −10 | 0 | Surfactant | No | 0 | 0 |
| 51 | Acrylic | −10 | 0 | Surfactant | Yes | 0 | 0 |
| 52 | Acrylic | −10 | 0 | Surfactant | Yes | 0 | 10% AC316 |
| 53 | Acrylic | −10 | 0 | Surfactant | No | 0 | 10% AC316 |
| 54 | Acrylic | −10 | 0 | Surfactant | Yes | 0 | 10% |
| | | | | | | | ML46940M1 |
| 55 | Acrylic | −10 | 0 | Surfactant | Yes | 0 | 10% ML743 |
| 56 | Acrylic | −10 | 0 | Surfactant | No | 0 | 10% E43 |
| 57 | Acrylic | −10 | 0 | Surfactant | No | 0 | 10% |
| | | | | | | | ML46940M1 |
| 58 | Acrylic | −10 | 0 | Surfactant | No | 0 | 10% ML743 |
| 59 | Acrylic | −10 | 0 | Surfactant | No | 0 | 10% Aqua |
| | | | | | | | Slip 952 |
| 60 | Acrylic | −24 | 0 | Surfactant | No | 0 | 0 |
| 61 | Acrylic | −24 | 0 | Surfactant | Yes | 0 | 0 |
| 62 | Acrylic | −24 | 0 | Surfactant | Yes | 0 | 10% AC316 |
| 63 | Acrylic | −39 | 0 | Surfactant | No | 0 | 0 |
| 64 | Acrylic | −39 | 0 | Surfactant | Yes | 0 | 0 |
| 65 | Acrylic | −39 | 0 | Surfactant | Yes | 0 | 10% AC316 |
| 66 | Acrylic | −54 | 0 | Surfactant | No | 0 | 0 |
| 67 | Acrylic | −54 | 0 | Surfactant | Yes | 0 | 0 |
| 68 | Acrylic | −54 | 0 | Surfactant | Yes | 0 | 10% AC316 |
| 69 | Styrene-Acrylic | 50 | 0 | ASR Polymer | Yes | 0 | 0 |
| | | | | Colloid | | | |
| 70 | Styrene-Acrylic | 35 | 0 | ASR Polymer | Yes | 0 | 0 |
| | | | | Colloid | | | |
| 71 | Styrene-Acrylic | 20 | 0 | ASR Polymer | Yes | 0 | 0 |
| | | | | Colloid | | | |
| 72 | Styrene-Acrylic | 5 | 0 | ASR Polymer | Yes | 0 | 0 |
| | | | | Colloid | | | |
| 73 | Styrene-Acrylic | −10 | 0 | ASR Polymer | Yes | 0 | 0 |
| | | | | Colloid | | | |
| 74 | Styrene-Acrylic | −10 | 0 | ASR Polymer | Yes | 0 | 10% AC316 |
| | | | | Colloid | | | |
| 75 | Styrene-Acrylic | −10 | 0 | ASR Polymer | Yes | 0 | 10% |
| | | | | Colloid | | | ML46940M1 |
| 76 | Styrene-Acrylic | −10 | 0 | ASR Polymer | Yes | 0 | 10% ML743 |
| | | | | Colloid | | | |
| 77 | Styrene-Acrylic | −24 | 0 | ASR Polymer | Yes | 0 | 0 |
| | | | | Colloid | | | |
| 78 | Styrene-Acrylic | −24 | 0 | ASR Polymer | Yes | 0 | 10% AC316 |
| | | | | Colloid | | | |
| 79 | Styrene-Acrylic | −24 | 0 | ASR Polymer | Yes | 0 | 20% AC316 |
| | | | | Colloid | | | |
| 80 | Styrene-Acrylic | −36 | 0 | ASR Polymer | Yes | 0 | 0 |
| | | | | Colloid | | | |
| 81 | Styrene-Acrylic | −47 | 0 | ASR Polymer | Yes | 0 | 0 |
| | | | | Colloid | | | |
| 82 | Styrene-Acrylic | −57 | 0 | ASR Polymer | Yes | 0 | 0 |
| | | | | Colloid | | | |
| 83 | Styrene-Butadiene | 54 | — | Surfactant | — | 0 | 0 |
| 84 | Styrene-Butadiene | 54 | — | Surfactant | — | 0 | 10% AC316 |
| 85 | Styrene-Butadiene | 24 | — | Surfactant | — | 0 | 0 |
| 86 | Styrene-Butadiene | 24 | — | Surfactant | — | 0 | 10% AC316 |
| 87 | Styrene-Butadiene | −5 | — | Surfactant | — | 0 | 0 |
| 88 | Styrene-Butadiene | −5 | — | Surfactant | — | 0 | 10% AC316 |
| 89 | Styrene-Butadiene | −5 | — | Surfactant | — | 0 | 10% |
| | | | | | | | ML46940M1 |
| 90 | Styrene-Butadiene | −5 | — | Surfactant | — | 0 | 10% ML743 |
| 91 | Styrene-Butadiene | −30 | — | Surfactant | — | 0 | 0 |
| 92 | Styrene-Butadiene | −30 | — | Surfactant | — | 0 | 10% AC316 |
| 93 | Styrene-Butadiene | −50 | — | Surfactant | — | 0 | 0 |
| 94 | Styrene-Butadiene | −50 | — | Surfactant | — | 0 | 10% AC316 |
| 95 | Styrene-Butadiene | −80 | — | Surfactant | — | 0 | 0 |
| 96 | Styrene-Butadiene | −80 | — | Surfactant | — | 0 | 10% AC316 |

### Example 8

Table 15 summarizes physical properties of various polyurethane or polyurethane/acrylic hybrid second coating compositions when coated on different first coating compositions. Tiles were coated as described in Example 6. The “90° Peel Average Load”, Ultimate Tensile Strength, Break Force, % Elongation, and Gloss were determined as described in Example 6. The Snell results were determined as described in Example 7. Peel, Tensile, % Elongation, and gloss tests were performed at 80° F. and 20% Relative Humidity (% RH). Snell Capsule testing was performed at 72° F. and 50% Relative Humdity (% RH). As shown in Table 15, results demonstrate the effect of the type of polyurethane used in the second coating composition, the type and content of the acrylic used in the second coating composition, and the type of first coating composition used.

TABLE 15
Physical Properties of Polyurethane or Polyurethane/Acrylic Hybrid
Second Coating Compositions on Variable First Coating Compositions

| | | 90° Peel | Break | Ultimate | | | Snell | 10 Coat |
|---|---|---|---|---|---|---|---|---|
| | | Avg. | Force | Tensile | % | Snell | Results | SCC |
| SCC | FCC | Load | Max Load | Strength | Elonga- | Results | Scuff | Gloss |
| Sample | Sample | g-Force | g-Force | psi | tion | BHMR | Resistance | 20°/60° |
| 22 | 16 | 228 | 937 | 1050 | 420 | Fair | Poor | 75/90 |
| 22 | 83 | 274 | 762 | 853 | 400 | | | 80/90 |
| 1 | 7 | 240 | | | | | | 83/97 |
| 2 | 16 | 247 | 1080 | 1210 | 283 | Good | Good | 80/90 |
| 2 | 6 | 125 | 1161 | 1300 | 270 | | | 82/90 |
| 2 | 83 | 255 | 1043 | 1169 | 263 | | | 76/90 |
| 3 | 7 | 269 | | | | | | 83/96 |
| 5 | 16 | 283 | 753 | 844 | 235 | Fair to | Fair | 69/89 |
| | | | | | | Poor | | |
| 5 | 83 | 221 | 890 | 997 | 353 | | | 76/89 |
| 6 | 7 | 333 | | | | | | 85/96 |
| 7 | 16 | 227 | 980 | 1097 | 368 | Fair | Fair to | 81/95 |
| | | | | | | | Poor | |
| 7 | 6 | 124 | 944 | 1057 | 349 | | | 85/94 |
| 7 | 83 | 232 | 1007 | 1127 | 372 | | | 81/94 |
| 8 | 6 | 123 | 1104 | 1236 | 350 | | | 86/94 |
| 9 | 16 | 213 | 1120 | 1254 | 332 | Good to | Good to | 76/92 |
| | | | | | | Fair | Fair | |
| 9 | 6 | 127 | 809 | 906 | 218 | | | 83/92 |
| 9 | 83 | 272 | 802 | 898 | 271 | | | 82/92 |
| 10 | 6 | 132 | 1387 | 1554 | 332 | | | 85/91 |
| 11 | 16 | 430 | 2050 | 2295 | 126 | Good | V. Good | 79/90 |
| 11 | 6 | 97 | | | | | | 87/98 |
| 11 | 83 | 132 | 1715 | 1921 | 59 | | | 74/90 |
| 12 | 16 | 185 | | | | | | 82/92 |
| 12 | 6 | 410 | 1933 | 2149 | 133 | Good | Good | 81/92 |
| 12 | 83 | 172 | 1876 | 2074 | 128 | | | 80/91 |
| 19 | 7 | 271 | | | | | | 86/96 |

### Example 9

Table 16 summarizes physical properties of various polyurethane/acrylic hybrid second coating compositions when coated on different first coating compositions. Tiles were coated as described in Example 6. The “90° Peel Average Load”, Ultimate Tensile Strength, Break Force, % Elongation, and Gloss were determined as described in Example 6. The Snell results were determined as described in Example 7. Peel, Tensile, % Elongation, and gloss tests were performed at 80° F. and 20% Relative Humidity (% RH). Snell Capsule testing was performed at 72° F. and 50% Relative Humidity (% RH). As shown in Table 16, results demonstrate the effect of the type of polyurethane used in the second coating composition, the type and content of the acrylic used in the second coating composition, and the type of first coating composition used.

TABLE 16
Physical Properties of Polyurethane/Acrylic Hybrid Second
Coating Compositions on Variable First Coating Compositions

| | | 90° Peel | Break | Ultimate | | | Snell | 10 Coat |
|---|---|---|---|---|---|---|---|---|
| | | Avg. | Force | Tensile | % | Snell | Results | SCC |
| SCC | FCC | Load | Max Load | Strength | Elonga- | Results | Scuff | Gloss |
| Type | Type | g-Force | g-Force | psi | tion | BHMR | Resistance | 20°/60° |
| 2 | 16 | 247 | 1080 | 1210 | 283 | Good | Good | 80/90 |
| 2 | 6 | 125 | 1161 | 1300 | 270 | | | 82/90 |
| 2 | 83 | 255 | 1043 | 1169 | 263 | | | 76/90 |
| 11 | 16 | 430 | 2050 | 2295 | 126 | Good | V. Good | 79/90 |
| 11 | 7 | 97 | | | | | | 87/98 |
| 11 | 83 | 132 | 1715 | 1921 | 59 | | | 74/90 |
| 13 | 16 | 341 | 1355 | 1517 | 83 | Good | V. Good | 74/89 |
| | | | | | | | to Good | |
| 13 | 83 | 191 | 1214 | 1359 | 75 | | | 71/89 |
| 14 | 16 | 213 | 1568 | 1757 | 16 | Fair to | Good | 82/90 |
| | | | | | | Poor | | |
| 14 | 83 | 160 | 1581 | 1771 | 23 | | | 74/90 |
| 23 | 16 | 309 | 745 | 835 | 205 | Good | Good | 60/88 |
| 23 | 83 | 194 | 829 | 928 | 213 | | | 63/88 |
| 15 | 16 | | | | | Poor | Fair | 71/89 |
| 15 | 83 | | | | | | | 73/89 |
| 16 | 16 | | | | | | | 71/89 |
| 16 | 83 | | | | | | | 70/90 |
| 17 | 16 | | | | | Poor | Fair | 73/90 |
| 17 | 83 | | | | | | | 74/90 |

### Example 10

Table 17 summarizes physical properties of a polyurethane/acrylic hybrid and physical blend second coating compositions when coated on different first coating compositions. Tiles were coated as described in Example 6. The “90° Peel Average Load”, Ultimate Tensile Strength, Break Force, % Elongation, and Gloss were determined as described in Example 6. The Snell results were determined as described in Example 7. Peel, Tensile, % Elongation, and gloss tests were performed at 80° F. and 20% Relative Humidity (% RH). Snell Capsule testing was performed at 72° F. and 50% Relative Humidity (% RH). As shown in Table 17, results demonstrate the effect of the type of hybrid composition or physical blend composition used in the second coating composition, and the type of first coating composition used.

TABLE 17
Physical Properties of Polyurethane/Acrylic Hybrid Second Coating
Compositions Compared to Physical Blend Second Coating Compositions

| | | 90° Peel | Break | Ultimate | | | Snell | 10Coat |
|---|---|---|---|---|---|---|---|---|
| | | Avg. | Force | Tensile | % | Snell | Results | SCC |
| SCC | FCC | Load | Max Load | Strength | Elonga- | Results | Scuff | Gloss |
| Type | Type | g-Force | g-Force | psi | tion | BHMR | Resistance | 20°/60° |
| 2 | 16 | 247 | 1080 | 1210 | 283 | Good | Good | 80/90 |
| 2 | 6 | 125 | 1161 | 1300 | 270 | | | 82/90 |
| 2 | 83 | 255 | 1043 | 1169 | 263 | | | 76/90 |
| 45 | 16 | 247 | 498 | 557 | 282 | Poor | Poor | 78/91 |
| 45 | 6 | 102 | 553 | 619 | 255 | | | 75/91 |
| 46 | 16 | 202 | 733 | 822 | 290 | Good to | Fair | 78/91 |
| | | | | | | Fair | | |
| 46 | 6 | 81 | 716 | 802 | 233 | | | 74/91 |
| 46 | 83 | 242 | 700 | 791 | 275 | | | 79/90 |
| 47 | 16 | 286 | 473 | 530 | 267 | Poor | Poor | 79/91 |
| 47 | 6 | 203 | 423 | 473 | 232 | | | 70/91 |
| 48 | 16 | 228 | 625 | 700 | 219 | Fair to | Poor | 82/91 |
| | | | | | | Poor | | |
| 48 | 6 | 143 | 729 | 816 | 288 | | | 78/91 |
| 48 | 83 | 273 | 598 | 691 | 208 | | | 80/91 |
| 49 | 16 | 297 | 584 | 655 | 395 | Good | Fair to | 69/88 |
| | | | | | | | Poor | |
| 49 | 6 | 110 | 723 | 809 | 389 | | | 70/87 |
| 49 | 83 | 336 | 602 | 694 | 386 | | | 72/89 |

### Example 11

Table 18 summarizes physical properties of polyurethane/acrylic hybrid second coating compositions when coated on different first coating compositions. Tiles were coated as described in Example 6. The “90° Peel Average Load”, Ultimate Tensile Strength, Break Force, % Elongation, and Gloss were determined as described in Example 6. Tensile, % Elongation, and gloss tests were performed at 80° F. and 20% Relative Humidity (% RH). As shown in Table 18, results demonstrate the effect of zinc oxide in the second coating composition, and the type of first coating composition used.

TABLE 18
Effects of Zinc Oxide in the Second Coating Composition
on Physical Properties of a Polyurethane/Acrylic
Hybrid Second Coating Composition

| | | | 90° | Break | | | |
|---|---|---|---|---|---|---|---|
| | | ZnO/ | Peel | Force | Ultimate | | 10Coat |
| | | COOH | Avg. | Max | Tensile | % | SCC |
| SCC | FCC | Mole | Load | Load | Strength | Elonga- | Gloss |
| Type | Type | Ratio | g-Force | g-Force | psi | tion | 20°/60° |
| 2 | 16 | 0 | 247 | 1080 | 1210 | 283 | 80/90 |
| 2 | 6 | 0 | 125 | 1161 | 1300 | 270 | 82/90 |
| 2 | 83 | 0 | 255 | 1043 | 1169 | 263 | 76/90 |
| 28 | 6 | 0.08 | 141 | 1113 | 1247 | 238 | 76/90 |
| 29 | 6 | 0.12 | 104 | 1050 | 1176 | 206 | 84/90 |
| 30 | 6 | 0.16 | 107 | 1299 | 1455 | 261 | 79/89 |
| 31 | 16 | 0.2 | 264 | 1173 | 1313 | 237 | 81/90 |
| 31 | 6 | 0.2 | 108 | 1035 | 1160 | 227 | 78/89 |
| 31 | 83 | 0.2 | 271 | 1098 | 1236 | 241 | 81/91 |

### Example 12

Table 19 summarizes physical properties of various polyurethane or polyurethane/acrylic hybrid second coating compositions when coated on different first coating compositions. Tiles were coated as described in Example 6. The “90° Peel Average Load”, Ultimate Tensile Strength, Break Force, % Elongation, and Gloss were determined as described in Example 6. The Snell results were determined as described in Example 7. Tensile, % Elongation, and gloss tests were performed at 80° F. and 20% Relative Humidity (% RH). Snell Capsule testing was performed at 72° F. and 50% Relative Humidity (% RH). As shown in table 19, results demonstrate the effect of the type of polyurethane used in the second coating composition, the type and content of the acrylic used in the second coating composition, and the type of first coating composition used.

TABLE 19
Physical Properties of Polyurethane or Polyurethane/Acrylic Hybrid
Second Coating Compositions on Variable First Coating Compositions

| | | 90° Peel | Break | Ultimate | | | Snell | 10 Coat |
|---|---|---|---|---|---|---|---|---|
| | | Avg. | Force | Tensile | % | Snell | Results | SCC |
| SCC | FCC | Load | Max Load | Strength | Elonga- | Results | Scuff | Gloss |
| Type | Type | g-Force | g-Force | psi | tion | BHMR | Resistance | 20°/60° |
| 22 | 16 | 228 | 937 | 1050 | 420 | Fair | Poor | 75/90 |
| 22 | 7 | 543 | | | | | | 84/97 |
| 22 | 83 | 274 | 762 | 853 | 400 | | | 80/90 |
| 24 | 16 | 322 | 1964 | 2199 | 64 | V. Good | V. Good | 70/91 |
| | | | | | | to Good | | |
| 24 | 7 | 353 | | | | | | 88/99 |
| 24 | 83 | 58 | 1833 | 2054 | 59 | | | 75/92 |
| 25 | 16 | 199 | 1620 | 1815 | 79 | V. Good | Good | 79/91 |
| | | | | | | to Good | | |
| 25 | 83 | 111 | 1571 | 1770 | 71 | | | 80/90 |
| 26 | 16 | 296 | 1388 | 1554 | 171 | Good | V. Good | 82/91 |
| | | | | | | | to Good | |
| 26 | 83 | 153 | 1353 | 1505 | 166 | | | 83/90 |
| 27 | 7 | 374 | | | | | | 79/95 |
| 2 | 16 | 247 | 1080 | 1210 | 283 | Good | Good | 80/90 |
| 2 | 6 | 125 | 1161 | 1300 | 270 | | | 82/90 |
| 2 | 83 | 255 | 1043 | 1169 | 263 | | | 76/90 |

### Example 13

Table 20 summarizes physical properties of various polyurethane/acrylic hybrid second coating compositions when coated on different first coating compositions. Tiles were coated as described in Example 6. The “90° Peel Average Load” was determined as described in Example 6. The Snell results were determined as described in Example 7. Peel tests were performed at 80° F. and 80% Relative Humidity (% RH). Snell Capsule testing was performed at 72° F. and 50% Relative Humidity (% RH). As shown in Table 20, results demonstrate the effect of the type of polyurethane used in the second coating composition, the type and content of the acrylic used in the second coating composition, and the type of first coating composition used.

TABLE 20
Physical Properties of Polyurethane/Acrylic Hybrid Second Coating
Compositions on Variable First Coating Compositions

| | | 90°Peel | | |
|---|---|---|---|---|
| | | Avg. | | |
| SCC | FCC | Load | Snell Results | Snell Results |
| Type- | Type | g-Force | BHMR | Scuff Resistance |
| 1 | 7 | 297 | | |
| 2 | 7 | 318 | | |
| 2 | 79 | 312 | | |
| 2 | 78 | 356 | | |
| 4 | 16 | | Poor | Fair |
| 4 | 7 | 369 | | |
| 4 | 78 | 433 | | |
| 6 | 7 | 329 | | |
| 3 | 7 | 307 | | |
| 5 | 16 | | Fair to Poor | Fair |
| 5 | 7 | 351 | | |
| 5 | 79 | 410 | | |
| 11 | 16 | | Good | V. Good |
| 11 | 7 | 187 | | |
| 11 | 79 | 262 | | |
| 11 | 78 | 419 | | |
| 12 | 16 | | Good | Good |
| 12 | 7 | 194 | | |
| 12 | 79 | 222 | | |
| 12 | 78 | 376 | | |
| 23 | 16 | | Good | Good |
| 23 | 7 | 452 | | |
| 23 | 79 | 343 | | |
| 23 | 78 | 307 | | |
| 13 | 16 | | Good | V. Good to Good |
| 13 | 7 | 535 | | |
| 13 | 79 | 326 | | |
| 13 | 78 | 349 | | |
| 15 | 16 | | Poor | Fair |
| 15 | 79 | 496 | | |
| 18 | 16 | | Poor | Fair |
| 18 | 7 | 392 | | |
| 17 | 16 | | Poor | Fair |
| 17 | 7 | 200 | | |
| 17 | 79 | 379 | | |
| 14 | 16 | | Fair to Poor | Good |
| 14 | 7 | 408 | | |
| 20 | 7 | 434 | | |
| 21 | 7 | 721 | | |

### Example 14

Table 21 summarizes physical properties of polyurethane/acrylic hybrid or physical blend second coating compositions when coated on first coating composition FCC16. Tiles were coated as described in Example 6. The “90° Peel Average Load”, Ultimate Tensile Strength, Break Force, % Elongation, and Gloss were determined as described in Example 6. The Snell results were determined as described in Example 7. Peel, Tensile, % Elongation, and gloss tests were performed at 80° F. and 20% Relative Humidity (% RH). Snell Capsule testing was performed at 72° F. and 50% Relative Humidity (% RH). As shown in Table 21, results demonstrate the effect of the type of polyurethane used in the second coating composition, the type of physical blend used in the second coating composition, and the type of first coating composition used.

TABLE 21
Physical Properties of Polyurethane/Acrylic Hybrid and Physical Blend
Second Coating Compositions Coated on First Coating Composition FCC16

| | | 90° Peel | Break | Ultimate | | | Snell | 10 Coat |
|---|---|---|---|---|---|---|---|---|
| | | Avg. | Force | Tensile | % | Snell | Results | SCC |
| SCC | FCC | Load | Max Load | Strength | Elonga- | Results | Scuff | Gloss |
| Type | Type | g-Force | g-Force | psi | tion | BHMR | Resistance | 20°/60° |
| 2 | 16 | 247 | 1080 | 1210 | 283 | Good | Good | 80/90 |
| 37 | 16 | 299 | 1229 | 1377 | 203 | Fair | Good to | 81/91 |
| | | | | | | | Fair | |
| 38 | 16 | 252 | 1208 | 1353 | 131 | | | 69/89 |
| 39 | 16 | 269 | 823 | 922 | 165 | Good | Good to | 84/91 |
| | | | | | | | Fair | |
| 40 | 16 | 289 | 1024 | 1147 | 219 | Good to | Good to | 84/91 |
| | | | | | | Fair | Fair | |
| 41 | 16 | 368 | 848 | 950 | 181 | Fair | Good to | 83/91 |
| | | | | | | | Fair | |
| 42 | 16 | 293 | 1313 | 1470 | 280 | Good | Good | 80/91 |
| 43 | 16 | 250 | 1079 | 1211 | 229 | Good | Good | 82/91 |
| 44 | 16 | 285 | 1289 | 1443 | 212 | Good | Good | 80/91 |

### Example 15

Table 22 summarizes Snell and delamination resistance results of various polyurethane or polyurethane/acrylic hybrids or physical blends of second coating compositions when coated on first coating composition FCC16. Tiles were coated as described in Example 6. The delamination resistance was determined as described in Example 6. The Snell results were determined as described in Example 7. The Snell Capsule and delamination resistance testing were performed at 72° F. and 50% Relative Humidity (% RH). As shown in Table 22, results demonstrate the effect of the type of polyurethane used in the second coating composition, the type and content of the acrylic used in the second coating composition, and the type of physical blend composition used in the second coating composition, and the type of first coating composition used.

TABLE 22
Snell and Delamination Resistance Results of Polyurethane Second
Coating Compositions Coated on First Coating Composition FCC16

| | | | | | Delamination | Delamination |
|---|---|---|---|---|---|---|
| | | Scuff | | | Resistance | Resistance |
| SCC | BHMR | Resist | Total | | Group | Rating Best (1) |
| Type | Rating | Rating | Score | Total Avg | Rating | to Worst (30) |
| 24 | VG/G | VG | 1.86 | 0.82/1.04 | Good | 7 |
| 11 | G | VG | 1.48 | 0.28/1.2 | Good | 6 |
| 26 | G | VG/G | 1.26 | 0.32/0.94 | Excellent | 1 |
| 25 | VG/G | G | 1.14 | 0.94/0.2 | Good | 10 |
| 31 | VG/G | G | 1.00 | 0.61/0.39 | Very Good | 2 |
| 13 | G | VG/G | 0.83 | 0.08/0.75 | Good | 14 |
| 12 | G | G | 0.69 | 0.23/0.46 | Good | 11 |
| 44 | G | G | 0.34 | 0.09/0.25 | Good | 5 |
| 23 | G | G | 0.25 | 0/0.25 | Fair | 29 |
| 42 | G | G | 0.13 | 0.13/0 | Good | 4 |
| 43 | G | G | 0 | 0/0 | Good | 15 |
| 2 | G | G | 0 | 0/0 | Good | 20 |
| 39 | G | G/F | −0.06 | 0.07/−0.13 | Good | 8 |
| 40 | G/F | G/F | −0.45 | −0.32/−0.13 | Good | 9 |
| 9 | G/F | G/F | −0.62 | −0.17/−0.45 | Good | 22 |
| 37 | F | G/F | −0.8 | −0.6/−0.2 | Good | 16 |
| 46 | G/F | F | −0.87 | −0.17/−0.7 | Good | 18 |
| 41 | F | G/F | −1.08 | −0.8/−0.28 | Good | 12 |
| 49 | G | F/P | −1.2 | 0/−1.2 | Fair | 30 |
| 14 | F/P | G | −1.25 | −1.25/0 | Good | 23 |
| 5 | F/P | F | −2.05 | −1.3/−0.75 | Good | 24 |
| 7 | F | F/P | −2.4 | −1/−1.2 | Good | 21 |
| 17 | P | F | −2.53 | −1.9/−0.63 | Good | 27 |
| 4 | P | F | −2.74 | −2.2/−0.54 | Good | 26 |
| 22 | F | P | −2.86 | −0.93/−1.93 | Good | 3 |
| 15 | P | F | −2.99 | −2.4/−0.59 | Good | 13 |
| 48 | F/P | P | −3.00 | −1.2/−1.8 | Good | 17 |
| 18 | P | F | −3.77 | −3.1/−0.67 | Good | 25 |
| 45 | P | P | −4.00 | −2/−2 | Good | 19 |
| 47 | P | P | −4.80 | −2.2/−2.6 | Good | 28 |

### Example 16

### Delamination Resistance Results of Second Coating Compositions on Variable First Coating Compositions

Table 23 summarizes delamination resistance results of various polyurethane or polyurethane/acrylic hybrids or physical blends of second coating compositions when coated on first coating compositions, FCC16, FCC6, and FCC83. Tiles were coated as described in Example 6. The delamination resistance was determined as described in Example 6, and was performed at 72° F. and 50% Relative Humidity (% RH). As shown in Table 23, results demonstrate the effect of the type of polyurethane used in the second coating composition, the type and content of the acrylic used in the second coating composition, and the type of physical blend composition used in the second coating composition, and the type of first coating composition used.

TABLE 23
Delamination Resistance Results of Second Coating Compositions
Coated on First Coating Compositions FCC16, FCC6, and FCC83

| SCC Type | FCC16 | FCC6 | FCC83 |
|---|---|---|---|
| 26 | Excellent | Excellent | Good |
| 31 | Very Good | Excellent | Good |
| 22 | Good | Very Good | Fair |
| 11 | Good | Excellent | Good |
| 24 | Good | Very Good | Fair |
| 25 | Good | Very Good | Fair |
| 12 | Good | Very Good | Good |
| 15 | Good | Very Good | Good |
| 13 | Good | Very Good | Good |
| 48 | Good | Good | Good |
| 46 | Good | Very Good | Good |
| 2 | Good | Very Good | Good |
| 7 | Good | Very Good | Good |
| 9 | Good | Very Good | Good |
| 14 | Good | Good | Fair |
| 5 | Good | Good | Good |
| 23 | Fair | Fair | Fair |
| 49 | Fair | Fair | Fair |

What is claimed is:

1. A peelable floor surface coating system comprising:
a first coating composition comprising a first polymer composition, wherein when the first coating composition is applied as a first liquid to a floor surface, the first liquid dries to form a first coating; and
a second coating composition comprising a second polymer composition, wherein when the second coating composition is applied to the first coating as a second liquid, the second liquid dries to form a second coating,
wherein the first coating and second coating form a peelable coating,
wherein an adhesive strength between the first coating and second coating is greater than an adhesive strength between the first coating and the floor surface, and
wherein the first polymer composition comprises an acrylic emulsion polymer, a vinyl emulsion polymer, a vinyl-acrylic emulsion polymer, a styrene-acrylic emulsion polymer, a styrene-butadiene emulsion polymer, or a combination thereof having a T_{g} from about 23° C. to about 120° C.

2. (canceled)

3. The peelable floor surface coating system of claim 1, wherein the second polymer composition comprises a polyurethane emulsion polymer having a T_{g} from about −80° C. to about 80° C.

4. The peelable floor surface coating system of claim 1, wherein the second polymer composition further comprises a polyester, a polycarbonate, a polyether, a polybutadiene, a polyamide, a polyurea, a polyester-polyurea, or a combination thereof.

5. The peelable floor surface coating system of claim 1, wherein the second coating composition further comprises an acrylic emulsion polymer, a vinyl emulsion polymer, a vinyl-acrylic emulsion polymer, a styrene-acrylic emulsion polymer, or a combination thereof having a T_{g} from about 20° C. to about 120° C.

6. The peelable floor surface coating system of claim 3, wherein the polyurethane emulsion polymer has an acid number greater than one.

7. The peelable floor surface coating system of claim 1, wherein the second polymer composition comprises a hybrid emulsion polymer comprising an interpenetrating polymer network, wherein the interpenetrating polymer network comprises an acrylic, a styrene-acrylic, a styrene, a vinyl, or a vinyl-acrylic polymer.

8. The peelable floor surface coating system of claim 7, wherein the hybrid emulsion polymer further comprises about 20 wt % to about 80 wt % of a polyurethane on a dry weight basis based on total dry weight of the hybrid emulsion polymer.

9. The peelable floor surface coating system of claim 7, wherein the hybrid emulsion polymer further comprises poly(methyl methacrylate), poly(tert-butyl methacrylate), poly(styrene), or a combination thereof.

10. The peelable floor surface coating system of claim 7, wherein the interpenetrating polymer network comprises at least one of poly(methyl methacrylate), poly(tert-butyl methacrylate), poly(styrene), or a copolymer combination thereof.

11. The peelable floor surface coating system of claim 1, wherein at least one of the first polymer composition and the second polymer composition comprises about 0.1 wt % to about 20 wt % of a multifunctional organic crosslinking monomer on active wt % based on 100 parts of the first polymer composition or the second polymer composition, respectively.

12. The peelable floor surface coating system of claim 11, wherein the multifunctional organic crosslinking monomer comprises trimethylolpropane triacrylate, divinyl benzene, triallyl cyanurate, diallyl maleate, gylcidyl methacrylate, acetoacetoxyethyl methacrylate, N-methylol acrylamide, diacetoneacrylamide or a combination thereof.

13-14. (canceled)

15. The peelable floor surface coating system of claim 1, wherein at least one of the first polymer composition and the second polymer composition comprises acrylic acid monomer, methacrylic acid monomer, or a combination thereof.

16. The peelable floor surface coating system of claim 1, wherein at least one of the first coating composition and the second coating composition further comprises an organic solvent coalescing agent, a wetting agent, a leveling agent, a wax emulsion, a polyvalent metal ionic crosslinker, an alkali soluble or dispersible resin, a alkali agent, a polyfunctional crosslinker, or a combination thereof.

17. The peelable floor surface coating system of claim 16, wherein the wax emulsion comprises a wax with an acid number greater than one.

18. The peelable floor surface coating system of claim 16, wherein at least one of the first coating composition and the second coating composition comprises about 0.01 wt % to about 40 wt % of the wax emulsion on active wt % based on 100 parts of the first or second coating composition, respectively.

19. The peelable floor surface coating system of claim 16, wherein the wax emulsion comprises an oxidized polyethylene, a maleated polypropylene, or a combination thereof.

20. The peelable floor surface coating system of claim 16, wherein at least one of the first coating composition and the second coating composition comprises about 0.01 wt % to about 10 wt % of the polyvalent metal ionic crosslinker on active wt % based on 100 parts of the first coating composition or the second coating composition, respectively.

21. The peelable floor surface coating system of claim 16, wherein the polyvalent metal ionic crosslinker comprises zinc oxide.

22. The peelable floor surface coating system of claim 16, wherein the first polymer composition comprises an alkali soluble or dispersible resin with an acid number greater than one.

23. The peelable floor surface coating system of claim 16, wherein the first polymer composition comprises about 1% to about 50% of an alkali soluble or dispersible resin on active wt % based on 100 parts of the first polymer composition.

24-37. (canceled)
